(19) United States
(12) Patent Application Publication
(10) Pub. No.: US 2022/0144058 A1
(43) Pub. Date: May 12, 2022

(54) SCALABLE TRACTIVE-POWER SYSTEM, INTEGRATED WITH ALL-WHEEL ELECTRIC STEERING AND ELECTRIC BRAKING SYSTEMS, DEVELOPING 90% TO 99% TRACTION AND DYNAMIC EFFICIENCY, FOR LIGHT & HEAVY-DUTY ELECTRIC-VEHICLES.

(71) Applicant: Jacob BEN-ARI, Bat Yam (IL)

(72) Inventor: Jacob BEN-ARI, Bat Yam (IL)

(21) Appl. No.: 17/472,606

(22) Filed: Sep. 11, 2021

(51) Int. Cl. B60K 1/02; B60K 7/00; B60K 17/02; B60K 1/04; B60L 50/40; B60L 50/60; B60L 15/20; B60R 16/033; B60L 50/75; B60L 58/12; B60L 58/40; B60K 17/356; B60K 23/08; F16D 27/00; F16D 11/14; F16D 1/10; B60W 10/08; B60W 10/02; B62D 7/14; B62D 15/02; B62D 3/08; B62D 5/04; B62D 7/18; B60W 30/045; G01D 5/165; G01D 5/14; H02S 10/40

(52) U.S. Cl. CPC B60K 1/02; B60W 2540/10; B60K 17/02; B60K 1/04; B60L 50/40; B60L 50/66; B60L 15/2045; B60R 16/033; B60L 50/75; B60L 58/12; B60L 58/40; B60K 17/356; B60K 23/0808; F16D 27/00; F16D 11/14; F16D 1/10; B60W 10/08; B60W 10/02; B62D 7/144; B62D 15/0215; B62D 3/08; B62D 5/046; B62D 7/18; B62D 5/0484; B62D 5/049; B60W 30/045; G01D 5/165; G01D 5/145; H02S 10/40; B60K 2023/0858; F16D 2001/103; B60W 2300/10; B60W 2300/12; B60W 2300/145; B60W 2300/125; B60L 2200/18; B60L 2200/28; B60L 2210/42; B60K 7/0007

(57) ABSTRACT

A scalable tractive power system for vehicles (car, truck, bus, semi-trailer), integrated with all-wheel steering system which leverage synergies between plurality of differently designed electric traction-motors and all-wheel electric steering-motors is configured with plurality of sensors to virtually eliminate wheel-dragging and EPS, as part of virtually 100% dynamic efficiency. A fully automated electronic clutch-system attached to selected electric traction motors is configured to carry out above 90% traction efficiency by coupling to wheels selected electric traction-motors in their high efficiency range of operation, and de-coupling and replacing electric traction-motors with another electric traction-motors while the vehicle is changing speed or when the vehicle requires higher or lower tractive-power, from forward-motion start to top-rated speed of the vehicle. A holistic controller is configured with multi-objective optimization design (MOOD) procedures computing complex variable values and parameters, finding the required trade-off among design objectives, and improving the pertinence of solutions, while complying with NHTSA's ‘fail operational systems’ for steer-by-wire.

### CROSS-REFERENCE TO RELATED APPLICATION

This application is a modified improvement of two applications filed by the above-named inventor—application Ser. No. 15/911,627, filed Mar. 5, 2018; and application Ser. No. 16/399,194, filed Apr. 30, 2019, which was published Nov. 21, 2019 (2019/0351895 A1)—to fit all electric-vehicles, e.g., cars, trucks buses and semi-trailers; and application Ser. No. 17/352,411, filed Jun. 21, 2021, as a modification of application Ser. No. 16/399,194 to fit all railway vehicles.

### THE PHILOSOPHY BEHIND the INTEGRATION of TRACTION & STEERING

When the world population was just about one-billion, and nature was able to replenish man-made pollution, Nicolaus August Otto (1832-1891) invented in 1862 the four-stroke piston engine; and in 1885 Gottlieb Daimler (1834-1900) and Karl Friedrich Benz (1844-1929) instigated the piston-engine automobile era (FIG. 1); yet several years later Henry Ford (1863-1947) assembly line (1913), drastically reduced the cost of production with standardized parts and more efficient assembly, was able to bring the luxury, convenience and freedom of the automobile to the masses. A little over a century later, those magnificent inventors were unable to predict that 8-billion people will inhabit the planet, and 1.5 billion vehicles will pollute the atmosphere on a daily basis, much faster than nature can replenish the pollutants, especially after large forests were cut-down.

This disclosure is a radical modification of the traditional, mechanical engineering model of traction, steering and braking systems. Countless billions of dollars spent on autonomous vehicles (AV) R&D to pursue human sensing physiology while driving a vehicle, when the world is sinking into a pollution disaster scenario of ‘no-return.’ Engineers, scientists, and politicians dedicated insufficient concerns and funds, to improve and regulate EVs efficiency to combat global pollution; forgetting that most electricity production is from coal, oil, and natural gas, and half (about 45%) of global CO₂ emission comes from the production of electricity.

This disclosure provides an advanced solution to reduce EVs pollution by up-to 60% while providing a seamless driving and handling of any EV, autonomous EVs, buses, heavy-duty trucks, and semi-trailers by spreading the traction and steering task among verity of differently designed electric motors, independently propelling, and steering—with electronic means—each individual wheel independently, while integrating a scalable traction system with the steering system, by pursuing the four Pedi motoric of the fastest animals on the planet (FIG. 11).

The general idea in the current transportation industry transformation-years is that electric vehicles need to be re-engineered from scratch. It should be transformative because EVs are completely different animals. Trying to build an electric, driver-less vehicle based on traditional, mechanical propulsion and steering developed in the 19th century; and applying electronic architecture developed in the 1980s is like trying to build a spaceship on the foundations of the Wright brother's flying-machine. This is certainly not where the transportation industry is heading.

About two decades ago, traditional manufacturers and startups constructed the first EVs by merely replacing the ICE (internal combustion engine) with an electric motor-totally ignoring the enormous difference of energy-density between gasoline and Li-ion batteries. Gasoline energy density is 12.7 kWh/Kg about 42 times the energy-density of Li-ion battery that is just 0.3 kWh/Kg. Gasoline efficiency of about 24% reduces the effective energy-density reaching the wheels to 3.048 kWh/Kg; while Li-Ion battery efficiency to wheels averages 92% (0.28 kWh/Kg), and the ratio gasoline/Li battery is reducing to about 11. The only way to close the gasoline/battery energy-density gap is to design EVs with superior efficiency, which are the objectives of this disclosure.

The second major objective to consider before designing an EV is the exponential demand for electric energy. At the end of 2020 there were 8.5 million EVs worldwide. Bloomberg cautious estimate predicts that at the end of 2030, the number of EVs will grow exponentially, reaching 116 million by marking a leap of 1,365% in less than a decade, which will increase the world electricity demand by 8,500 TWh. Other's opinion is that the EVs number will grow much faster for 3 reasons:

4. Most manufacturers will stop manufacturing piston engines between 2025 and 2035. Between 2025 and 2030 people will buy much more EVs because they will realize that nobody will buy their piston engine as a used vehicle, which will deter banks to give a loans to ICE cars.

5. Governments around the globe will impose higher taxes on fuel to combat pollution and to prevent people from using piston engine vehicles; and

6. The purchase price and maintenance of EV will be so much cheaper than piston engines vehicles that will lure people to buy EVs.

With the shortage of electricity supply to 8.5 million EVs today, the big question is how to provide electricity to 116 million EVs in 2030? Big electric traction-motors with large battery pack will not contribute to the atmosphere clean-up since the majority of electric-energy is produce from coal, oil, and natural-gas. Current OEMs claim to be “zero” EVs, are:
Tesla Model S, with 515 Hp motors, and with 2.3 metric tons curb weight; Volvo Polstar 2, 408 Hp, W/2.4 tons; Lexus LF-30, 536 Hp, W/2.4 tons; Mustang Mach-E, 459 Hp, W/2.4 tons; Mercedes EQC, 408 Hp, W/2.5 tons; Audi E-Tron Quattro, 408 Hp, W/2.5 tons; and Porsche Taycan, 680 Hp, W/2.3 tons.
It does not take a rocket scientist to figure-out that these vehicles are unnecessarily too heavy in every aspect, with average electric-energy consumption of 4 Km/kWh, while lighter and more efficient EVs perform above 8 Km/kWh. Governments will eventually impose penalties, similar to EPA CAFE (Corporate Average Fuel Economy) standards to enforce manufacturers to fabricate EVs with smaller traction-motors and with smaller battery-packs to boosting efficiency and consume up to 60% less electricity.

FIG. 3 is a list of EVs from the 2020 model years. The efficiency of EVs is measured by the traveled range, divided by the size of the battery. It is obvious that Citroen has the best efficiency by reducing the power of a single electric traction-motor to 50 kW yet compromising maneuverability. At the center to bottom of the list are manufacturers with big electric motors, and enormous size battery-packs to manage a longer range. Their efficiency is one-half of Citroen's. This disclosure combined the philosophy of Citroen and Tesla by designing a traction system with 100 kW divided between 6 to 8 electric traction-motors, yet use the 100 kW power only for seconds, in forward-motion start and during accelerations, while driving on the highway 100 Km/h, by utilizing only two 7.5 kW (15 kW) electric traction-motors (FIG. 3, 4).

This application is pursuing nature's 2.5 billion-years of selective evolution where only the best ‘motion technology’ survived. EVs should be built different from ICE vehicles by first, eliminating obsolete mechanical components, and second, by designing a scalable tractive power system for superior efficiency, integrated with all-wheel steering system which leverage synergies between plurality of differently designed, and individually controlled electric traction-motors and all-wheel electric steering-motors, under the management of a holistic, digitized control-system, to consume the least electric-energy, yet maneuvering as powerful EV; while meeting the mobility prerequisites of the autonomous vehicle era, and safely dealing with any cyber threats.

### BACKGROUND OF THE INVENTION'S TECHNICAL FIELD

Additionally, this disclosure is radically modified, to digitally communicate with the multi-sensing-analog-information obtained—with variety of cameras, ultrasonic sensors, long & short-range radars, and LiDAR systems—in autonomous vehicles. This disclosure provides the answer to a seamless driving and handling of any EV, autonomous EVs, buses, heavy-duty trucks, and semi-trailers by spreading the traction and steering task among verity of differently designed electric motors, independently propelling, and steering each individual wheel—with electronic means—while integrating a scalable traction system with the steering and braking systems, by pursuing the four Pedi motoric of the fastest animals on the planet (FIG. 11).

The holistic controller in this disclosure monitors a variety of analog information collected from plurality of sensors; translates the analog sensory data into digital data, with which it can be applies to all kinds of electric traction and steering-motors and to electric brake-calipers to:
propel, steer, and decelerate each wheel independently with variety of electric traction and steering-motors, and with electric brake-calipers;
control the energy flow to and from all electric traction-motors with bi-directional DC to DC converters, and with bi-directional DC to AC inverters;
monitor the level of charging and discharging in various energy-storage units, and in various energy producing units;
apply different torque and different speed to opposing electric traction-motors for perfect, geometric steering while eliminating the electric power-steering (EPS) system;
incorporate the GPS receiver information into the traction and steering to provide the proper torque and speed in different road conditions, e.g., downhill, and uphill, for a perfect and very efficient mobility, while energy use-up is precisely monitored for best efficiency results.

Electric Power Steering (EPS) is today the standard fitment in most vehicles. However, autonomous driving poses challenges to the steering technology manufacturing community:

[symbol] , First, once a vehicles starts to operate without a driver, steering systems will expect to cater loss-of-assist mitigation in order to provide a safety net as, and when, the EPS power-pack fails to provide assistance for the vehicle steering. This will therefore force steering suppliers to migrate from fail safe systems³ to fail operational systems for steering. However, the major obstacle for the steering suppliers is NHTSA [National Highway Transportation and Safety Administration] regulatory compliance, which manufacturer are expecting modifications to accommodate AVs steering functionality. The scalable, integrated traction, steering and braking concept of this disclosure should be adopted as the ultimate future technology of choice because: ³ A fail-safe or fail-secure device is one that, in the event of a specific type of failure, responds in a way that will cause no harm, or at least a minimum of harm, to other devices or to personnel.

(iii) currently there is no effective mechanical solution for AV steering as this disclosure is; and

(iv) this disclosure triggers the elimination of EPS and all conventional, mechanical steering gears below the driver's steering-wheel.

In other words: while opposing wheels in an electronic-axle are activated with different tractive-power, and different speed; and while all wheels are steered in different angles because the distance of each wheel from the geometric center is different, it is obvious that a differential, electronic-controlled tractive-power will take-over the power-steering function, while integrating the traction in the electric all-wheel steering process, which will provide an exceptional stability and maneuverability without comparison.

[symbol] autonomous driving does not require humans to drive the vehicle, in which case the use of steering wheel is made redundant. This then allows OEMs and steering suppliers to concentrate on technologies that will help either eliminate the steering wheel or allow the steering to retract to the dashboard if not required. The bottom line: OEMs realized that steer-by-wire must be the system of choice.

In short; this disclosure attempts to indoctrinate the taboos in mechanical engineering perceptions because, the inventor's philosophy is that EVs have to be contemplated as a completely new animal and not as a machine. Robots in the industry, should be classified as machines because robots are carrying-out one or at the most extremely limited, repetitive, pre-programmed functions. Yet an EV operates under constant changing driving conditions. Every driving mode is different from the previous one or the next one, which compels to sustain complex multi-objective optimization algorithm to calculate all operatives for the next move in milliseconds.

Level-Five AVs collapses the traditional, redundant steering wheels, yet the sophisticated cameras, ultrasonic sensors, long & short-range radars, and LiDAR systems digital data is connected to the wheels with mechanical differentials, mechanical steering linkages and hydraulic brake systems, developed in the 19^{th} century. There is no engineering sense in having sophisticated sensory systems in autonomous vehicles—providing exclusively sensing information of the environment around the vehicle—while translating the digital information to the wheels, with a 130-year-old, obsolete mechanical-technologies. The analog sensory information received by the AV's ECU is converted to digital system, with which it can poorly communicate with mechanical gears that propel, steer and decelerates the wheels.

### TECHNICAL FIELD AND THE DISCLOSURE'S PHILOSOPHY FUNDAMENTS

This disclosure provides a frog-leap towards prevention of the catastrophic global pollution that is reaching a point-of-no-return. System 10 infra provides an efficient and seamless driving and handling of any EV, or AV, by spreading the traction and steering functions among plurality of differently designed electric traction and steering-motors, to propel and steer each wheel independently, while the electric brake-calipers decelerate each wheel independently, with a sophisticated digitized electronic systems.

A holistic controller is configured at the center stage of the overall management since the holistic controller is accomplishing every logic associated with excellent and safe handling; electing the most efficient alternatives for traction, steering, and braking, by utilizing plurality of Multi-Objective Optimization Design (MOOD) procedures simultaneously and employing Evolutionary Multi-objective Optimization (EMO). The main purpose to elect a holistic processes was to take all the steps in the MOOD procedure into a centralize account:
the multi-objective problem (MOP) statement.
the Evolutionary Multi-objective Optimization (EMO) process; and
the Multi-Criteria Decision Making (MCDM) steps, which involve machine learning.
   With a holistic controller management of plurality of electric traction-motors, electric steering-motors and electric brake-calipers along a semi-trailer, the overall efficiency will rise above 90% which will solve all major challenges before the transportation industry to:

(vi) meet all government pollution requirements;

(vii) reduce the battery-pack size by up to 50%;

(viii) reduce excessive electricity [in today electric trucks & buses] spending;

(ix) establish alternate energy solutions; and

(x) reduce the massive maintenance and repair expenditures.

The supremacy of humanity materialized about 5,500-years ago with the invention of the wheel, which outperformed evolution since there are no wheels in any known species. Yet, the first most efficient mobility emerged 5,300-years later when on Jun. 12, 1817, Karl von Drais (1785-1851) realized the first self-propelled machine when he travelled through the streets of Mannheim, Germany with his Laufmaschine, the “running machine,” the first bicycle. Human muscles create a super-efficient propulsion since it is the direct result of close-to-perfection human muscle motoric physiology. The lower part of the brain—with “algorithm” precision—activates the exact muscle-fibers, with the electric degree of intense that is just necessary to propel the bicycle's pedals. Then, the pedal rotation is transferred to the rear wheel, to accomplish the best efficiency in any given load condition, which is the gist of this disclosure. The nanotechnology in the molecular level—engaging the precise electro-chemical process that excites the exact number of Actin and Myosin proteins needed to perform precision contraction of the muscle—is not yet worked-out in vitro; yet it eventually will become the leading technology in future science because, every bio-technology utilized in lighting, television, and in a long list of products, makes it many-time-over superior and efficient, compared with any other technologies.

The reason the industry needed 130 years to look at a vehicle as an quadruped animal, is [symbol] first because the convenience of cheap fuel, and [symbol] , because the dogma taught in engineering schools that only mechanical components in machines is dependable. The turning point emerged when AV researchers realized the necessity to pursue human physiology ‘perception of the environment’ while driving a vehicle to produce AVs. However, the current “end-product” of a multi-billion-dollar AV-research, is translating the ‘environment perception’ into the traditional mechanical traction, steering, and braking which is on the way to be obsolete.

Visiting Thomas Alva Edison's Museum in Fort Myers Fla., man can witness the “old timer” philosophy of ‘power transfer’ when one electric motor-actuates several ‘consumers’ with one leather belt. In the past—and unfortunately also in the present transportation industry—one crankshaft actuated since 1885 all “consumers” in ICE vehicles: the crankshaft rotates a camshaft with belt or chain, to activate the valves; water pump; oil pump; power-steering pump; alternator; pollution air pump; ignition distributor shaft; AC compressor; transmission and differentials to mechanically synchronize most power into only two wheels.

In system 10 as depict in FIGS. 5, 12 electric motors—8 traction-motors and 4 steering-motors—all of which contain less than 100 moving parts, while in a single ICE the number of moving parts is about 2,000, which explains why only 20%-28% of power reaches the wheels, while electric traction-motors may perform above 90% efficiency. Regrettably, the majority of the current EV manufacturers are continuing the ‘one power source’ doctrine since most current EVs are manufactured with only one electric traction-motor coupled to plurality of mechanical gears to propel only two wheels; and a mechanical steering systems, independently steers only the front wheels of the vehicle with a traditional electric power-steering (EPS), while dragging the rear wheels. Heavy-duty tracks and semi-trailer drivers have to steer a 58′ long articulated vehicle with only two steerable wheels in the very front, while the rest 16-wheels of the semi-trailer are literally dragged behind like a giant monster with dead, out-of-control body. This is definitely not the insight of the future electric transportation business. The bad-news is that millions of jobs will become superfluous, for the 2,000 “moving-parts” in IC-engines will no longer manufactured.

The [symbol] first philosophy rule behind this disclosure is the notion that traction, steering and braking should complement each other, which is the only way to perform any perfect and stable mobility. Traditional automobile engineering, and new EVs, are constructed with traction, steering, and braking with no coordination between the three systems. It is obvious that propelling the wheels with one system and steering the same wheels with another is an imperfect arrangement, especially when it is conducted with mechanical means. FIG. 2A presents two separate systems, at the top the vehicle propulsion, and at the bottom is an electric power-steering (EPS) system that differentiate in their assignment, yet with lack of integration between them. This set-up is utilized in 99% of manufactured vehicles, where the ICE propels only two wheels independent from the driver who steers only the front wheels with different, mechanical steering-system assisted by electric motor [EPS].

The [symbol] philosophy rule is to centralize and digitize-control of all components with exclusively electronic means, for precision integration of the traction into the steering and braking process; providing EVs a ‘cheetah-like’ maneuverability; a precise computed scalable traction for outstanding efficiency; and in AVs the ability to translate the perception of the environment around the vehicle into digitized vehicle mobility.

The [symbol] philosophy rule is to split power between plurality of electric traction-motors, to follow the steps of evolution where thousands muscle-fibers are involved in motoric procedures, yet super-efficient precision is arrived at, only when the brain—the holistic controller—actuates only those, elected muscle fibers [e.g., electric traction-motors] that are necessary to sufficiently do the job. Therefore, coupling, de-coupling and precision rotation of plurality of small electric traction-motors while steering all wheels, and unevenly actuating brake calipers to manage wet and ice roads is the ultimate approach to achieve optimization of super-efficient mobility.

The [symbol] philosophy rule is that one electric traction-motor can do limited undertaking. Add another electric traction-motor for different task, add sensors, and further relationship becomes possible. Yet, gradually adding more, differently designed electric traction-motors configured to different specifications and to different assignment, with individual, electronically controlled, coupling, and de-coupling clutches, then the number of complex inter-relationships grows exponentially. FIG. 2B shows a desired healthy, and balanced systems between integration and differentiation. The theory of healthy in integrated systems is when the systems complement each other, which contributes to an incomparable vehicle maneuverability and stability that could not be achieved when the systems are not integrated. However, the electric traction-motors that are integrated in the traction system, and the electric steering-motors in the steering system are fully differentiated.

The [symbol] philosophy rule teaches us that complex systems are accommodating substantial number of elements that operate in coordination with one another, flinching new modes of actions. This disclosure exhibits simple forms of coordination between traction steering and braking, which results from interaction of multiple electric-motors and electric brake-calipers in a non-linear behaviour. Complexity of multiple-component in non-linear system could never be predicted from just computing a single component and adding it up. Human precision motoric is typically acquired during incredibly early age and becomes programmed in the lower brain with association to the cortex. Later on, most motoric undertakings are performed subconsciously through interactions of millions of neurons. The same “specific learned motoric sequence” in humans—with reliance on GPS's (FIG. 5, #10) memorized road topography and locations—may be programmed in the holistic controller to accomplish specific turns, down- and uphill maneuvers with improved efficiency. For example, when an EV or AV faces a downhill road, and after certain distance it changes to uphill; with the GPS acquired memory, the holistic controller can compute the best velocity downhill to take the uphill portion easy and efficiently. The same procedure relates to complex turns to be steered efficiently.

The [symbol] philosophy rule is to move into digitized controls and to discard the obsolete traditional mechanical traction, steering and braking gears. This will result in drastic reduction in weight, in manufacturing cost, and at the same time boost efficiency, precision maneuverability and safety, which will extend the EV driving-range, reduce components wear, and fulfil all AV engineering demands by translating analog data collected from cameras, radars, LiDAR and variety of sensors into a digital information, with which the holistic controller can utilize to precisely maneuver the traction-motors, the steering-motors, the electric brake-calipers and all other management undertakings.

The [symbol] philosophy rule is to completely electrify the trucking industry and pave the road to autonomous heavy-duty trucks and semi-trailers that will drive on highways during night-time to prevent road-congestion during the day. There is a wide consensus among manufacturers that—parallel to the enormous transition in the electrification of light-duty vehicles—the trucking and buses industry has to be revolutionized as well. Diesel engines in trucks, semi-trucks and buses are to become obsolete for the extensive pollution of NOx and CO₂ emission, which are a respiratory health detriments. The damage to the environment and the expenditure of health-care will always exceed by far the unsupported claims of the trucking industry that manufacturing and operating electric semi-trailer is much more expensive than diesel. Unsupported arguments as presented infra with supported calculations.

### Traditional Mechanical Gears Become Obsolete in EVs and AVs

This disclosure is obviously not following the steps of engineering schools which support the notion that “bigger is always better.” In fact, up to last decade, automobile industry only rated vehicles by how fast they go from 0 to 60 mph; totally ignoring efficiency and pollution while neglecting the rest 99.9999% of the time traveled. It makes no technological, economical, or environmental sense to continuously operate an EV with a single or dual, 175 to 200 HP electric traction-motors when this level of power is needed only for the first few seconds of forward-motion start and during accelerations that last also only seconds.

It took ICE engineers about 100-years to register that the classic 350 CID (5,735 cc) Chevy engine could be downsized to 122 CID (2,000 cc), and while equipped with a turbo charge system (2018 Camaro)—which is only engaged for intervals of seconds at forward-motion start and during accelerations—could produce the same pep as a 350 CID engines, thus pollutes 300% less, and consumes 60% less fuel.

As part of the development of AVs; most vigorous R&D are in the artificial intelligence (AI) technologies, which is nothing but a computer science that pursues human sensory perception of the environment. The holistic controller receives the sensory information, but it cannot apply this information directly to the vehicle mechanical steering gears or to the vehicle transmission or differentials that propels the wheels. In order to provide the holistic controller a form of traction and steering management abilities, electric motors have to be installed to activate the different mechanical gears. Getting rid of mechanical gears while propelling, steering, and decelerating each wheel individually ‘by wire,’ is what nature decided to be the best mobility in the fastest animal on the planet (FIG. 11).

### The Assessment of Battery-Pack Size, Weight and Cost

Manufacturers require about 5-years to develop a new model, which makes it especially important to predict how the transportation industry will look like in the next 10-years. To follow government regulations and meet CAFE (Corporate Average Fuel Economy) requirements, the majority of the manufacturers specific intent is to electrify by 2035 their entire vehicle portfolios. FIGS. 3 and 4 provides a list of 17 leading manufacturers, introducing 21 EVs in the 2020 model year. Both tables specify electric traction-motors HP/kW, efficiency rating in Kilometers traveled per kWh consumption, battery-pack capacity in kWh, range traveled on a single charge in Kilometers, and the curb weight of the vehicle. FIG. 3 last column depicts the EV efficiency, rated as the ratio between the distance traveled in Kms divided by the battery-pack size in kWh. FIG. 4 is a similar table, yet the last column efficiency-rating is the explicit efficiency of the electric traction-motors by multiplying the distance traveled by the curb-weight of the vehicle [the physical work performed], dividing by the battery-pack capacity in kWh.

FIG. 3, actually presents an overall distinct distribution of efficient EVs at the top of the list, going stepwise down towards inefficient EVs with electric traction-motors between 202 kW and 568 kW. However, the efficiency-factor in FIG. 3 depicts an overall efficiency without to take into consideration the maneuverability of each EV. EVs No. 1, 2 and 4 utilize the same 50 kW electric traction-motors, supported by small 14 kWh to 16 kWh battery-packs, with which the EVs can travel eight Kilometers consuming only one kWh; and travel about 150-Km on a single charge. Yet, these vehicles are very sluggish since they need in average 15 seconds to travel from zero to 100 Km/h. The right column in FIG. 3; the ratio: distant traveled divided by battery-pack kWh reveals a distinct discovery. The first 10-EVs have an average efficiency ratings of 9.35 while the last 11 to 20 EVs averaged at 5.31. The average weight of the first 10-EVs is 1,019 Kg and the average weight of the second 10-EVs is 1,938 Kg is twice. It appears that about 1,500 Kg [3,300 Lb.] is the breaking point in passenger cars efficiency, and that larger curb-weight contributes to inefficiency of EVs (see No. 1: Renault Zoe in FIG. 4).

A different approach to EVs manufacturing is presented in FIG. 3 by EVs No. 15, 16 and 20. Tesla's EVs 15, 16 and 20 are equipped with exceptionally large motors and 100 kWh battery-packs. EV No. 15, 16 and 20 with 100 kWh utilizes almost seven-times larger battery-pack than the ones in EVs No. 1, 2 and 4. However, EVs No. 15, 16 and 20 accomplishes an overall efficiency of about 50% vis a vis EVs No. 1, 2 and 4. The proximate conclusion is: adding kWh to the battery-packs, and increasing the tractive-power kW will extend the distance traveled, increase the pep, but at the same time it also increases the vehicle curb-weight, the manufacturing cost, and dramatically reduce the overall efficiency.

The right column in FIG. 4 evaluates the efficiency of electric traction-motors in physical terms of work to move an EV with weigh no Kilograms from stationary-point A to point B, divided by the kWh consumed. The most surprising results are EVs No. 15, 16 and 20 in FIG. 3, which are rated in FIG. 4 in efficiency places No. 4, 5 and 9 with electric traction-motors efficiency of 11,473 to 12,039, although the EVs weight between 2,255 and 2,514 Kg; and carry 5-6 times larger motors and batteries than EVs 1, 2 and 4.

This observation brought the inventor to the conclusion that larger motors are more efficient than smaller motors when moving stationary, or heavy-weight vehicles; and therefore, the best efficiency solution may be a plurality of—relatively small electric—traction-motors, coupled to and de-coupled from the wheels, according to a scheme derived from the holistic controller computed algorithms to satisfy the changing tractive-power requirements.

As for heavy-duty electric trucks, this disclosure achieved 23% better efficiency results than the Tesla semi-trailer (FIGS. 3, 4) for the following reasons:

(iii) Tesla's semi-trailer utilizes the same conventional steering as diesel semi-truck, which attributes to 22% inefficiencies of wheel-dragging. Integrating the traction in the steering process, while steering the articulated trailer two rear-axles will improve efficiency by about 20%; and

(iv) Distributing 10 electric traction-motors along the tractor and the trailer; and de-coupling selected electric traction-motors will improve the efficiency by additional 20-40% on the low side.

In most cases, the decision how to design a vehicle does not begin in the engineering department. The decision is made in the new vehicle showroom by sale personal, providing the information what sells. New-car customers are not interested in efficiency; top interest is the look of the vehicle, the pep, and the price, which is usually what makes a sale. To meet buyers' demands, the manufacturers listed in FIG. 3 increased the battery-pack kWh and/or the power-train kW in the 2020 models. However, manufacturers No. 1, 2 and 4. in FIG. 3 are still manufacturing the models with the same 15 kWh battery-packs and 50 kW traction-motors as in the 2017 models for being a low manufacturing cost and for the reason that the European market average daily driving-range does not exceed 80 Km.

There is a huge gulf in opinions about EVs design among manufacturers. Most of the manufacturers believe that the only factor to become more efficient is an improved battery to increase the driving range and the rest of the EV has to be manufactured with the same, traditional die-cutting because, traditional manufacturers refuse to accept the fact that EV manufacturing is eventually going to evolve as a ‘computer on wheels’ piece of equipment. EV chassis and bodies will be built by robots, and the electric motors and digital computers—which are not traditional vehicles manufacturing components—will be manufactured by subcontractor. When this stage evolves, it will indicate the start of a revolution in the transportation industry, with the main concern—how to deal with the huge unemployment the EV era generated.

The size of the battery-pack; the contribution to the vehicle weight and the contribution to manufacturing cost—and how the subject disclosure will contribute to reduce the size of battery-packs, and at the same time improve efficiency—is the core issue in this disclosure. A rigorous and thorough analysis considering battery metrics as well as vehicle design's parameters was done to decide how to reduce the weight, cost, and size of the battery-packs. Since personal vehicles are designed with no weight-limitations, the following battery-pack evaluations is concentrating in semi-trucks—since the size of energy-storage needed is more than five-times larger than in personal vehicles, although the equations presented infra are applicable to any EV.

The average payload carried by diesel semi-trucks is up to 17,300 Kg. The starting point is the fact that Class 8 semi-trailer has to comply with federal requirements of 36,364 Kg GVW; consisting of (i) semi-tractor 8,600 Kg; (ii) empty trailer 6,200 Kg; (iii) battery pack weight; and (iv) the size of the payload. The semi-truck empty weight Wv is about 14,800 Kg. Cummins X-15 engine and transmission weight about 1,750 Kg; and the differential gears about 400 Kg. Then, a diesel semi-trailer ‘empty weight’ without gears is about 12,650 Kg. Four-motors in Tesla's semi-truck weight 35 Kg.×4=140 Kg. and four differentials about 200 Kg. Then, the Tesla electric semi-trailer empty weight Wv should be considered as: 12,990 Kg. The only variable to determine the payload is the battery-pack weight Wbp:

(W_{Load})=Wₜ−(W_{bp}+Wᵥ)=36,364 Kg.−(W_{bp}+12,990 Kg); then: Eq. 1.0

W_{Load}=23,374 Kg.−W_{bp} when: Eq. 1.1

W_{bp} is the battery-pack weight; and W_{Load} is 23,374 Kg permissible load-battery-pack weight. Theoretically, a reduced battery-pack weight increases the permissible load.

[symbol] _{P}: energy, battery-pack size depends on the energy density in Wh/kg. A new nickel-rich cathode enables storage of 560 Wh/kg (0.56 kWh/kg), is configured with the best energy-density, which is more than double the leading battery used in current EVs made by Panasonic (LiFePO₄ model NCR18650B), which contains specific energy density of 243 Wh/kg. However, even the best Lithium batteries contain lower energy-density than petrol 12,889 Wh/kg, and hydrogen 39,443 Wh/kg. But battery-to-wheels efficiency is 90%, which includes battery discharge efficiency of 95% and electric drive-train efficiency over 90%, e.g., batteries propelling electric traction-motors are several times over more efficient than IC engines, with 24% gasoline and 28% diesel power that reaches the wheels. In hydrogen fuel-cell efficiency is only 36% that reach the wheels. The current fuel-cell technology is actually not serving the environment since hydrogen is produced from oil and natural gas (!) Clean hydrogen production via water electrolysis (FIG. 6A) has a negative energetic value in view of the fact that it takes 41.4 kWh to produce 1 Kg Hydrogen, whereas 1 Kg Hydrogen delivers only 33.33 kWh. Adding the 36% efficiency of fuel-cells, and the expensive fuel-cell system, makes it obvious that today's fuel-cell technology is environmentally unjustifiable, and commercially too expensive, and not practical. When the majority of electricity is produced from cheap, renewable energy, or atomic fusion reactors, fuel-cells may become environmentally, and commercially attractive. Electric Semi-truck will have to meet certain performance requirements at a reasonable cost of operation in order to be a practical alternative to the current diesel semi-trucks. Based on standard dynamics of motor-vehicles, including light- and heavy-duty vehicles up to semi-trucks; to estimate energy-pack [symbol] _{P} size in kWh, the vehicles have to meets dynamic requirements as presented in Eq. 2.0:

$${P}_{} = [ ( \frac{1}{2} ρ C d \cdot A \cdot {{v}^{3}}_{rms} + {C}_{rr} \cdot {W}_{T} \cdot g \cdot v + {t}_{f} \cdot {W}_{T} \cdot g \cdot v \cdot Z ) / {η}_{bw} + \frac{1}{2} {W}_{t} \cdot v \cdot a ( \frac{1}{{η}_{bw}} - {η}_{bw} \cdot {η}_{brk} ) ] ( \frac{D}{v} )$$

$$Wher \text{e:}$$

$$ρ = density of air ( 1.2 kg / {m}^{3} )$$

$$C d = Coefficient of drag ( 0.2 \text{3-0} .63 )$$

$$A = frontal area of the vehicle ( 2. \text{8-7} .2 {m}^{2} )$$

$${C}_{r r} = coefficient of tires rolling resistance ( 0.000 \text{5-0} .01 )$$

$$g = acceleration due to gravity ( 9.8 m / {s}^{2} )$$

$${W}_{T} = gross o \text{n-r} oad vehicle weight ( GVW ) maximum 36364 Kg . for sem \text{i-t} rucks$$

$$Z = the road gradient ( r / 100 )$$

$$r = the percentage road grade$$

$${t}_{f} = the fraction of time the vehicle spends at a road grade of r \%$$

$${η}_{bw} = batter \text{y-t} \text{o-w} heels efficiency 85 \% , discharge efficiency 95 \% , driv \text{e-t} rain efficiency 90 \%$$

$${η}_{brk} = brakes efficiency 97 \%$$

$$v = average velocity for trucks ( \text{m/s} ) ( mph ) ; ( 1 \text{6-2} 1 ) ; ( 3 \text{6-4} 7 )$$

$${v}_{r m s} = \text{root-mean-square} of the velocity for trucks ( \text{m/s} ) ( mph ) ; ( 1 \text{9-2} 4 ) ; ( 4 \text{3-5} 4 ) ; and$$

$$\frac{D}{v} = total time taken for a fixed driving range determined$$

Each of the above parameters is cast as truncated multivariate Gaussian Distribution (truncated within the limits of future projections and known max/min values as depict in FIGS. 6, 6a, 6b source: Bloomberg BNEF).

Based on distributions of variables, a standard simulation test considering the mean values of an output, the distribution of output values, and the minimum/maximum output values brought the following results:

(iv) an average annual distance traveled by a Class 8 diesel semi-trucks is 75,000 miles. 52-weeks and 6-days a week driving, translates into an average drive of about 250 miles/day, which is accurate statistics for more than 80% of semi-trucks travel. Since average semi-trucks speed is about 45 mph, driving 270 miles takes six-hours. Then, battery-pack size, weight, cost, and maximum payload capacity for electric, Class-8 truck is conducted with 480 Km driving ranges, and optional 960-mile range.

(v) after driving 480 Kms, a driver should stop after six-hours; spend 30 minutes charging the batteries to 80% capacity with Mega-charger at 7-cents/kW and complete the rest 480 Km with another 6-hour drive, which is little above the ‘Federal Motor Carrier Safety Administration Rules’ in which: semi-trailer driver can drive up to 11-hours after being off duty for 10 or more consecutive hours.

(vi) the trucking industry arguments that diesel trucks have a 1,450 Km range in one fueling is not a valid argument because this distance requires 20-hours driving, in violation of federal law. Therefore, the only weight-values considered for the required battery-pack is for 480- and 960-Kms range. For light-duty vehicles, any battery-pack may be utilized—there is no weight limits.

Tesla claims its electric semi-truck achieves 2 miles/kWh. This is correct when driving downhills. Tesla's tractor power-train consists of 4×192 kW electric traction-motors and gear-assemblies taken from Tesla's model 3. EPA test records confirms that Tesla Model 3 with a single 192 kW motor achieves about 6 Km/kWh with about 1,773 Kg curb weight, and [symbol] =0.36. Tesla's semi-truck definitively produces lower than 3.2 Km/kWh results because:

(iv) coefficient of drag accounts to 16% of energy loses in Class 8 semi-trucks. Model 3 [symbol] =0.23 while Tesla's semi-truck has [symbol] =0.36, which is the result of 57% increase in drag for having frontal area of about 7.2 m², causing an efficiency decrease to about 1.6 Km/kWh.

(v) Tire-drag and rolling-resistance accounts to 22% of energy loses in Class 8 semi-trucks. Assuming a fully loaded semi with 36,364 Kg distributes the weight equally on all 18-wheels, then each wheel carries about 2,000 Kg. Class 8 semi-truck has two steered-tires in the very front and 16 dragged-tires that will massively decrease efficiency by multiple tires rolling-resistance. With a tires rolling resistance coefficient Cᵣᵣ=0.0063, utilizing SAE J1269 standard test as defined by the Society of Automotive Engineers, the tires rolling resistance of the semi-truck will decrease efficiency to about 1.02 Km/kWh.

(vi) Class 8, diesel semi-truck's engine accounts to 59% of energy loses will not be considered; instead, an evaluation how this disclosure will improve electric semi-tucks efficiency is presented infra. All other variables listed in Eq. 2, were not considered because their influence on efficiency is fractional.

Applying the E_{P} energy results to 480- and 960-Km traveled distance; then fully loaded semi-truck will consumes 470 kWh, and 940 kWh, respectively. The [symbol] battery-pack weight calculations are set forth as follows:

$$\begin{matrix} = \frac{{E}_{P}}{{S}_{P}} were & Eq . 3.0 \\ = \frac{{E}_{P}}{{S}_{P}} = \frac{470 kWh}{0.243 \frac{kWh}{kg}} = 1 , 930 Kg for 480 Km range ; and & Eq . 3.1 \\ = \frac{{E}_{P}}{{S}_{P}} = \frac{940 kWh}{0.243 \frac{kWh}{kg}} = 3 , 870 kg for 960 Km range , \\ Wher \text{e:} \\ & Eq . 3.2 \\ {P}_{} = uses the Panasonic ' s NCR 18650 B cell with 243 \text{Wh/kg} as current . & \end{matrix}$$

To calculate limit payload, the above weights are inserted in Eq. 1:

W_{Load}=23,374 1,930˜21,500 Kg, with a 470-kWh battery-pack; Eq. 1.1

W_{Load}=23,374 3,870˜19,500 Kg, with a 940-kWh battery-pack. Eq. 1.2

Cost_{P}. the battery-pack cost: After calculating the battery-pack required energy and weight for Class 8 semi-trailer, the cost is given as follows:

[symbol]

_{P}= [symbol] × [symbol] _{kWh} Eq. 4.0

The cost of batteries based on the price available in the market is assumed to have a current mean value of $100/kWh.

[symbol]

_{P}=470 kWh×$100=$47,000 for 480 Km range; and Eq. 4.1

[symbol]

_{P}=940 kWh×$100=$94,000 for 960 Km range. Eq. 4.2

For beyond current Li-ion batteries, it is assumed to be at mean cost of $80/kWh with a minimum value of $50/kWh (see Bloomberg's BNEF estimate in FIG. 6).

Silicon is leading in battery research for two peerless advantages:

(iv) It is the third most common element after hydrogen and oxygen; and

(v) crystalline silicon anode has a theoretical specific capacity of 3,600 mAh/g; approximately ten times that of graphite anodes (372 mAh/g) in Li-ion batteries. Future Silicon Nano-Technology [to overcome swelling and rupturing problems] with 700 Wh/kg and up to 1.0 kWh/kg or better specific density might be available that could reduce the battery-pack energy E_{P} to 470 kWh and 940 kWh respectively; reduce the battery-pack weight to 470 Kg, and 940 Kg, respectively; and the cost to $470 and $970, respectively.

(vi) Magnesium could also become a viable alternative to overcome the safety and energy density limitations faced by current lithium-ion technologies.

Past experience teaches us that in 1967, the first digital wrist-watch, model CEH-1020, introduced with a retail price of couple hundred US dollars. Today, better digital watches are selling in dollar stores. This is the prognosis for the battery manufacturing community, and in the EV manufacturing turf in particular. The vehicle chassis will be manufactured by robots; the electric traction-motors; DC-DC converters, and the DC to AC inverters will be produced in multi-million units that will slash the EV's prices to the level of vehicle prices in the early 1980s. In fact; in certain vehicle categories, today's EV prices are already lower than the current price of vehicles with IC engines.

### Social and Economic Considerations

The future social and economic considerations-especially the availability, and monopoly of the rare-earth elements that are crucial to EV manufacturing-were evaluated before drafting this disclosure since automobiles in particular, are devices of culture and behavior, not just economics. Both culture and behavior can change quickly for the following reasons:

(vi) Because automobile personal ownership is a bad investment since it is in use less than 10% of the time and depreciate in value rapidly; automobile ownership expected to decline dramatically also because the world population is moving into cities, leading to augmentation of public transportation, and the car-sharing programs. A car shared by 5-10 people will be running 5-10 times longer, and less vehicles may be produced. In addition to focusing on reduction in the price of battery manufacturing, and increase in the batteries kW/Kg ratio, e.g., increase in energy density to extend the driving range, manufacturers should develop EVs that can withstand the rigors of near-constant driving and have much longer driving range on a single charge.

(vii) Shared vehicles will reduce the desire for personal “options” which usually makes 20-30% of new vehicles price. Another decline in price may be expected in the manufacturing of energy storage devices which makes more than 30% of the vehicle retail price today. Eventually, the future, average EV retail prices may be stretched from below $20,000 to about $30,000. This excludes manufacturers who retail EVs for much more than $40,000, since their sales depend heavily on $7,500 Federal Tax Credit, state, and local incentives; and on selling CAFE credits to other manufacturers. Those benefits may be no longer available in the future.

(viii) Before purchasing a new car, the first consideration—which includes lending institutions' top concern—is the projected resale value after 3, 4 or 5 years of the loan. Empirical tests prove that fast-charging procedures—which may be the MO—will shorten battery life. Since the battery-pack makes more than 30% of a new EV price; after 3, 4 or 5 years, when the batteries may be replaced, the vehicle batteries value will entail more than 75% of the entire used vehicle. Therefore, new vehicles with large battery-packs would have exceptionally low resale value as a used-car.

(ix) When the EV industry reaches production of 20-30 million BEVs/year, soaring demand for Lithium, Cobalt, Nickel and other rare earth metals such as: neodymium magnet Nd₂Fe₁₄B, samarium magnet [cobalt SmCo₅]—with magnetic field exceeding 1.4 Teslas—could be monopolized by China since it controls 90% of the world mining of those elements. This monopoly—especially when China logged 60% of global EV sales [Bloomberg]—will skyrocket prices to levels that would lead to dis-economy. Minimizing, or totally giving up the use of rare earth magnets is one of the goals of this disclosure.

(x) Massive quantities of battery hazardous waste disposal are another reason to produce efficient EVs with small battery-packs, or find an alternatives in the bio-technology, which demonstrates impressive recycling and efficiency results.

### Defeating Electric Motors Inefficiencies & Cost

IC engines waste into heat most of the energy they produce; only 28% in diesel and 20% of the energy in gasoline engines reach the wheels. FIG. 7 depicts two representatives of the IC engine family distribution of typical, narrow useful range of torque and power over speed (RPM). Both engines have similar, very narrow peak of about 100 Kw (134 HP) power-output but then, a quite different characteristic of torque distribution. If these engines were coupled directly to a drive shaft without a multi-gear transmission, the engine will stall. Large transmissions were constructed to fit within narrow, effective operable RPM of IC engines, to secure enough torque, and to provide optimal power to the wheels while changing speed and load demand.

Most electric-motors are designed to run at 50% to 100% of their rated load; maximum efficiency is usually near 75% of the rated load. The specific example of Motor #3 in FIG. 8 and FIG. 10 displays the ‘High-Efficiency Range’ between 47 and 73 mph, gradually increases from point a of just below 80% efficiency to just 90% maximum efficiency level in point b, which is also the point of ‘break-down torque.’ However, if output-power continues beyond point b, then efficiency will gradually reduce to 80%, and when reaching point c it will rapidly reduce to a lower efficiency values.

Unfortunately, the drive-trains design in most EVs listed in FIGS. 3 and 4 is inherited from vehicles with IC engines because today's EVs are assembled by manufacturers who assembled piston-engine-vehicles for decades with a design concept of: “one power source does it all.” A single electric traction-motor is traditionally constructed with a gearbox [most EVs use a single gear transmission] that is connected to a mechanical differential that transfers power to the wheels with two or four drive-shafts. Electric traction-motors are much smaller than IC engines, lighter, and have higher HIP to Kg ratio than IC engines. Electric traction-motors are being constructed in infinite designs, sizes, and specifications, which is a crucial advantage in fitting electric traction-motors in any vehicle category; and electric traction-motors are the only solution to integrate traction, steering and braking in EVs and AVs.

FIG. 9 is a typical, non-linear energy-consumption vs. speed in a standard EV with a single induction-motor. Cruising at 60 mph the EV consumes about 15 kW. Doubling the power to 30 kW will bring the EV only to 84 mph; 40 kW to 93 mph; 50 kW to 100.4 mph; and 60 kW reach a speed of 106 mph. These numbers suggest that the subject EV may overall travel only 1.8 times faster than 60 mph yet consume 4-times more energy than when traveling at 60 mph. The lowest energy use-up of about 7 kW is between 20 mph and 30 mph.

VW demonstrated in 2009 how far efficiency can go with the experimental XL-1 hybrid vehicle, first presented in the 2013 Geneva automobile show. In addition to its super-aerodynamic (Cd=0.189); its light-weight carbon-fiber reinforced polymer (CFRP) which facilitates only 1,749 Lb (795 Kg) curb weight, and its hybrid propulsion of two pistons, 800 cc diesel engine, producing 50 HP with an electric-motor that adds 27 HP; the XL-1 brings about an impressive efficiency of 280 to 313 mpg, more than twice the average current EVs. In full power mode, the XL-1 can run 125 mph. The achievement of the XL-1 inspired the inventor to record the subject disclosure by virtue of the fact that if the XL-1 is able to cruise in a windless highway at 62 mph (100 km/h) with just 8.3 HP, which supports the inventor philosophy supra that 175-200 HP electric traction-motors that operate at all times must be extremely inefficient.

Synchronous motor is rated with better efficiency than induction motor attributable to their permanent magnets in the rotor, while induction motors consume part of the electric energy to create the magnetic field in the rotor. Yet, synchronous motors have “side effects” and high price that diminishes their efficiency benefits. Synchronous-motors are expensive; they overheat, which calls for an extensive water-cooling system, especially with 175 to 200 HP and larger motors. Torque ripple and rotor skew produces annoying vibrations, similar to the annoying vibrations in high compression IC engines. Manufacturing synchronous motors with Neodymium is expensive, and depends on monopolized supply, which could lead to dis-economy.

Induction motors are amazingly simple, require no ‘rare-earth-elements,’ are robust, air-cooled, and cost a fraction of synchronous motors. Tesla's best-selling model S, originally equipped with induction-motors, was reported on March 2019 in the German magazine “Das Elektroauto & E-Mobilitats-Portal” that TeslaModel S listed by “Schwake” [German Blue Book] as a three-year-old with 60,000 kilometers “at a considerable 60% residual value [the Model S has had an induction-motor], while Porsche Panamera stood at 57.4% residual value.”

In spite of induction-motors' lower-efficiency, when distributing power among four-pairs of induction-motors as depict in FIG. 5, it eliminates the detriment of induction-motors vis a vis synchronous motors, as illustrate in FIG. 10; because, when utilizing optimization algorithm to determine optimal power distribution with the least energy use-up among four-pairs of induction-motors; in different speed intervals, it establishes much better efficiency than one synchronous motors coupled to the wheels at all times. Coupling to wheels only the induction-motors needed to meet the vehicle power demand, surpasses by far the efficiency of synchronous motors.

Electric traction-motors operate above 90% efficiency because mechanical losses during transmission of power to the wheels as in IC-engines no longer exist, which predicts that EVs are enormous potential in reducing transportation's energy demand. EVs will play a significant role in the future of personal mobility and a leading role in transformation of energy; especially after car-sharing will become the norm. But to achieve the energy turnaround, battery EVs (BEVs) must be much more efficient. FIGS. 7 and 8 depict the obvious difference in operational range of torque and power between IC engines and electric traction-motors.

There are all kind of Intelligent Motor Controllers (IMC) in the market, and in patent application process, to justify an EV design with a single electric traction-motor, claiming to have solved efficiency problems in electric motors by utilizing microprocessors to monitor motor load and accordingly match the motor torque to the motor load—maybe in laboratory testing. The process is reducing or increasing the voltage to the AC terminals and at the same time lowering or elevating the current to bring the motor to operate within its ‘High-Efficiency Range.’ Unfortunately, IMC provides limited efficiency improvement for a single electric traction-motors because, for substantial part of traveled-time, EVs are operating under low load conditions; and electric-traction-motors operate extremely inefficient at low and at high RPM (see FIG. 8). The same problem take place at low power output levels, e.g., below 30% rated load and beyond the point of ‘break-down torque.’ Design and mechanical limitations of electric traction-motor cannot be resolved merely by electronic means. A sophisticated IMCs design, equipped with all electronic gadgets could not maintain efficient propulsion with a single electric traction-motor through all driving conditions; and in every vehicle speed, and load conditions.

If emulating human physiology to create AI (artificial intelligence) is so widespread today, then why human's and certain mammals' motoric physiology is not implemented in manufacturing EVs? FIG. 11 represents the complexity of muscles (motoric apparatus) necessary to create the precision movements in the fastest animals on the planet. Muscles are directly attached to the motoric sites and are only controlled “by neurons [wires]” through feed-back loops, with a single, small brain (holistic controller), while being supported by all kind of sensors. There is no case in evolution where a single muscle “does it all.” Humans' 6,000 years of creative history cannot measure-up to 2.5 billion years of selective evolution that extinguished inefficient species and let survive only those with the best coordinated motoric system. In the Cheetah's muscle diagram, it is noticeable that the muscles in the rear Pedi are much more voluminous than the front Pedi, because with the rear Pedi the Cheetah accomplishes more than 80% of the motoric thrust.

A Cheetah could reach speeds of over 115 Km/h by using both rear Pedi, and front Pedi to achieve an extremely fast sprint forward. However, the Cheetah's precise operation is different than horse galloping that put into motion one Pedi at a time. A slow-motion video of running Cheetah establishes that both rear Pedi hit the ground at the same time while the front Pedi hit the ground most of the time at the same time. Yet, in maneuvering [steering], other than straight-forward, the Cheetah hit the ground with the front Pedi in an extremely fast sequence, one after the other to steer its body as needed. When turning to the right, the Cheetah hits the ground with the front left Pedi harder to force a turn to the right, as matched in this disclosure: when the driver steers to the right, the left-side electric traction-motors turn the left-side wheels faster than the right-side to assist the steering without EPS (electric power steering) as described infra. Because Cheetahs were “operational” millions years before Karl Benz put the first automobile on the road in 1885, this observation deduces that for much better power distribution and stability, the rear wheels better be equipped with more powerful, identical electric traction-motors on each side; since EVs are manufactured with rigid chassis, a holistic controller may provide uneven speed distribution to the left and to the right wheels to force a turn without EPS.

### The Fundamentals of Electric Traction-Motors

In principle, the decisive difference between this disclosure and other EV designs is the notion that in order to achieve the best efficiency possible, not all electric motors have to be engaged in the traction and steering at all times. It took engineers decades to realize that running power-steering pump, or hydraulic pump all the time is extremely inefficient. Today's norm is EPS that assist in the steering process only when the driver moves the steering-wheel. Hydraulic pumps are replaced by electric motors or powerful solenoids. If all muscles, in humans and animals, would be in motion all the time, when only the legs were used to take a walk, humans and animals would be sleeping every 2-hours to “charge their batteries.” The concept of this disclosure is a design of plurality of distinctively designed electric traction-motors, coupled to wheels almost only in their highest efficiency range of operation as depict in FIG. 10; then, when the vehicle moves into a different speed and different load that fits the specifications of another electric traction-motor group, the previous electric traction-motor group is de-coupled from the wheels because the electric traction-motor group that was just coupled is more efficient in the new load and speed the vehicle have just entered.

This intricate mechanism is designed to preserve small portions of energy in the battery-pack that adds-up, especially when a vehicle is driven for hours. The additional energy saved by running the vehicle in highly efficient procedure, may go a long way.

It is evaluated and proven that three fundamental factors affect the efficiency in vehicles with IC engines: 12% for the vehicle's aerodynamics; 22% for the tires rolling-resistance; and 59% for the IC engines inefficiency in transmitting the power to the wheels. Aerodynamics is a vehicle design issue—affected in particular by the EV frontal area—which is not a part of this disclosure. The design of this disclosure drastically reduces the 22% tire rolling resistance, tire dragging, and the inefficiencies of electric traction-motors in certain loads and speeds. In addition, it will dramatically improve heavy-duty vehicles maneuverability and overcome the manufacturing cost barrier of electric semi-trailers, by significantly reducing the battery-pack size and the vehicle weight, while increasing the payload capacity.

The concept that electric traction-motors operate above 90% efficiency is only partially correct because it only materializes under specific loads and during specific angular speeds as depicted in FIGS. 8, 9 and 10. The vast reduction in vehicle energy consumption is represented in detail infra. FIG. 12 displays a detailed cross-section configuration of the front right wheel electric traction-motors and clutch assembly in system 10, as displayed in FIG. 5A. The basic parts of the disclosure are two electric traction-motors 53, 54 with their individual, coupling and de-coupling electronic-clutches mechanisms 86a, 87a as displayed in detail in FIGS. 12, 13, 14, 36, 37, and 38 for the other three-wheels. System 10 may be designed with reduced electric traction-motors by utilizing in the front or the rear axle only two motors instead of four as depicted in FIG. 14 or in FIG. 38 where an electric traction-motor is configured without electronic-clutch and is rotating whenever the vehicle is in motion in combination with electric traction-motors with electronic-clutches (FIG. 13A).

The big advantage of electric traction-motors over IC engines is the ability to design infinite electric traction-motors to fit a mixture of specifications to efficiently cover cruising speed from forward-motion start to the top-rated speed of the vehicle. The industry world-wide utilizes exclusively electric power; and therefore, the number of IC engines in the industry are fractional because of their high pollution rate, narrow torque output, narrow efficiency range, low durability, and high maintenance cost for having multiple moving parts. IC engines were manufactured for their extremely low price, and high energy content of gasoline. Yet, the wider range of efficiency in electric traction-motors is not enough to operate an EV with a single electric traction-motor because it cannot operate efficiently without a transmission across the range of zero to 90 mph and under variable loads. Manufacturers who built EVs with a single motor introduced in the model years 2020 EVs with 2-motors in FIGS. 3 and 4: Tesla (first Model S came with one induction-motor), VW I.D. BOOMZZ, Audi e-Tron and Jaguar I-Pace. Transportation engineers have realized that distributing power with electric traction-motors among all wheels leads to better efficiency and better stability and maneuverability. However, electric motors not equipped with de-coupling clutches, consume energy all the time when the vehicle is in motion, while in the subject disclosure, electric traction-motors are most-of-the-time coupled to wheels only in their highest efficiency range of operation.

In EVs with a single electric traction-motor, most driving-modes after forward-motion start are inefficient. The solution must be a distribution of the vehicle's power demand—in different driving modes—between electric traction-motors designed with different ‘high-efficiency range of operation.’ While driving through changing load and changing speed, controller 100 (FIG. 5) utilizes multi-objective optimization design algorithm to elect and actuate specific electric traction-motors that overlap each other's ‘high-efficiency range of operation,’ to continuously propel the vehicle from forward motion start to 90 mph in the most efficient way by coupling to wheels electric traction-motors only in their high efficient range of operation, and coupling to wheels another electric traction-motors when load and speed are changing, and then, de-coupling the previously coupled electric traction-motors, and at the same time meet the vehicle's load and power demands (FIG. 10).

Controller 100 management begins the forward motion-start with all electric traction-motors—with 100 kW power in System 10—to accelerate the vehicle from zero to 60 mph in less than 5 seconds, which solves the deficient maneuverability problem of EVs No. 1, 2 and 4 in FIG. 3. Yet, seconds after forward-motion start, controller 100 de-couples selected electric traction-motors because at this point the vehicle gained sufficient kinetic energy to proceed efficiently with only 2 or 4 electric traction-motors. De-coupling electric traction-motors promotes efficiency, prevents overheating, and components wear out. One of tractive-power setup in system 10 may be with the following electric traction-motor (100 kW total):
7.5 kW-10 kW-10 kW-7.5 kW front
7.5 kW-20 kW-20 kW-7.5 kW rear
   Four 7.5 kW induction-motors; two 10 kW induction-motors; and two 20 kW induction-motors cost less than one 100 kW synchronous motor with all attachments (electronic components and cooling system). The same applies to small DC to DC converters; and DC to AC inverters. The reason for low prices is that small electric-motors and small electronic parts in general is manufactured in the millions as they are utilized in multiple technologies.

FIG. 15 represents a chart with 4 traces, which represents the torque and speed vs efficiency for two, differently designed pairs of electric traction-motors that overlap each-other to propel system 10 configuration in optimum efficiency from zero to 90 mph. FIG. 15 is a chart that applies to the traction-motors in FIGS. 12 and 13 for operation of electric traction-motors 53, 54 and 57, 58, respectively. Each electric traction-motor, 53 and 54 or 57 and 58—when coupled to the wheels—may be coupled in series to a joint shaft 62 via reduction gears 66, 68 [not shown in detail] that propels the front right and the rear right wheels of the vehicle, respectively. The same configuration is at the left side.

Trace 150 in FIG. 15 shows the output torque of electric traction-motor 53; trace 151 shows the output torque of electric traction-motor 54; and trace 152 shows the combined torque provided by electric traction-motors 53 and 54. Trace 154 shows the combined power output provided by electric traction-motors 53 and 54. Trace 152 shows that the speed range over which a single electric traction-motor can deliver torque, which is effectively the sum of the torque output of both electric traction-motors 53, 54 when the two electric traction-motors are propelling the joint shaft, e.g., put in a serially coupled configuration, they will provide an equivalent output as a single electric traction-motor with the sum of their power, and the sum of their speed, but then, only the average torque of the two electric traction-motor. Electric traction-motor 53 [Trace 150] shows maximum speed at 48 mph, and maximum speed of electric traction-motor 54 [Trace 151] is 84 mph, then the maximum speed of the right front wheel in system 10 [FIG. 5] may be raised to 132 mph. The actual benefit of this disclosure is the aptitude of controller 100 to promote efficiency by splitting power when only one pair of the four pairs of electric traction-motors is coupled to wheels to satisfy the power demand, which is unfeasible in EVs with a single or double electric traction-motor configurations.

However, that electric traction-motors 53, 54 and 57, 58 are not “pairs” although they operate the same joint shaft. Electric traction-motors 53, 54 and 57, 58 may be constructed with distinctive design and different specification. Electric traction-motors 53, 54 and 57, 58 that are on the right side of the vehicle is “paired” with electric traction-motors 51, 52 and 55, 56 that are on the left side of the vehicle, respectively. Because electric traction-motors pairs have the same design and specification, they are engaged in propulsion at the same time except in precision steering modes—for example in tight parking conditions—when controller 100 disables the electric traction-motors of one wheels, and slowly activates the other three wheels, using the non-operating wheel as pivoting axis.

Controller 100 may elect to de-couple electric traction-motors 53, and/or 54—or any other electric traction-motors in system 10—when:

(iv) their engagement in traction of the EV is not necessary at specific point and time; and when the EV is operating in a speed range that is not in the specific electric traction-motors' ‘high-efficiency range of operation;’

(v) controller 100 may elect to engage alternative electric traction-motors with higher or lower torque or power rating to meet the power demand during changing speed, while maintaining efficiency at optimum; and

(vi) during regenerative mode, controller 100 may be configured to couple all electric traction-motors that are not coupled to promote faster deceleration; maximum gain in converting most of the vehicle's kinetic energy into electric energy; supply the bucked voltage to the respective energy storage units 14, 16; and promote efficiency, getting by without, or with effortless use of the electric brake-calipers, which also curtails wear and tear of the braking-pads.

In FIG. 12, discs 87a and 87b is permanently attached to a join shaft that rotates whenever the vehicle is in motion. Because the permanently attached discs' 87a, 87b revolution cannot be altered; before the electronic-clutches can be coupled, discs 86a, 86b revolution must precisely matched the permanently attached discs 87a, 87b. Relying on Einstein's theory of relativity pertaining space and time, published 1915 with the title: “Zur Elektro-dynamik bewegter Körper” (“On the electro-dynamics of moving bodies”), there is no fixed frame of reference in the universe. Every moving body relates to every other body in space and time. Yet, when two bodies travel next to each other, at exactly the same speed, relative to each other, they are stationary.

Relaying on Einstein's theory, the electronic-clutches operative-sequence of coupling and de-coupling of individual electric traction-motors, illustrated in FIGS. 12, 13, 16 and 17 as follow:

(vi) utilizing multi-objective optimization algorithm, controller 100, may couple to wheels electric traction-motors 53, 54 if the algorithm provides that electric traction-motors 53, 54 efficiency rating is the least energy use-up in a specific driving mode, and at the same time the traction-motors meet system 10 tractive-power demand.

(vii) since revolutions of the permanently attached discs 87a, 87b is constantly monitored by speed sensor 88; and, since disc 86a, 86b RPM information is provided to controller 100 via close-loop feedback-mechanism through sensor 88a, 88b; and because electric traction-motors 53, 54 are not under load, controller 100 may spin electric traction-motors 53, 54 in a fraction of a second to revolutions that precisely match the revolution of disc's 87a, 87b.

(viii) controller 100 may then actuate the three-solenoid-sets 81a, 81b, triggering a pull-back of locking-latches 83a, 83b, which causes the releases of the electronic-clutch's circular gear 84a, 84b.

(ix) a large coupling-spring 85a, 85b, between the disc and the electric traction-motor thrusts the already rotating motor-side disc 86a, 86b forward, to couple the motor-side disc with the permanently attached wheel-side disc 87a, 87b while both discs are rotating at precisely the same angular speed. At this point, rotational power is transferred from a coupled electric traction-motor to the wheel. The two discs are configured with dog-teeth, claws-teeth or any other means of concave indentation and convex projections that fits perfectly tight one into the other when they are coupled.

(x) at the same time, controller 100 actuates electric traction-motors 53, 54 through DC to AC voltage inverters 43, 44, and with the appropriate voltage, current and frequency modulation, satisfies the torque, power, and RPM demand for optimal traction in every mode of operation within the integrated AWD and AW-steering of a vehicle.

When electronic-clutches have to be de-coupled as presented in FIG. 16, 17, controller 100 may actuate the three-solenoid-set 83c, and by means of electro-magnetic force; electronic-clutch cylinder 86a, 86b is pulled back; a large coupling-spring 85a, 85b, that kept the two discs coupled is compressed, and electronic-clutch circular disc 84a, 84b is locked down with a three latch-sets 84a, 84b in de-coupled, stationary position.

To overcome the sluggish start as mentioned supra with EVs No. 3, 4 and 5 in FIG. 3; and to have the pep of a sport car, experiencing zero to 60 mph in less than 5 seconds; controller 100 secures adequate torque and power distribution to all four wheels by actuating all four-pairs of electric traction-motor 51, 52, 53, 54, 55, 56, 57 and 58 in FIG. 5, or elect to actuate for just a few seconds less than all electric traction-motors to reach a desired speed of about 60 mph. The holistic controller ‘decision making procedure’ depends upon the level of the position of the driver acceleration-pedal (FIG. 5, #40). When the vehicle gained sufficient kinetic energy, controller 100 may de-couple selected electric traction-motors and continue to maintain the vehicle power demand under strict efficiency considerations with fewer electric traction-motors that are elected to meet the efficiency and power demand within a specific load, speed, and any specific driving mode as depict in FIGS. 10 and 14. However, if the driver desires to continue accelerating, controller 100 may continue to engage all or selected electric traction-motors to follow the driver's accelerator position (FIG. 5, #40). In smooth driving, before the vehicle reaches the speed of about 50 mph, controller 100 may first actuate specific pair of electric traction-motors that were designed to operate efficiently within 50 to 60 mph range [for example motors #3 in FIG. 10] or any other combination of electric traction-motors to meet the driver's accelerator position while carrying on with the least energy use-up and securing vehicle stability. Before the vehicle reaches the speed of about 70 mph, controller 100 may first actuate the electric traction-motors pair that is designed to operate efficiently in the 70 to 90 mph range [motors #4 in FIG. 10], and only then it may disconnect electric traction-motors pair that operated in the 50 to 70 mph range [motors #4 in FIG. 10] or elect any other electric traction-motor combination.

Three systems, as detailed below, is integrated into one system for much better vehicle dynamics, stability, and exceptional handling and efficiency:

### Improving Traditional Inefficiencies and Vehicle Dynamics

Two traditional engineering concepts in current EVs are the paramount contribution to vehicles inefficiencies:

(iii) transfer power from electric traction-motors to the wheels via traditional transmissions and differentials;

(iv) utilizing 130 years old mechanical steering only in the front wheels, while the rear wheels are dragged.

EPA motor vehicle's Federal Test Procedure driven on a dynamometer, is not a real-world driving environment since in the real world, vehicles do not drive only straight forward as on a dynamometer. The scenario of mechanical steering inefficiency is unaccounted for because during steering procedures on the road, three tires are dragged in different degrees, especially the two rear ones, and especially in short-radii steering. Cd [Coefficient of drag] and the vehicle weight are entered into the dynamometer calculations, yet the consideration that are ignored are four tires side-slip in their contact-patch, the deformation that affects all four tire carcasses, caused by cornering shear-stress-forces and rear wheels dragging. The energy lost in mechanical steering affects EVs efficiency the same way it affects IC engine vehicles, which dramatically curtails the driving range; while additionally, wheel dragging diminishes life expectancy of tires.

A layout of a traditional fixed rear-wheel suspension (FIG. 18) contains a multi-link suspension pointing in all directions, to constantly provide ideal geometry to respond to all external dragging forces applied during steering modes; to prevent vibrations; skidding and reduce vibrations and noise. FIG. 19 represents the entire rear-suspension assembly that should be obsolete in EVs. Tires rolling resistance increases when dragging wheels, which reduces the power to wheels by an average of 22%.

Since traditionally only the front wheels are steered, a layout of front-wheel suspension (FIG. 20) contains no supporting link-bars or stabilizing link-bars because the front wheels are steered 90° to the turning center and are not exposed to drag-forces like the rear wheels. To reduce inefficiencies during low-speed steering, the ideal situation in low-speed is to position all four wheels 90° degrees to turning center to get rid of tire dragging altogether, which would realize virtually 100% dynamic efficiency and close to perfect maneuverability. Because, this disclosure is propelling and steering all four wheels, FIG. 21 represents a suspension to fit all four wheels, with minor changes between the front and the rear suspensions, since each wheel has to be steered to different angle and propelled with different speed. Therefore, links and stabilizers are obsolete.

The fact that AWD (all-wheel drive) systems provides partial solutions for better dynamics and road stability improvement, was the first choice by EV manufacturers who utilized one electric traction-motor in the rear axle, coupled via differentials to both rear wheels, and one electric traction-motor in the front axle, coupled via differentials to both front wheels. However, both electric traction-motors coupled to the wheels at all times when the vehicle is in motion. AWD systems that improve vehicle dynamics is manufactured in limited numbers for their economic expense, and massive mechanical components that caused the vehicle to ‘gain weight,’ which called for bigger IC engines and transmissions. However, traditional AWD systems faded away, for being heavy, costly, and inefficient.

The next step in improving stability and efficiency in EVs is the incorporation of a single electric traction-motor inside the wheel. Protean Electric in Michigan claims to improve stability and efficiency in EVs by incorporating a single electric traction-motors inside the wheel, as represented in FIG. 22. In other words, propelling the vehicle with 2- or 4-wheel direct-drive “by wire.” However, this design contains deficiencies that must be taken under consideration:

(iv) connecting two or four different electric traction-motors, one on each wheel is an innovative idea. However, after the first few seconds, when the vehicle gained sufficient kinetic energy, the electric traction-motors cannot be disconnected to keep traction within ‘high-efficiency range’ as depict in FIGS. 8 and 9 because there are no decoupling mechanisms available;

(v) considering that the wheel's disc-brake, and brake-caliper is also located inside each wheel, then during braking procedure, the brake-calipers may release a huge amount of heat that might damage and curtail the life expectancy of the electric traction-motors;

(vi) constructing an EV with only two or four electric traction-motors, e.g., one or two pairs of electric traction-motors, is not desirable because, FIG. 10 will then display only one or two traces instead of four. This suggests that one pair will have to cover ‘high efficiency range’ of about 90 mph range; two pairs 45 mph range, instead of about 22.5 mph range for each of the four pairs in system 10.

It is definitely possible to design electric traction-motors that can cover efficient operation in a 45 mph range. Yet such electric traction-motors will perform inefficient before and after the narrow 45 mph efficiency ranges-of-operation. In addition, the electric traction-motor must be much larger than the electric traction-motor in system 10, such as: synchronous motors must be utilized, with all the attachments, and with higher production and maintenance costs.

A sophisticated, mechanical AWD architecture manufactured by Audi, a subsidiary of VW, assists the steering by activating the brake calipers. However, this ‘Quattro’ system (FIG. 23) is expensive, is a large piece of equipment, high-priced and with plurality of components, such as: control units, sensors and much more. Between the transmission and the rear differential, Audi designed a multiple-plate clutch with integrated decoupling mechanism, and gears and bearings. An electronic central controller ‘ESC’ attached to multiple sensors to accomplish ‘optimum traction and dynamics.’ In steering modes, the wheel selective torque-controller interacts between brakes & AWD control system to assist the steering. When AWD is not required, the controller de-couples the rear wheels for better efficiency, which supports the fundamental philosophy of the subject disclosure that de-coupling electric traction-motors promotes efficiency.

Audi engineered an advanced version of the Quattro. It is a hybrid AWD system (FIG. 24). An IC engine drives the front wheels—with a transmission bigger than the engine—and an electric traction-motor drives the rear wheels, with a differential, thus making it an AWD system. Another electric motor is integrated inside the IC engine; and together with the electric traction-motor in the rear, it creates an AWD, while operating in an all-electric mode. In comparing both versions, it is impossible to overlook the fact that the AWD system in the hybrid version (FIG. 24) is identical to the full mechanical one (FIG. 23). The electric rear axle is only designed to reduce emission during EPA dynamometer low-speed driving test to obtain a better MPG sticker because, typical mechanical AWD vehicles maintain unfavorable emission and MPG ratings, which is most of the time above federal CAFE standards.

### The Electronic Integration of Traction, Steering and Braking

The concept of making a vehicles steer better by actuating all four wheels has inspired engineers since World War II, when the US Army experimented with all-wheel-steering jeeps. Currently, BMW utilizes ‘Integral Active Steering’ featured on the 7-Series and 5-Series; Infiniti (in their G and M cars), the 2014 Acura RLX; Renault (on the Laguna); and currently the GM Hummer and Tesla's Cyber Truck “crab-mode” steering make use of this technology.

FIG. 25 represent a 200-year-old front steering technology, designed by Rudolph Ackermann (1764-1834) in 1818. Unfortunately, the same design dominates the automobile industry to this day, including the EVs listed in FIGS. 3 and 4. FIG. 26 is a layout of AW (all-wheel) steering, which applies to the subject disclosure. The obvious difference in geometry is the much shorter turning radius; about half the length of conventional steering system, which improves maneuverability to a degree that a driver can perform steering tasks in very narrow lanes, and tight parking spots he could not have manage before. The efficiency benefit materializes in smaller steering-angles of the wheels because, if a two-wheel steering needs 30° to make a specific turn—while dragging the rear wheels—a four-wheel steering will make the same turn with just 150 and with no rear-wheel-dragging. Additionally, a wheel at 30° angle-of-attack creates twice the cornering shear-stress-forces of a wheel in a 15° angle-of-attack, which translates into greater inefficiency. Maneuverability improvement is also a great helps especially for articulated vehicles. The paramount benefits of electronic AWD and AW steering is a direct result of the diminished wheel dragging, which improves the vehicle dynamics and stability, and improve precision in handling and above all the efficiency, without to carry excessive weight and excessive gears as vehicles with mechanical AWD.

In 2014, Infiniti Q50 introduced the first “steer-by-wire” vehicle, meaning there is no mechanical connection between the steering-wheel in the driver hands and the wheels on the street. “Turning the steering wheel sends just electronic signals to the steering-force-actuator, which sends data to the electronic control unit, which forwards it to the steering angle actuator, which turns the wheels” [according to Nissan specs information]. Steering response is quicker and more precise than in a mechanical setup. It also keeps the vibrations from the road from annoying the driver and improves the car's active lane control system. Electronic control includes a car's lane control system, which steps in when the driver drifts out of his lane. The system can adjust steering by electronic means, which is unfeasible with mechanical gears. ‘Steer by wire’ cuts the vehicle's weight since no mechanical gears are utilized, and there is no need of an EPS system, which boost efficiency; make it easier and cheaper to produce a left- and right-hand drive versions of cars; it's an easy jump to systems that can be used by handicaps drivers; it reduces maintenance cost, and creates designing AVs a lot easier.

‘Steer by Wire’ option is not welcomed by all drivers because:

(iv) the additional cost for such system.

(v) for 130 years, sitting at the steering-wheel stands in a figurative sense also for exercise of power. The driver has his vehicle under control over the steering wheel, and he can tear around in extreme situations. It is about being deprived of obedience of sheet metal to the driver's command. It takes years to get rid of human's control syndromes.

(vi) subconscious fear that between steering wheel and wheels on the street no solid connection exists, and steering order transmitted only by data cables.

Safety concerns have slowed the adoption of steer-by-wire technologies. Mechanical systems can and do fail, but conservative regulators, under the influence of insurance company lobbyists, see them as being more dependable than electronic systems. However, time have changed because the automobile industry is experiencing technological transition never materialized in such a degree since 1885. Manufacturers are foisting autonomous driving technologies, which will eventually eliminate most, if not all mechanical components utilized in today's vehicles. Traction and steering “by-wire” is the next step toward that age. In the coming age of self-driving cars, NHTSA would certainly certify AW-steering and AW-drive ‘by wire’ since in today's advanced technologies, a problem is electronically detected before it materializes. Hence, AWD propulsion and AW steering “by-wire” should be safer than any mechanical system FIG. 30).

Back to evolution; most living species are controlling their motoric “by wire” (brain-neurons-muscles). Humans are at the top of the list for their muscle control precision (speech, piano and violin playing.) However, motoric “by-wire” was also utilized by very primitive species that no longer exist, including dinosaurs who lived over hundred million years ago and moved their huge bodies with muscles actuated “by wire.” If it were not safe during 2.5 billion years of evolution, species who carry motoric “by-wire” would have disappeared and replaced by species with better systems. It did not materialize, which makes NHTSA's arguments that “steer by wire” is unsafe without merit; considering steer-by-wire—approved by FAA—is the norm in aviation for decades. A pilot cannot stop in midair to fix his steering.

### BRIEF DESCRIPTION OF THE INVENTION

The instant disclosure is getting to full efficiency requires solutions that can scale; designed from the ground up to scale both economically and environmentally while addressing the essential attributes of efficiency, maneuverability, and safety. The scalable system presented in this disclosure can be used in a variety of vehicle types for the movement of goods and people, making it perhaps the most efficient and versatile driving solution available today; it is a scalable tractive-power system, integrated with all-wheel electronic steering and electric braking systems, which may be applied to any class of vehicles—with two or more wheels—and in infinite configurations. The wide-ranging aspects of this disclosure suggest that EV manufacturers should throw-out all mechanical gears utilized in traditional transportation engineering; skip the design stage of manufacturing EVs in admixture with IC engines; and design vehicles only with electric motors for traction and steering, with electric brake-calipers, while utilizing battery-pack, ultra-capacitors, fly-wheels, fuel-cells and photovoltaic cells as energy storage and production source.

This disclosure comprises of plurality of differently designed electric traction-motors, that may be configured as a single electric traction-motor coupled to the wheel via a driveshaft, or two electric traction-motors sharing a joint shaft in series, coupled to the wheel via a driveshaft, which may comprise the basic traction assembly that propels each wheel individually, with or without reduction gears; connected with or without a drive-shaft directly to each, independently propelled wheel instead of a speed changing transmission and/or a differential assembly. Each electric traction-motor may have its own individual, bidirectional DC-DC converter; and may have its own DC to AC bidirectional inverter. Utilizing DC motor in any section of the design, then no inverter is necessary. To secure precise, while variable torque and angular speed of each individual electric traction-motor coupled to the wheels, the holistic controller may actuate all or less than all electric traction-motors to reach fast response from forward-motion start to the top-rated speed. However, after gaining sufficient kinetic energy, the holistic controller may de-couple selected electric traction-motors, and in any given speed and load, actuate the electric traction-motors, designed to operate most efficient in a specific load and speed ranges.

Coupling and decoupling electric traction-motors in and out of the vehicle tractive system is achieved with electronic-clutches attached to selected electric traction-motor. If one or more electric traction-motors utilizes no electronic-clutches (FIG. 38), these electric traction-motors will operate whenever the vehicle is in motion, which may also represent the minimum traction power the vehicle needs while driving with no-load on flat roads. The sophisticated electronic coupling and de-coupling procedure and the sequence of operation of electronic-clutches is detailed infra.

A four-wheel maneuvering and steering system comprises of four individually controlled electric systems, where each system assigned to specific wheel. Each individual electric steering-motors installed on the vehicle's frame and connected via a tie-rod and a wheel-position sensor to the steering-knuckle of each wheel. Each wheel-position sensor acts also as a traditional tie-rod-end, while continuously monitoring and transmitting to the controller the instant wheel-angle.

During steering procedures, the holistic controller integrates the traction into the steering systems by applying different speed and different torque to opposing wheels to perfect the steering process while replacing the power-steering system. Each wheel-position sensor, in any given point and time, sends ‘by wire’ a continuous, precise information about the instant position of each wheel, with which information the holistic controller computes the precise, mostly different, angle and speed for each wheel during any speed and load conditions. Simultaneously, the holistic controller actuates each steering-motor to bring each individual wheel to the precise computed angle to precisely meet the driver elected steering angel received from the steering-wheel sensor.

The holistic controller receives information from multiple sensors; process the information received, and precisely, in conformity with the program stored in the holistic controller, execute, and coordinate the integration of the tractive-system with the steering and braking systems. This logical operation of all four wheels transpires by actuating precise power, torque, speed, and proper angle of each wheel—rather than only two wheels in the front or the rear—to accomplish an overall traction stability with no-wheel-dragging, and thus, enhanced maneuverability, safety, and maximum efficiency.

This disclosure supersedes the safety and stability benefits of mechanical AWD and AW-steering while abolishing the “side-effects” of imperfect handling control; poor stability and ill-maneuverability; excess weight; poor efficiency; excessive tire wear; and high manufacturing cost caused by multiple obsolete mechanical gears, especially in heavy duty trucks and buses. In addition, with electronically controlled torque, and speed, and while precise positioning of each wheel, the vehicle performance results in a superb performance, which resembles a ‘Cheetah-like’ super-efficient model, by consuming the least energy for better efficiency, and at the same time satisfying propulsion demands. This form of precise calculated energy consumption would provide much longer driving range in one charge, and with up to 60% smaller battery pack, 50% off manufacturing cost; and 30% less weight.

Various other features and advantages are made apparent from the following detailed description and drawings.

### BRIEF DESCRIPTION OF THE DRAWINGS

The drawings illustrate embodiment presently contemplated for conducting the invention. In the drawings:

FIG. 1 represents the first automobile unveiled 1885 by Gottlieb Daimler (1834-1900) and Karl Friedrich Benz (1844-1929), remembered as the beginning of the automobile era with piston-engines. After Henry Ford (1863-1947) introduced the assembly line (1913), it managed to bring the automobile to the masses and a little over a century later, 15 billion vehicles are polluting the atmosphere on a daily basis, much faster than nature can replenish the pollutants. The goal of this disclosure is to bring the pollution level down to a level that nature, and human technologies will prevent further deteriorating of the global environment by replacing the piston-engine automobiles with super-efficient transportation systems.

FIG. 2A depicts two independent systems, which characterize a traditional concept of vehicle manufacturing-propulsion is one system, steering is an isolated system, and braking is a separate system [not shown], with no interaction between the three systems. The first typically propels only the front or only the rear wheels, the second usually steers only the front two-wheels, and the third is usually hydraulic system that decelerates all wheels at the same force when the driver pushes the brake-pedal. There is no bringing together between the three systems. The braking system is independent with no mechanical or electronic connection with any other system at all.

FIG. 2B depicts the fundamental concept of the instant disclosure, namely, a balanced differentiation and integration between traction, steering and braking to realize above 90% vehicle traction and virtually 100% dynamic efficiency.

FIG. 3 is a list of 17 leading manufacturers, introducing 20 BEVs offered for sale in the 2020 model year. No. 21 is a Tesla semi-truck. No. 22 is the specifications of system 10 in this disclosure as described throughout the application; and No. 23 is this disclosure projected semi-trailer specifications. The listing specifies motor[s] in HP/kW, efficiency rating in miles traveled per kWh, battery pack capacity in kWh, traveled range on a single charge in Kilometers, and curb weight of the vehicle in Kilograms.

FIG. 4 is a similar table as FIG. 3; yet the second efficiency-rating at the last column is specifying the specific efficiency of the vehicle electric traction-motors by multiplying the distance traveled by the curb-weight of the vehicle, then dividing by the battery-pack kWh capacity.

FIG. 5A is a block diagram of the entire traction and steering in system 10, according to one of multi-embodiment designs available in the invention. All eight electric traction-motors may be equipped with electronic-clutches to afford the holistic controller maximum options of coupling and de-coupling electric traction-motors to and from the wheels.

FIG. 5B is a block diagram of the entire traction and steering in system 10, according to one of multi-embodiment designs available in the invention. However, only six electric traction-motors may be equipped with electronic-clutches, while two—small electric traction-motors in the rear (with 7.5 kW, see [0060] supra)—have no electronic clutches to efficiently run the vehicle at 100 Km/h while all other six electric traction-motors are de-coupled from the wheels.

FIG. 5C is a block diagram of the entire traction and steering in system 10, according to one of plurality embodiment designs available in the invention. Only six electric traction-motors may be equipped with electronic-clutches, while two—small electric traction-motors in the front of the vehicle (with 7.5 kW, see [0060] supra)—have no electronic clutches to efficiently run the vehicle at 100 Km/h while all six electric traction-motors are de-coupled from the wheels.

FIG. 5D is a block diagram of the entire traction and steering in system 10, according to one of plurality embodiment designs available in the invention. Four electric traction-motors may be equipped with electronic-clutches, while two electric traction-motors in the front and two in the rear—small electric traction-motors in the rear (with 7.5 kW, see [0060] supra)—have no electronic clutches to efficiently run a larger vehicle at 100 Km/h while all four electric traction-motors are de-coupled from the wheels.

FIG. 6 is a schematic of present and future prediction diagram of Tesla's vs. the average market cost of batteries; dollars per kWh.

FIG. 6a depicts the ideal, future production, transport, and utilization of hydrogen in times when green energy-solar, wind and hydro-power-becomes so inexpensive that the production of Hydrogen through hydrolysis is commercially viable.

FIG. 7 is a schematic diagram of the narrow useful range of torque and power over speed (i.e., RPM) in two representatives of the IC engines family; namely, diesel, and gasoline.

FIG. 8 is a diagram of typical three-phase induction-motor displaying a much wider range of torque and efficiency than an IC-engines.

FIG. 9 is a typical schematic diagram of energy consumption in relation to speed in a typical EV with induction or synchronous-motor, which represents the majority of EVs listed in FIGS. 3 and 4.

FIG. 10 is a schematic of optimal power distribution with the least energy use-up among four-pairs of electric traction-motors, which is the crux of this disclosure. Each trace represents the efficiency and torque vs speed for each pair of electric traction-motors. Each electric traction-motor-pair operates very efficient in a specific load and speed interval and are replaced by another electric traction-motor-pair when the EV load and speed exceeds the optimal efficiency range of the specific electric traction-motor-pair. The four-pairs of electric traction-motors are overlapping each other's ranges of ‘high-efficiency’ to build a continuous efficient traction from forward motion start to over 100 mph, while providing the essential speed and power demand.

FIG. 11 is a diagram of a Cheetah with the complexity of multiple muscles [motoric system] necessary to create the Cheetah's four-Pedi precision motoric to establish the fastest animals on the planet.

FIG. 12 depicts detailed cross-section of the front left and right tractive apparatus of system 10, which consist of a pair of electric traction-motors 53, 54, their individual electronic-clutches 86a, 86b, the clutches release and pull-back electromagnetic solenoids 84a, 84b [see also FIGS. 15, 16] with all the accessories.

FIG. 13 is a cross-section of the rear right & left electric traction-motors of system 10 as depicted in FIG. 5A, which consist of two different electric traction-motors 57, 58 with their individual electronic-clutches and the clutches release and pull-back electromagnetic solenoids, which is a similar layout to FIG. 12 yet one of the electric traction-motors is with different torque and power configuration.

FIG. 13A is a cross-section of the rear right & left electric traction-motors of system 10 as depicted in FIG. 5B, which consist of two different electric traction-motors 57 with an electronic-clutch with the clutch release and pull-back electromagnetic solenoids, which is very similar layout to FIG. 12 yet one of the electric traction-motors is with smaller power configuration and is with no electronic-clutch. A clutch-less electric traction-motor pairs in the rear or in the front axle may be the only tractive power coupled to the wheels at 60 mph on flat HWY for outstanding efficiency.

FIG. 14 is a cross-section of a single electric traction-motor with steering assembly, representing an alternative for small cars, utilized in the front or the rear axle instead of two electric traction-motors sharing a common axle in each wheel.

FIG. 15 is a chart representing the torque and power versus speed, which applies to the traction systems in FIGS. 12, 13, and 13A for the operation of electric traction-motors 53, 54 and 57, 58, respectively.

FIG. 16 depicts a detailed side-view and a cross-section of an electronic-clutch release and pull-back scheme with all the different electronics, solenoids and hardware involved.

FIG. 17 depicts a side view of the motor-side electronic-clutch-disc with the splines, inside and outside the disc cylinder, and the wheel-side disc-clutch permanently attached to the wheel.

FIG. 18 displays a typical layout of the rear-wheels suspension supported with multiple reinforcing-links and stabilizing-bars in all directions to prevent skidding.

FIG. 19 represents the entire rear-suspension assembly with links and stabilizer-links attached to the vehicle's chassis; and a differential that transfers power to the wheels with two drive-shafts. All the mechanical aggregates will become obsolete in the subject disclosure, as represented in system 10 [FIGS. 5].

FIG. 20 is a layout of a traditional mechanical front-wheel suspension in a vehicle with mechanical steering. No reinforcing bars are necessary since steering wheels perpendicular to the turning circle eliminates the dragging element.

FIG. 21 is a prototype suspension to fit all four wheels—with minor changes between the front and the rear suspensions—since all wheels are steered, there are no supporting-links, and stabilizing-bars. Noticeable is the wheel-position sensor at the end of the tie-rod connected to the wheel knuckle [not shown].

FIG. 22 represents a system developed by Protean Electric in Michigan, incorporating a single electric traction-motors inside the wheel, and propelling the vehicle with 2- or 4-wheel direct-drive “by wire.”

FIG. 23 displays a sophisticated, mechanical AWD, manufactured by Audi. Yet, this ‘Quattro’ [AWD] system propelled by an IC engine and a large transmission, is expensive with multi-element piece of equipment, consisting of control units, sensors and much more beside the engine, transmission, and differentials. The system also assists the steering by activating selected brake calipers.

FIG. 24 is Audi's ‘e-Tron Quattro.’ Hybrid AWD system, consisting of an IC engine that drives the front axle, and the electric part of the AWD system, with an electric motor and a differential, powers the rear axle, thus making it an AWD system. Another electric motor installed inside the IC engine, and together with the electric motor that propels the rear wheels it creates an AWD, operating as all-electric mode.

FIG. 25 displays a 200-years old geometry of front wheels mechanical steering designed 1818 by Rudolph Ackermann (1764-1834) and is unfortunately still dominating the automobile industry, including all EVs listed in FIGS. 3 and 4.

FIG. 26 is a layout of AW-steering as depict in 1 FIG. 5. The obvious difference in geometry is the length of the turning radius in the AW-steering vehicle, which is half the length of a conventional steering system depicted in FIG. 25, which provides a much smaller turning circle.

FIG. 27A is a layout of a vehicle making 90° turn to the right at low-speed where controller 100 applies precisely computed higher speeds to the left-side wheels; and simultaneously activate all four electric steering-motors, and selected electric traction-motors, to position each wheel 90° to the turning-center.

FIG. 27B is a layout of a vehicle making a high-speed steering while changing lanes, where controller 100 applies the same speed to all wheels; and simultaneously, activate all four electric steering-motors, and selected electric traction-motors.

FIG. 28 depicts the preferred design of a steering-wheel sensor, emulating nature's sensor design with one sensor one nerve configuration. This particular sensor [#90 in FIGS. 5] comprises of 60 leaflets, representing 60 different angles the vehicle may turn to. Each leaflet individually connected by wire directly to controller 100, transmitting by electronic means the driver's elected steering angle.

FIG. 29 depicts a different steering-wheel sensor configuration comprising of 60 resistors connected in series, which represents 60 different angles the vehicle might turn to in system 10. The steering sensor is configured as “add-up” resistance. Controller 100 recognizes a specific angle by the ‘added-up’ resistance in the circuit.

FIG. 30 represent a schematic of fail-assist scheme that complies with NHTSA's “fail operational systems” for ‘steering by wire.’ If one contact leaflet is defective, broken, disconnected or malfunctioning, controller 100 utilizes the readings of the last and/or the next leaflet—which may be merely 1° difference between the leaflets—to keep the wheel within safe range of only 1.66% error; and activate specific warning signal to alert the driver of the malfunctioning leaflet.

FIG. 31 is a schematic, displaying the relation between wheel angle and speed in relation to FIG. 27A where the vehicle makes a 90° right turn. Because the distance to the turning-center for both left wheels is much greater [14.6′] than the distance to the turning-center for both right wheels [10′], the left wheels have to travel a precisely computed longer distance—at the same time period as the right wheels—to make a perfect turn, with no wheel-dragging.

FIG. 32 is a schematic, displaying the relation between the non-linear L/R wheel angle and their respective revolutions. In other words: how many revolutions each wheel has to accomplish to pull off the turn without power steering assistance and with no wheel dragging.

FIG. 33 is an electric-steering-configuration, usually utilized in front wheels for quicker steering-response. The wheel-position sensor shows in four different views. A is a central cross-section with the outer tie rod; B is a view from the top of the sensor; C is also a center cross-section but is 90° to the A cross-section; and D is a bottom view of the sensor.

FIG. 34 is an electric-steering-configuration, usually utilized in rear wheels, and in wheels of articulated trailers. All components are identical to the design in FIG. 33; however, the electric steering-motor configured with a rotor that is modified into a big threaded nut 118.

FIG. 35 make obvious the lack of maneuverability of a traditional class-8 semi-trailer with only two steerable wheels in the very front of the semi-tractor, making a 90° right turn at low-speed, which requires a 33′ feet lane-width.

FIG. 36 is a single electric traction-motor equipped with electronic-clutch, configured to couple and de-couple electric traction-motors to and from wheels as utilized in cars, trucks, buses, and semi-trailers. This configuration lacks a steering system because in vehicles, specific axles at the vehicle center face 90° to the turning-center.

FIG. 37 is a different configuration; a combination of two electric traction-motors with electronic-clutches, utilized in buses, light- and heavy-duty trucks that have only two or three axles, to manage more tractive-power configurations.

FIG. 38 is a single electric traction-motors without electronic-clutches because, in specific vehicles, and in different electric traction-motor configurations, there might be a design in which a specific electric traction-motors are engaged in the tractive-power of the vehicle at all times. It is usually a more powerful electric traction-motor-pairs that represents the minimum tractive-power needed to run a vehicle on a flat road, and with no load [usually in commercial vehicles].

FIG. 39A displays a suggested design of six electric traction-motors for a semi-tractor. The electric traction-motors might be designed with the same, or different specifications. Yet, the two rear-axles may or may-not be steerable; and the electric traction-motors pair in the very rear axle may be large electric traction-motors without electronic-clutches, which may run the semi-trailer without load while all other four electric traction-motors are de-coupled.

FIG. 39B is a steerable, electronic rear-axles in a semi-tractor, to perform a limited degree of steering as ‘crab-mode steering’ when changing lanes on the highway where: 9 is a yaw-sensor; 23 is a large ball-bearing steering-screw; 24 are two steering-rods; 25 a steering-motor; 26 are two tie-rods; 27 is a large ball-bearing steering-screw; 28 are two steering-screw heads; and 72 are two long steering-columns with a spur- or helical-gears.

FIG. 39C is the front or rear-view of independently rotating wheels-assembly as depict in FIG. 39B; where: 9a and 9b are top and side view of the yaw-sensor, respectively; 26 a tie-rod; 50 and 51 are the semi-tractor chassis metal roof and floor, respectively as additional support and stability to opposing electric traction-motors; 54 are steering-studs that stabilizes and guide an electric traction-motor during steering maneuvers; and 72 is a spur- or helical-gear long steering-columns, getting its stability by being supported by the bogie metal roof 50 and floor 51.

FIG. 39D is a steerable rear axles configuration of a semi-tractor and a semi articulated trailer, configured with a pair of large electric traction-motors without clutches, and a pair of medium-size electric traction-motors with electric-clutches moving on a curved track. The drawing demonstrates the movement of all steering parts as numbered in FIG. 39B.

FIG. 40 is a different configuration of the four electric traction-motors at the rear of the articulated-trailer, configured with electronic-clutches. After forward-motion-start the holistic controller may disconnect any electric traction-motor-pairs to reduce energy use-up whenever the tractive-power contribution of the de-coupled electric-traction-motors is not necessary. All 4-wheels in the trailer are steerable.

FIG. 41A depicts a semi with steerable articulated-trailer rear-axles, with which the semi-trailer exhibits a remarkable reduction in the outer radius when the trailer rear axles are steerable. Optimal setting is when the tandems center in the trailer is following exactly the curve as the center front tractor axle (heavy line).

FIG. 41B is an all-wheel steering semi-tractor and articulated-trailer in a ‘crab-mode’ steering, changing lanes on the highway.

FIG. 42 represent the ability of controller 100, configured with total control over all traction-motor's torque and speed; and total control over all steering-motor activities while controlling the tractive-effort, the speed, and the position of each wheel, to prevent the driver from choosing an unsafe range of speed at any desired turning angel. The controller utilizes the vehicle center of gravity to compute the threshold-point in which the vehicle may overturn in any combination of turning angles and speed. The controller utilizes multi-objective optimization design (MOOD) programs to generate an algorithm that computes a safe speed limit below a safe threshold-point that may endanger the vehicle stability yet afford the driver to make the turn safely in a reasonable speed to prevent the vehicle from turning-over, even though the driver may have pushed the accelerator to the floor.

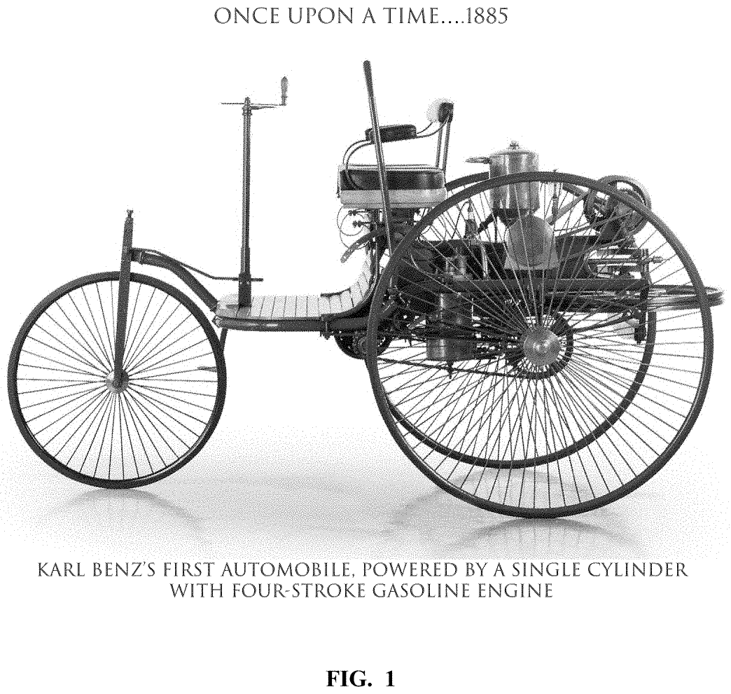

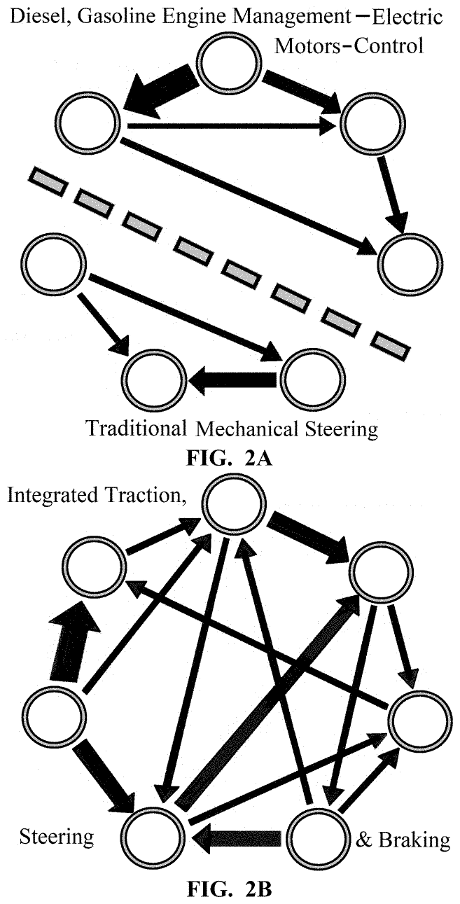

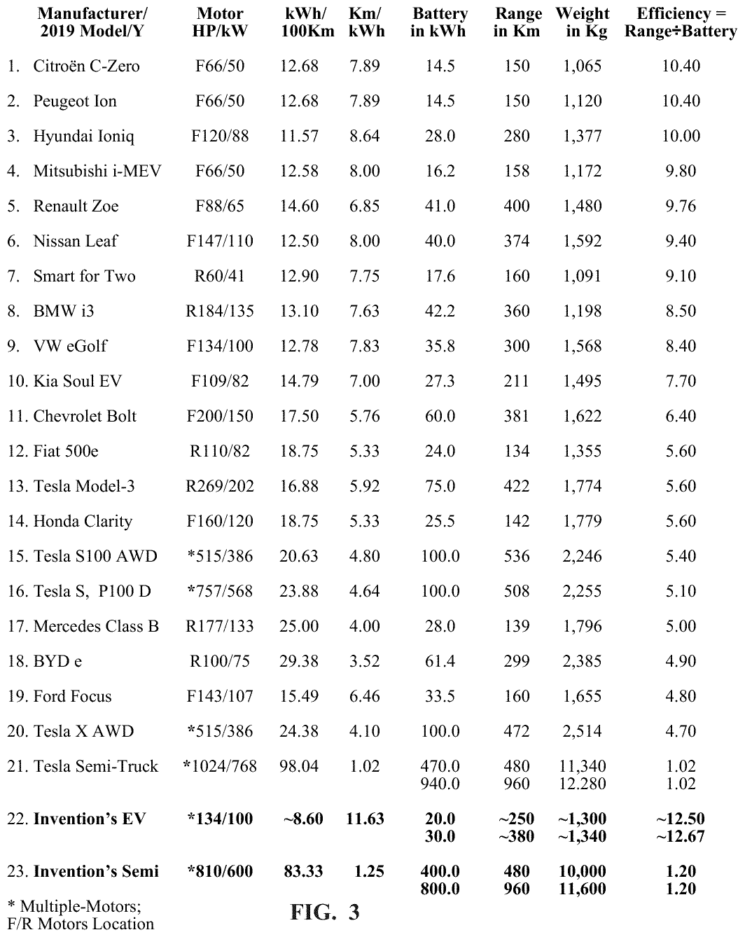

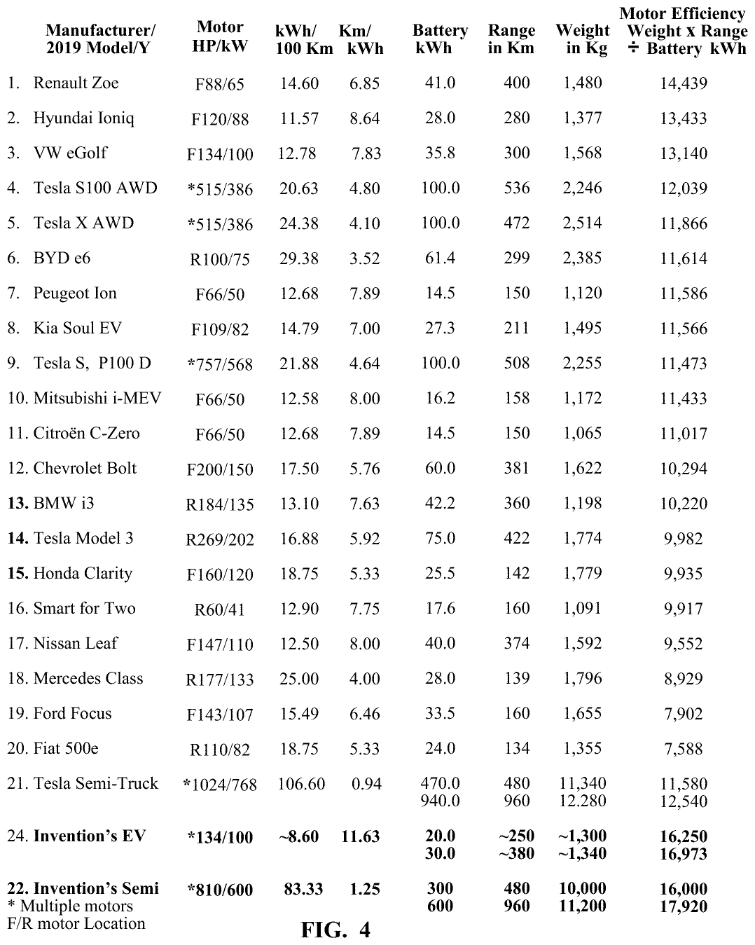

Various other features and advantages will be made apparent from the following detailed description and drawings.

### DETAILED DESCRIPTION OF THE INVENTION

The embodiment of the present disclosure is described herein. It is to be understood, however, that the disclosure embodiment can take various and alternative forms. The figures are not necessarily to scale; certain features may be exaggerated or minimized to show details of particular components. Therefore, specific structural and functional details disclosed herein are not to be interpreted as limiting, but merely as variously employ the present invention. As those of ordinary skill in the art will understand, various features illustrated and described with reference to any one of the figures can be combined with features illustrated in one or more other figures to produce embodiment that are not explicitly illustrated or described. Various combinations and modifications of the features consistent with the teachings of this disclosure, however, could be desired for particular application or implementation.

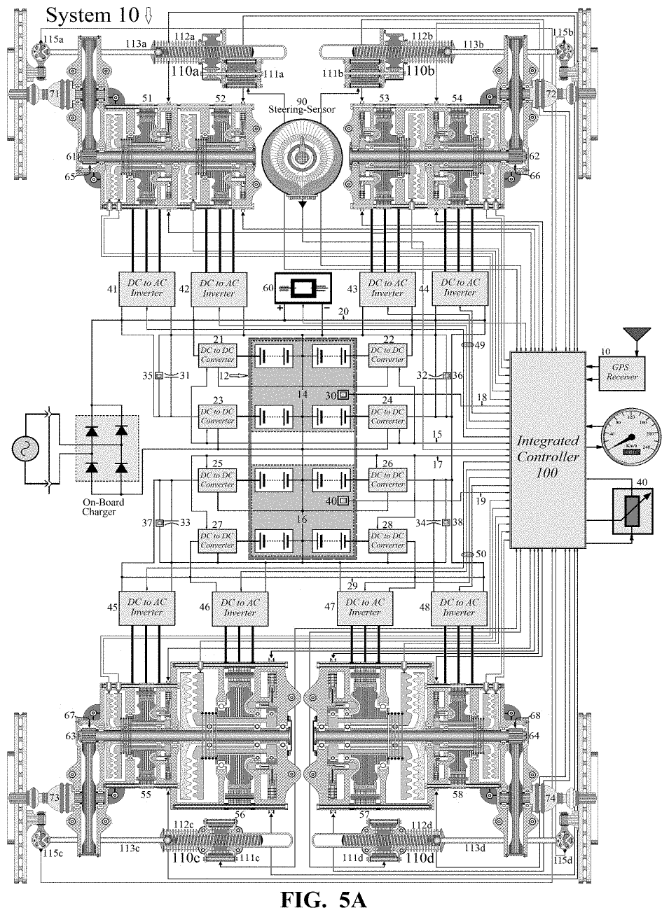

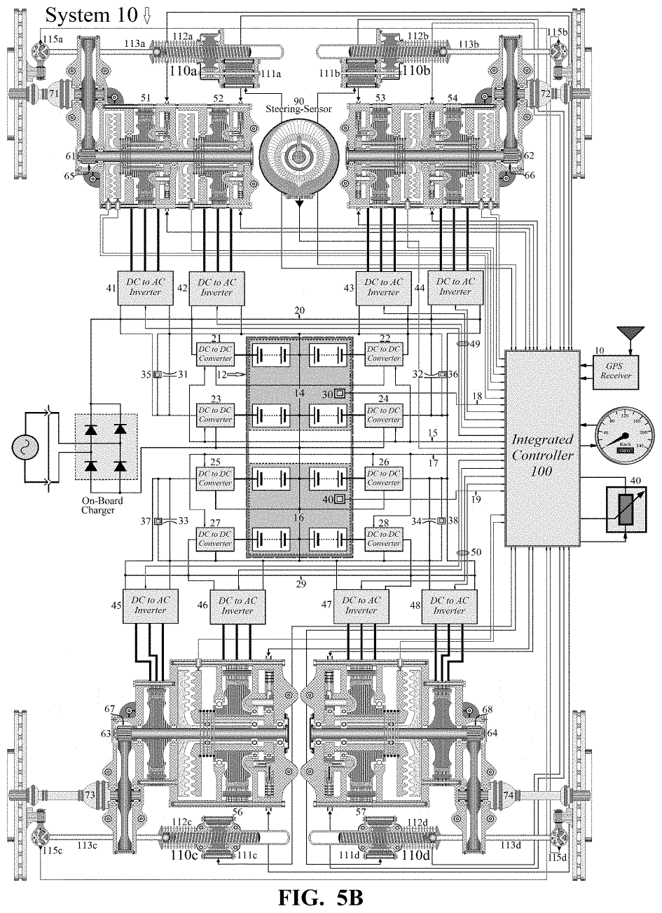

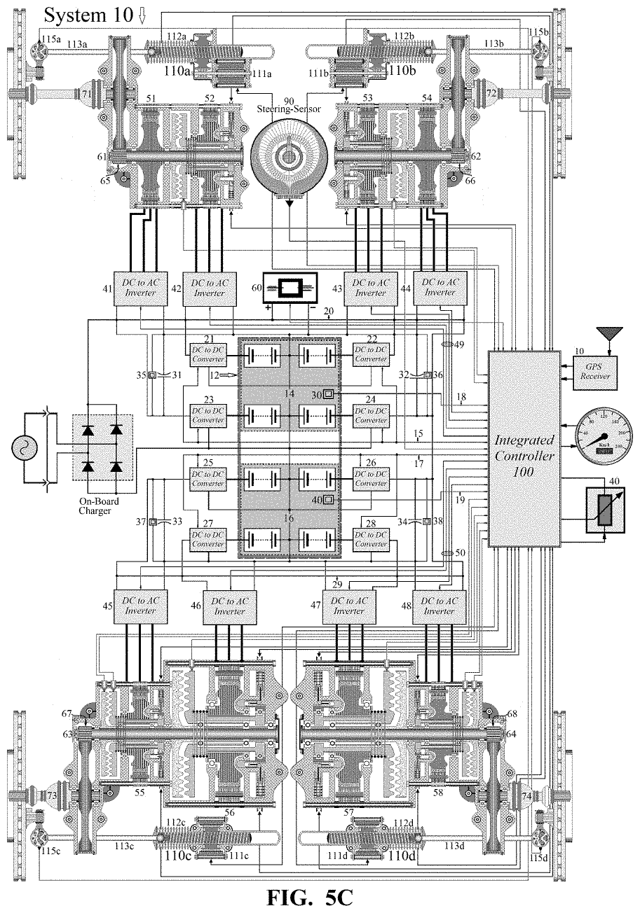

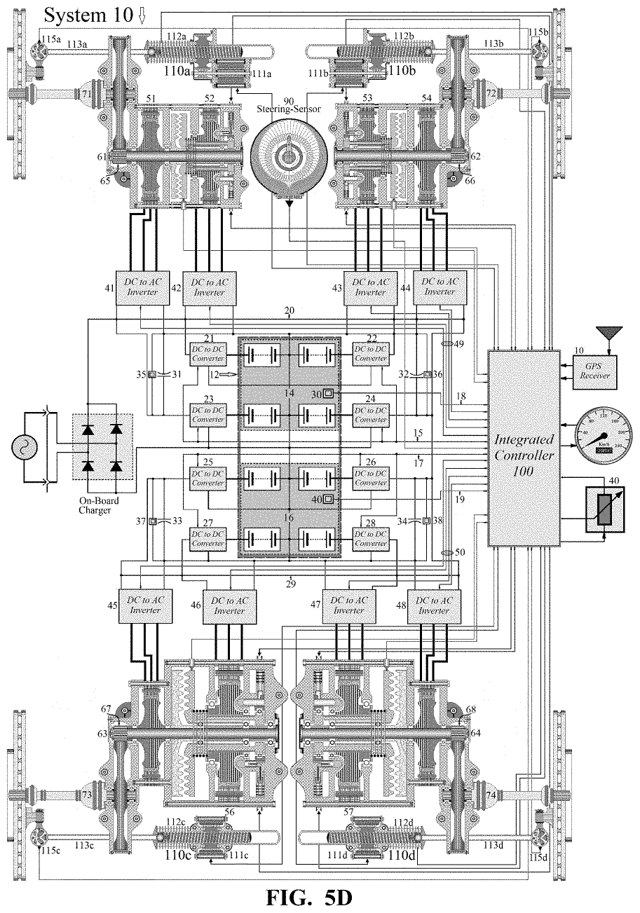

Referring now to the drawings wherein like reference numerals are used to identify identical components in the various views. FIG. 5A is a block diagram view of system 10, which is one of infinite scalable tractive-power system for EVs embodiment of the invention. As will be described in detail infra, traction, steering and braking in system 10 may be configured in battery electric (BEV) traction system arrangement that splits power output between one pair or plurality of electric traction-motors pairs. Another system configured as hybrid electric (HEV) traction system that includes an internal combustion engine in addition to one or more electric traction-motors. Additional hybrid combination of power configured with fuel cell electric vehicles (FCEV) that includes hydrogen fuel cells in addition to other energy producing devices. The above configuration applies also to trucks, semi-trailers, buses, and all-purpose vehicles.

### AWD-EVs with Differently-Designed Electric Traction-Motors

In various embodiment of this invention, the AWD traction segment of system 10 configured to be incorporated into diverse types of vehicles. The electric traction-motors in system 10 (FIG. 5A) may include a singular, or divided energy storage-system 12, with front energy storage 14 and rear energy storage 16. Each energy storage unit 14, 16 may have four positive terminals that are directly connected to each individual bi-directional DC-DC Converter, 21, 22, 23, 24, 25, 26, 27 and 28. Each energy storage unit 14, 16 may also have four negative terminals that are directly connected to each individual bi-directional DC-DC Converter, 21, 22, 23, 24, 25, 26, 27 and 28. Each of the energy storage units 14, 16 may have a separate or an integrated power management energy storage system [not shown], which may be configured as a battery management system. According to another embodiment, DC-DC converters 21, 22, 23, 24, 25, 26, 27 and 28 are bi-directional buck/boost voltage converters.

In energy storage units 14, 16, within system 10, sensors 30, 40 may be provided to monitor and compute the state-of-charge of energy storage units 14, 16. According to one embodiment, sensors 30, 40 may include voltage and current sensors configured to measure the voltage and current of first and second energy storage units 14, 16 during operation of system 10.

According to various embodiment, first and second energy storage units 14, 16 may include one or more energy storage or energy producing devices such as batteries, ultra-capacitors, flywheels, photovoltaic cells, fuel cell or a combination of all five components, in various percent of their representation within each energy storage units 14, 16. Other embodiment may be where energy storage units 14, 16 incorporate ultra-capacitors with numerous capacitor-cells couple to one another, where every single capacitor-cell may have a capacitance between 500 and 3000 Farads—or greater. Ultra-capacitors offer nearly instantaneous power bursts during periods of peak power demand, therefore they may be implemented as a secondary energy source that complements the primary batteries sources that suffer fast deterioration when repeatedly providing quick bursts of power; and since traditional battery energy storage have problems supporting high-power features—such as frequent start-stop vehicle uses, especially at lower temperatures—a secondary energy source with ultra-capacitors may be utilized to overcome this limitation.

In different embodiment, first and second energy storage units 14, 16 may be with high power battery-packs, with density more than 500 Wh/Kg. Other embodiment may be where energy storage units 14, 16 integrate high density batteries detailed above, in combination with ultra-capacitors.

In other embodiment, first and second storage units 14, 16 are a low-cost lithium-ion batteries. Alternatively, first and second storage units 14, 16 may comprise of a Silicon or Magnesium-anodes in Lithium-Sulfur battery; Sodium metal hybrid battery; a Sodium Sulfur battery; a Nickel metal hybrid battery; a Zinc-air battery, a Lead-Acid, or any other combinations of low-constituent battery.

The scalable traction in system 10 may include: four bi-directional DC-DC converters 21, 22, 23 and 24, as integral components of the propulsion of the front wheels; and four bi-directional DC-DC converters 25, 26, 27 and 28, as integral components of the propulsion of the rear wheels, which are coupled across the positive DC link 20 and link 29 in the front and the rear bi-directional DC-DC converters respectively. The negative link begins in energy storage units 14, 16, and coupled on the negative side of each component in system 10.

System 10 may include front left bi-directional DC-DC converters 21, 23 may connect across the positive and the negative DC link with DC bus 31 that may connect to voltage sensor 35 to monitor the bus voltage. Bi-directional DC-DC converters 22, 24, 25, 27, 26 and 28 may maintain the same set-up as bi-directional DC converters 21, 23 respectively; that is, DC bus 32, 33 and 34 may connect in parallel with a separate voltage sensor 36, 37, 38 to monitor the voltage in DC bus 32, 33 and 34, respectively.

To reduce the number of components in system 10; a different embodiment may fit where the front and rear energy storage units 14, 16 may be equipped with specific batteries that the respective bi-directional DC-DC converters may be left out. This will simplify production and reduce overall production cost. In such embodiment, a solenoid provides to selectively couple energy storage units 14, 16 to the respective DC bus.

All bi-directional DC-DC converters 21, 22, 23, 24, 25, 26, 27 and 28, when in use, is configured to convert one DC voltage to another DC voltage, either by bucking or boosting the DC voltage. According to one embodiment, each bi-directional DC-DC converter 21, 22, 23, 24, 25, 26, 27 and 28 includes an inductor coupled to a pair of electronic switches and coupled to a pair of diodes. Each switch coupled to a respective diode, and each switch/diode pair forms a respective half phase module. Switches may be isolated gate bipolar transistors (IGBT), metal oxide semiconductor field effect transistors (MOSFET), silicon carbide (SiC) MOSFET, gallium nitrite (GaN) devices, bipolar junction transistors (BJT), and metal oxide semiconductor-controlled thyristors (MCT).

In system 10, both energy storage units 14, 16 coupled via DC bus 31, 32, 33 and 34 to all electric traction-motors or any other combination of partial loads. The holistic controller may actuate any number of electric traction-motors in any driving procedure, speed, or load conditions, using multi-objective optimization algorithm to determine which of the electric traction-motors configurations would consume the least Kw in any given driving procedure to reach the best, most efficient traction.

In one embodiment of system 10, each DC to AC inverter 41, 42, 43, 44, 45, 46, 47 and 48 includes six half phase modules that are paired to form three phases, with each phase is coupled between the positive DC links 20, 29 of the DC bus 31, 32, 33 and 34 and the overall negative links of system 10.

Each electric traction-motors 51, 52, 53, 54, 55, 56, 57, and 58 includes a plurality of winding coupled to respective phases of its respective DC-to-AC voltage inverter 41, 42, 43, 44, 45, 46, 47 and 48. The arrangements and design of electric traction-motors 51, 52, 53, 54, 55, 56, 57, and 58 is limitless. Electric traction-motors 51, 52, 53, 54, 55, 56, 57, and 58 may either be a variety of AC motors, DC motors, fraction motors, and/or generators. It contemplates thus, that three-phase inverters 41, 42, 43, 44, 45, 46, 47 and 48 described herein may utilize any number of phases in alternative embodiment.

According to other embodiment, system 10 could be configured as genuine electric traction, steering and braking system. Alternatively, system 10 could be configured in a hybrid electric vehicle (HEV) traction system, which also includes an IC engine [not shown], coupled to electric traction system by mean of shared transmission [not shown]. System 10 could be configured in as fuel cell electric vehicles (FCEV) propulsion system, which also includes fuel cell [not shown] that may be coupled to distinctive design of energy storage unit 14, 16.

Traction, steering and braking system 10 may include geared power-transmissions [not shown in detail], 65, 66, 67 and 68 coupled to four joint shafts 61, 62, 63 and 64 that may be shared by two electric traction-motors when actuated by controller 100. The four-geared power-transmissions 65, 66, 67 and 68 [not shown in detail], may be constructed as single or multi-gear drive assemblies; toothed belt drive; chain drive assemblies or combinations thereof, according to innumerable embodiment. According to other embodiment, four geared power-transmissions 65, 66, 67 and 68 [not shown in detail], may be configured as electronic-variable transmission (EVT) that couples the outputs joint shafts 61, 62, 63 and 64 of electric traction-motors 51, 52, 53, 54, 55, 56, 57, and 58 to an internal planetary gear [not shown]. In operation, electric traction-motors 51, 52, 53, 54, 55, 56, 57, and 58, may be operated interchangeably over their specific high-efficiency range of bi-directional speed, torque, and power commands to minimize energy loss and maintain high degree of overall system efficiency while system 10 is operating in either charge depleting (CD) or charge sustaining (CS) mode of operation.

The power outputs of four geared power-transmissions 65, 66, 67 and 68 are coupled directly to each corresponding driveshaft 71, 72, 73 and 74 of the vehicle since no differentials are necessary in this electric AWD traction, steering and braking of system 10.

Controller 100 that runs and operates System 10 is connected to all eight bi-directional DC-DC converters 41, 42, 43, 44, 45, 46, 47 and 48 by control lines 15, 17. In one embodiment, control lines 15, 17 may include a real or virtual communication data link that conveys the voltage commands to the respective bi-directional DC-DC converters 21, 22, 23, 24, 25, 26, 27 and 28. Through appropriate control of switches in the front bi-directional DC-DC converters 21, 22, controller 100 is configured to boost voltage of first energy storage unit 14 to higher voltage and to supply the higher voltage to DC bus 31, 32 during the various modes of propulsion. Likewise, through appropriate control of switches in the front bi-directional DC-DC converters 23, 24, controller 100 is configured to boost voltage of first energy storage unit 14 to higher voltage and to supply the higher voltage to DC bus 31, 32 during various traction procedures. In the same way, through appropriate control of the switches in the rear bi-directional DC-DC converters 25, 26 controller 100 is configured to boost voltage of second energy storage unit 16 to higher voltage and to supply the higher voltage to DC bus 33, 34 during various traction procedures. Likewise, through appropriate control of the switches in the rear bi-directional DC-DC converters 27, 28 controller 100 is configured to boost voltage of second energy storage unit 16 to higher voltage and to supply the higher voltage to DC bus 33, 34 during the various Traction procedures.

Additionally, during charging or during regenerative mode of operation, controller 100 is configured to control switching bi-directional DC-DC converters 21, 22, 23 and 24 in the front of the vehicle; and bi-directional DC-DC converters 25, 26, 27 and 28 in the rear of the vehicle to buck voltage of DC bus 31, 32 in the front and DC bus 33, 34 in the rear and supply the bucked voltage to the respective first and second energy storage units 14, 16.

System 10 may be implemented in infinite configurations. To fit this scalable, integrated all-wheel electric traction, steering, and braking in any vehicle, the variables may include the number and design of the electric traction-motors, the power and torque rating, and the design of the algorithms inside the logic data base of holistic controller 100. System 10, as depict in FIG. 5, is configured to operate with eight electric traction-motors that is divided into four pairs of electric traction-motors. Each pair is comprising of similar construction, design, torque, and power output. During any driving mode, controller 100 is configured to operate at least one electric traction-motor pair. Therefore, front electro-mechanical pairs 51, 54 and/or 52, 53; and rear electro-mechanical pairs 55, 58 and/or 56, 57 or any combination thereof, may be actuated simultaneously at the same time. However, since ‘electro-mechanical pair’ are always installed on opposite sides of the vehicle, to maintain balanced propulsion, controller 100 may operate a specific pair of electric traction-motors at the same time, but may elect to, and maintain diverse torque and speed (RPM) between the two-electric traction-motors in steering and braking procedures, and in slippery roads or in any other driving conditions that such diversion of same torque and same speed is required.

In all traction, steering and braking procedures, controller 100 is coupled individually to all four DC to AC voltage inverters 41, 42, 43 and 44 in the front of the vehicle through control lines 49. Controller 100 is also configured to control the half phase modules of the front DC to AC voltage inverters 41, 42, 43 and 44 to convert the DC voltage on DC bus 31, 32 to AC voltage for supply individually to each electric traction-motors 51, 52, 53 and 54, as part of the front propulsion. In forward-motion start, in changing speed, in acceleration or deceleration, or in any change of load, controller 100 may increase or decrease the voltage and increase or decrease the frequency modulation in selected DC to AC inverters 41 42, 43 and 44, through lines 49, with which the revolutions—in electric traction-motors 51, 54 or 52 and 53, or in all four electric traction-motor together—are boosting or bucking to increase or decrease the speed of the vehicle.

Similar operation takes place through control line 50. Controller 100 is configured to control the half phase modules of the rear DC to AC voltage inverters 45 46, 47 and 48 to convert the DC voltage on DC bus 33, 34 to AC voltage for supply to electric traction-motor 55, 56, 57 and 58 as part of the rear propulsion. In forward-motion start, in changing speed, to acceleration or deceleration, controller 100 may increase or decrease the voltage and increase or decrease the frequency modulation in selected DC to AC inverters 45, 46, 47 and 48, through lines 50, with which the revolutions—in electric traction-motors 55, and 58 or in electric traction-motors 56, and 57 or all four electric traction-motors together—are boosting or bucking to increase or decrease the speed of the vehicle. DC to AC inverters, and electric traction-motors may be different in size and specifications. Nevertheless, controller 100 MO does not change thus, it may be programmed to fit all kind of specifications, utilizing machine learning procedures.

In a regenerative [charge sustaining] mode, controller 100 is configured to control DC to AC voltage inverters 41, 42, 43 and 44 in front of the vehicle through control lines 49 to invert an AC voltage received from its corresponding electric traction-motors 51, 52, 53 and 54 into a DC voltage to be supplied to DC bus 31, 32. Similar condition of operation takes place through control line 50 in the rear of the vehicle, which may contain the same configuration as the front of the vehicle.

During operation, controller 100 receives continuous feedback from plurality of sensors, while transmitting control commands to other components within the Traction, steering and braking operation. In this instance of system 10, holistic controller 100 receives via control line [not shown], specific feedback from voltage sensors 35, 36 coupled in parallel to DC bus 31, 32; and from energy storage unit sensor 30 via control line 18. Controller 100 also receives via control line [not shown], specific feedback from voltage sensors 37, 38 coupled in parallel to DC bus 33, 34; and from energy storage unit sensor 40 via control line 19.

### The Ultimate all-Wheel Electronic Steering

The steering capacity of system 10 is configured to be incorporated into various embodiment, in miscellaneous types of vehicles, including but not limited to, automobiles, light-duty trucks, delivery trucks, buses, semi-trailers, commercial and industrial vehicles such as mining and construction equipment, marine craft, aircraft, off-road vehicles, material transport vehicles and personal carrier vehicles.

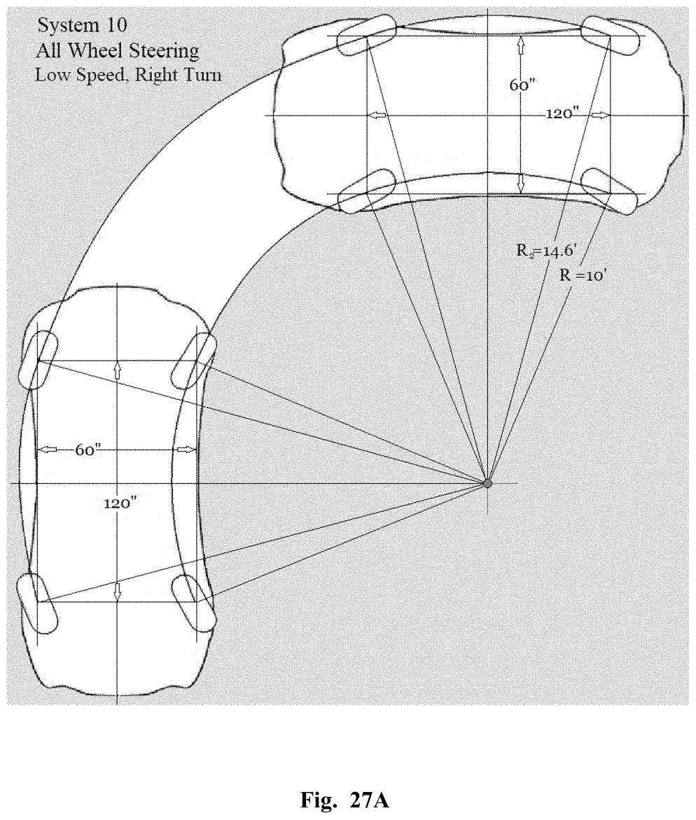

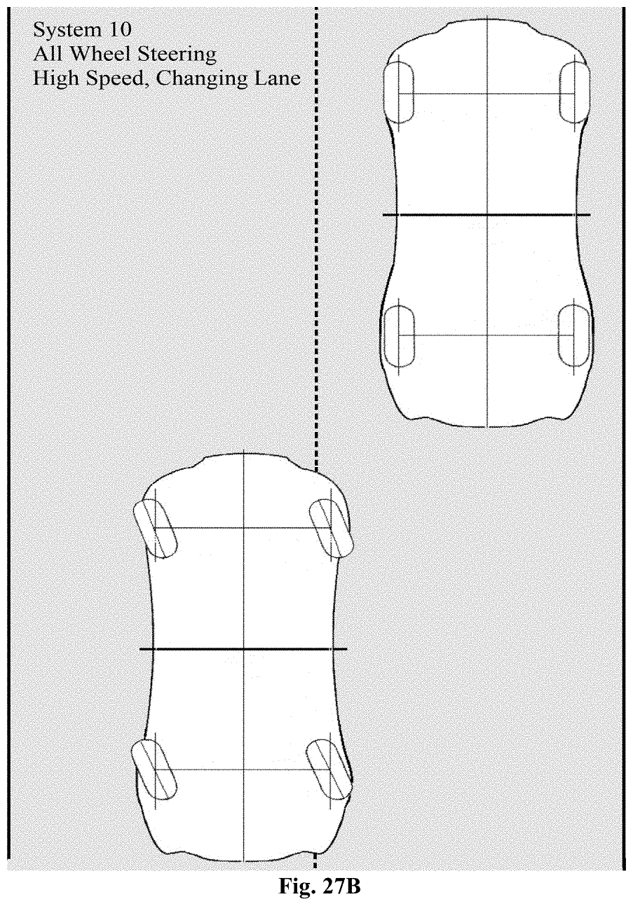

According to the embodiment of the present invention, at some point during vehicle steering—as pre-programmed in the data base—the holistic controller 100 may apply various speeds and load to the left and to the right wheels; and simultaneous, activate all four-electric steering-motors, to position each individual wheel 90° to the turning center, which is the core of this integrated traction, steering and braking disclosure, as depicted in FIGS. 26, 27A and 27B.

To achieve the precise steering maneuver—which is to steer and propel all 4-wheels at the same time—controller 100 is conducting the following steering steps:

(vi) the electric traction-motors that are coupled to the wheels should operate all the time in their optimal range of operation.

(vii) the electric traction-motors should be integrated in the vehicle steering and braking, for better efficiency, stability, and much better handling. Integration of traction, steering and braking will also dispose-of the power steering system, and other redundant mechanical unnecessary gears, to reduce weight, improved efficiency, and lower production cost.

(viii) during low-speed steering, all four wheels may be positioned perpendicular to the turning-center to eliminate wheel dragging (see FIG. 27A), depending on the velocity of the EV.

(ix) in velocities above 50 Km/h, the rear-wheels are positioned at the same directions as the front wheels, not necessarily at the same angle. The exact rear-wheels angle may be determined with empirical testing since it depends on the vehicle's wheelbase, the distance between the left-side and right-side wheels, the vehicle weight, center of gravity, and purpose of the vehicle; and

(x) in multi-wheel-vehicles, AW-steering will stabilize the vehicle and improve efficiency to a greater extent than light duty vehicles with four-wheels. When changing the steering angle of the front axle, the longitudinal axis of the vehicle must be taken into consideration and stored in controller 100 data base, to provide individual, and accurate steered angle for each steerable wheel along the vehicle and the trailer. This will also comply with NHTSA's new FMVSS 136 for semi-trailer and certain buses with GVWR of 26,000 Lb. [about 12,000 Kg], which will reduce untripped-rollovers, and mitigates severe understeer or oversteer conditions that usually leads to loss of control.

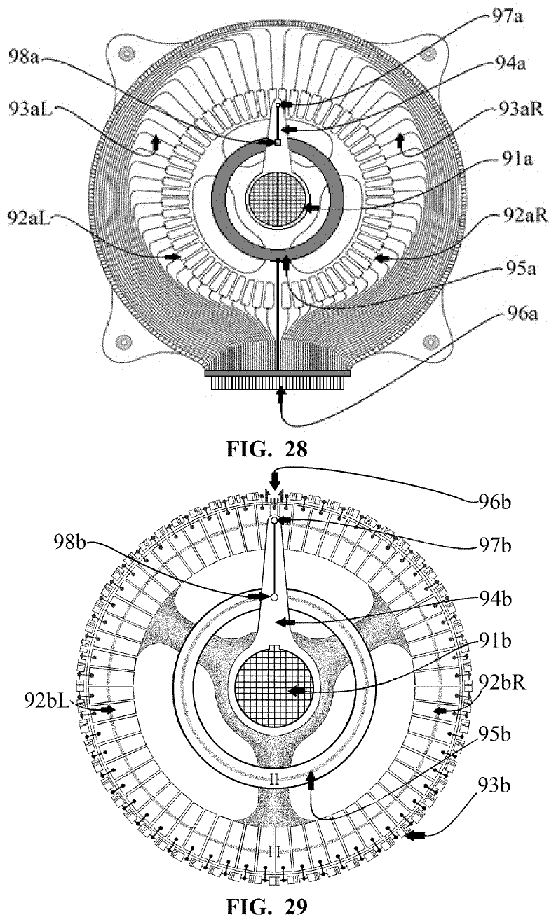

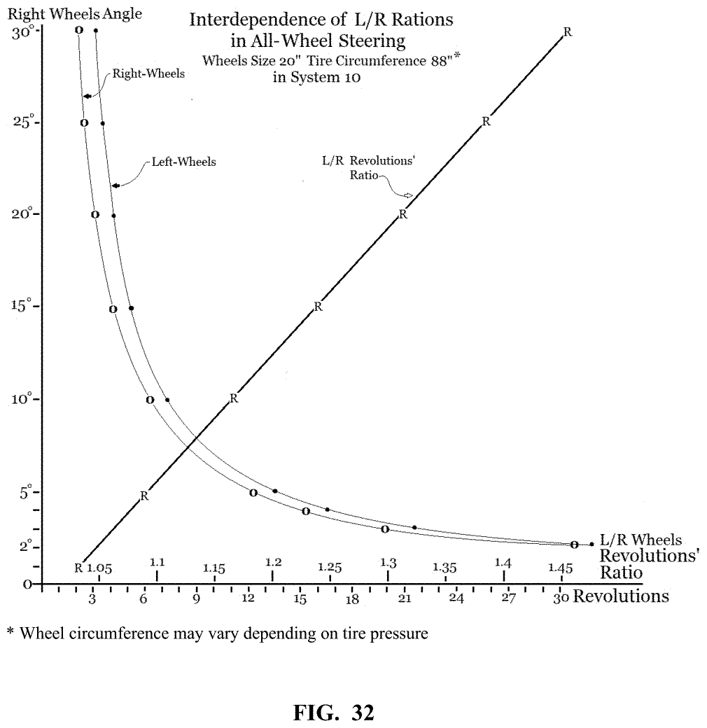

Steering a vehicle begins when the driver or the Autonomous Vehicle (AV) ECU elects to change the direction of the vehicle. FIGS. 28, and 29 depicts two distinctive configurations of the driver's steering-wheel sensors [90 is in FIGS. 5], which is incorporated in the steering-wheel. The only moving part of the steering-wheel sensor is pointer 94a that is permanently fixed to steering-wheel column 91a [shown in cross-section] and is moving whenever the steering-wheel changes position. Therefore, whenever the driver turns the steering-wheel, column 91a causes pointer 94a to slide on leaflets 92a until the driver stops the steering-wheel movement and pointer 94a is having continuous contact with a specific leaflet, which represents the driver's elected angle to where the vehicle should be steered. In AVs, if there is no steering wheel, the ECU may move pointer 94a with a stepping-motor whenever the ECU elects to steer the AV. Pointer 94a may also be configured with an upper sliding contact 97a, and a lower sliding contact 98a that may be connected to each other by electronic means. The lower sliding contact 98a is in continuous contact with sliding ring 95a connected to controller 100 by to create a closed-loop circuit in the following sequence: steering-sensor 90-specific leaflet 92a-upper-pointer contact 97a-lower-pointer contact 98a-controller 100-wheel steering-motor 116 [in FIG. 32]-wheel-position sensor 115-back to controller 100. When the pointer's upper contact stops over specific leaflet, it closes through the lower contact an electronic circuit with controller 100. This specific close-circuit is recognized by controller 100 as pre-programmed leaflet No. no. e.g., turning the steering wheel to leaflet No. 26 on the right side of steering sensor 90 means the driver or the autonomous ECU sent a command by wire to controller 100 to turn the vehicle 260 to the right, which means, the specific contacted leaflet is the steering angle the driver or the AV ECU elected to take.

FIG. 28 is configured by way of sensor-neuron layout, following nature's sensor design; one sensor-cell, one neuron transmitting electronic information directly to the controller [brain]. The benefit of such set-up is to ensure that if one sensor cell stops functioning, the neighboring cells [leaflet] is within range to cover-up for the failing cell by transmitting the same information to the controller [brain]. The subject steering sensor similarity to human's sensor-neuron configuration is an integral part of system 10 and is shown in detail in FIG. 28, which comprises of thirty contact leaflets 92aR with individual direct wire 93aR connection to controller 100 from the right half of the steering sensor; and thirty contact leaflets 92aL with individual direct wire 93aL connection to controller 100 from the left half of the steering sensor.

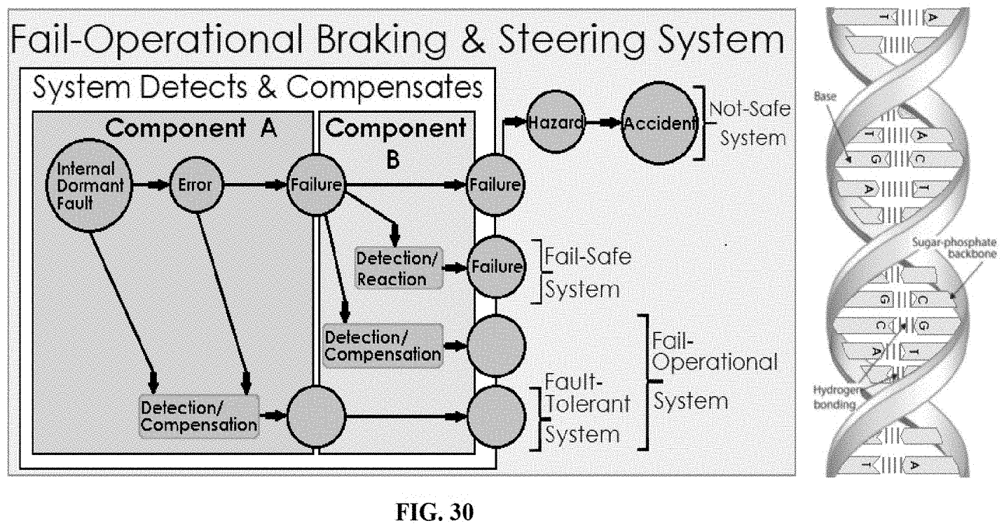

If one contact leaflet is defective, broken, disconnected or malfunctioning, controller 100 may be programmed to utilize the last and/or the next leaflet reading—which may be just 1° difference between the leaflets—to keep the wheel within safe range of only 1.66% error; and activate specific warning signal to alert the driver of the malfunctioning leaflet. This fail-assist maneuver complies with NHTSA's “fail operational systems” for steering (FIG. 30).

The steering-sensor configuration in FIG. 29 is simpler and inexpensive to manufacture. The resistors are connected in series and each resistor may have the same or different resistance. Therefore, steering-sensor in FIG. 29 is configured as “add-on” resistance. Controller 100 recognizes a specific leaflet, e.g., specific steering angle by the resistance in the circuit, which is the sum of the resistors added from the top [resistance zero] to leaflet no where pointer contact 97b stops. However, according to Ohm's law, resistance is the ratio between voltage and current, then in fluctuations of voltage or current within system 10, controller 100 reading may be somehow different than that for which it was set. Additional deficiency is the resistors being connected in series. Any malfunction of a single resistor will cause brake-down of the left or right side of the sensor after the broken resistor. Therefore, steering-sensor 90 as configured in FIG. 28—emulating human physiology—is much more dependable than any other configuration available.

In the embodiment of system 10, steering-sensor 90, comprises of sixty leaflets, thirty for the right turns, and thirty for the left turns. Each leaflet represents a specific angle [in degrees], which is pre-programmed in the data base of controller 100. However, in different configurations, a leaflet may represent any angle; and the number of leaflets on each side of the steering-wheel sensor may be elected to fit specific vehicle's applications.

### Integration of Traction, Steering and Braking

The integration of the electric traction-motors in the steering of the vehicle begins when the driver moves the steering-wheel to a position other than 0°[straight forward]. In AVs, it begins when the ECU initiates a specific turning mode. As a part of system 10, the vehicles schematics in FIGS. 26 and 27A are configured with 120″ wheel-base, with 60″ distance between the front-wheels, and with 60″ between the rear-wheels. Tire circumference is 88″. When the driver for instance, gradually moves the steering-wheel to leaflet 30° to make a 90° turn at 50 Km/h, controller 100 may keep the electric traction-motor on the front-right and rear-right wheels at 50 Km/h.

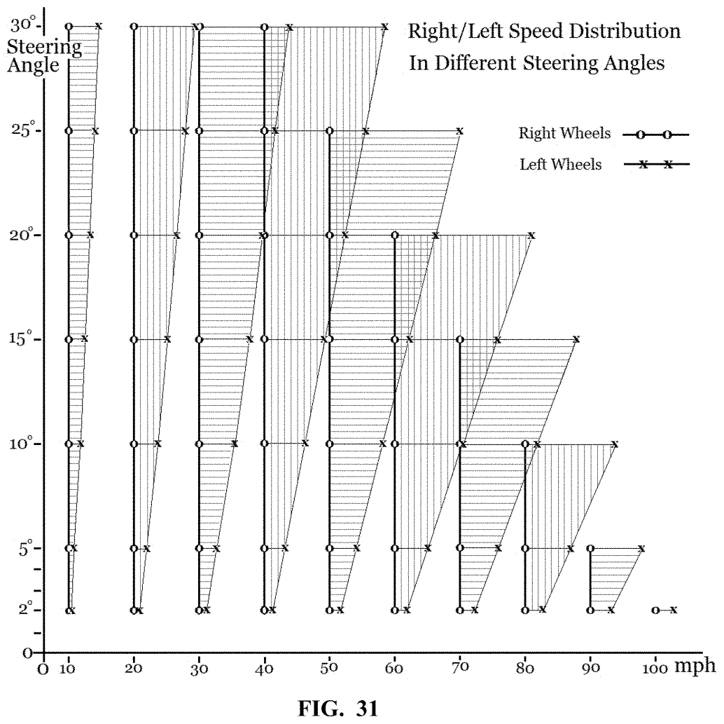

FIG. 27A also indicates that the distance to center of the turning-circle for both left wheels is about 50% greater [14.6′] than the distance to center of the turning-circle for both right-wheels [10′], the left wheels have to travel a longer distance—at the same time period as the right wheels—to make a perfect turn. Controller 100 may gradually move-up the electric traction-motors speed on the left side of the vehicle from 50 Km/h in straight-forward driving, to 70 Km/h (see FIGS. 31 and 32); or translate the speed into measured revolutions at a 30° front-right wheel angle—to gradually make a 90° direction-change to the right—the right-wheels will have to make only 2.1477 revolutions, while the left wheels will have to make 3.1230 revolutions to perform a perfect turn without assistance of EPS (see FIG. 32). This perfectly calculated electronic AW traction and steering is impossible to pull off with traditional mechanical gears.

Turning gradually steering-wheel sensor 90 [in FIGS. 5 and 28] to leaflet number 30 [30°]⁴, triggers an initial input of steering information. Controller 100 may utilize multi-objective optimization algorithm to simultaneously compute each individual wheel's steering angle and speed [angular revolutions]. The intricate process takes the following steps: ⁴ 0° to 180° is always the right-side; and 181° to 360° is always the left side.

(v) controller 100 (FIG. 5A) actuates the front-right electric steering-motor 111b in steering assembly 110b to gradually [simultaneously as the driver steering-wheel is moving] bring the front-right wheel to 30°. Controller 100 continuously receives electronic information from the wheel-position sensor 115b about the gradually changing position of the right-front wheel. When wheel-position sensor 115b informs controller 100 that the right front wheel reached the angle of 30°, controller 100 stops electric steering-motor 111b.

Simultaneously, the front-right wheel speed may be reduced, remain unchanged or increased (see FIGS. 27, 31 and 32).

(vi) the same steering procedure follows when controller 100 actuates the front-left electric-steering-motor 111b in steering assembly 110a to gradually bring the front-left wheel to 20.1°. Controller 100 then continuously receives electronic information about the changing position of the left-front wheel from wheel-position sensor 115a. When wheel-position sensor 115a informs controller 100 that the left-front wheel reached the angle of 20°; controller 100 stops steering-motor 115a.

Simultaneously, the front-left wheel speed—in case where the front-right wheel's speed remains unchanged—will be gradually increased to 43.6 mph to make a perfect turn without a standard EPS (see FIGS. 27, 31 and 32).

(vii) controller 100 actuates the rear-right electric steering-motor 111d in steering assembly 110d to gradually bring the rear-right wheel to 330°. Controller 100 then continuously receives electronic information about the changing position of the right-rear wheel from wheel-position sensor 115d. When wheel-position sensor 115d informs controller 100 that the right rear wheel reached the angle of 330°; controller 100 stops electric steering-motor 111d.

Simultaneously, the rear-right wheel speed may be reduced, remain unchanged or increased. It usually matches the front-right wheel's speed (see FIGS. 27A, 30 and 31).

(viii) the same procedure follows when controller 100 actuates the left-rear electric steering-motor 1l1c in steering assembly 110c to gradually bring the rear-left wheel to 340°. Controller 100 then continuously receives electronic information about the changing position of the left-rear wheel from wheel-position sensor 115c. When wheel-position sensor 115c informs controller 100 that the right-rear wheel reached the angle of 340°; controller 100 stops electric steering-motor 111c.

Simultaneously, the rear-left wheel speed—in case where the front-right wheel's speed remains unchanged—will be gradually increased to 43.6 mph to match the front-left wheel speed (see FIGS. 27A, 31 and 32).

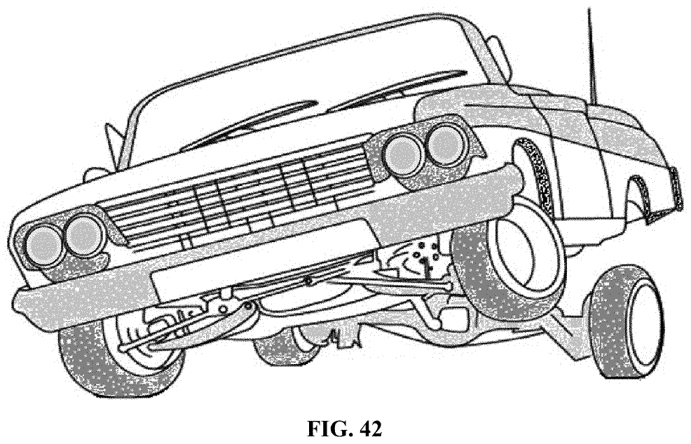

Since at 30° steering the right wheels' turning center has only a radius of about 10′, a 70 Km/h or even 50 Km/h velocity is not realistic because it may knock the vehicle off balance. While the relationship between speed and turning angle could be empirically determined for each vehicle or computed by using wheel-base measurements, weight distribution and center of gravity; in the 70 Km/h turn, the controller is configured to execute control logic stored in a data base associated with the stability of the vehicle. Controller 100 can determine the highest permissible speed at 30° turning mode that will keep the specific vehicle velocity below the speed that might endanger the vehicle stability (see FIG. 42). The program stored in Controller 100 may allow the driver to make the 30° turn safely, yet, only at permissible speed, even if the driver pushes the accelerator-pedal to the floor.

Beside the safety issue, without the ‘overturn prevention system,’ drivers would nervously apply the braking-system, trying to stabilize the vehicle and in the process drive down efficiency. In view of stability benefits—while the traction system engages in the steering and braking process—a vehicle could easily manage lateral acceleration of 0.07 g in 30° turning procedure without to push-down the braking pedal. The same applies to AVs because every time brake pads are applied; it cuts down in the vehicle efficiency.

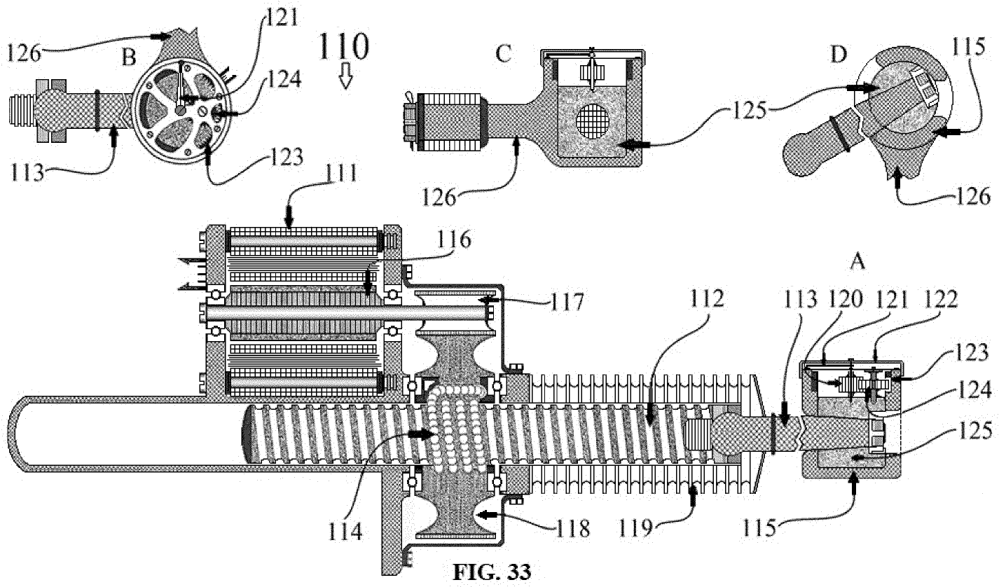

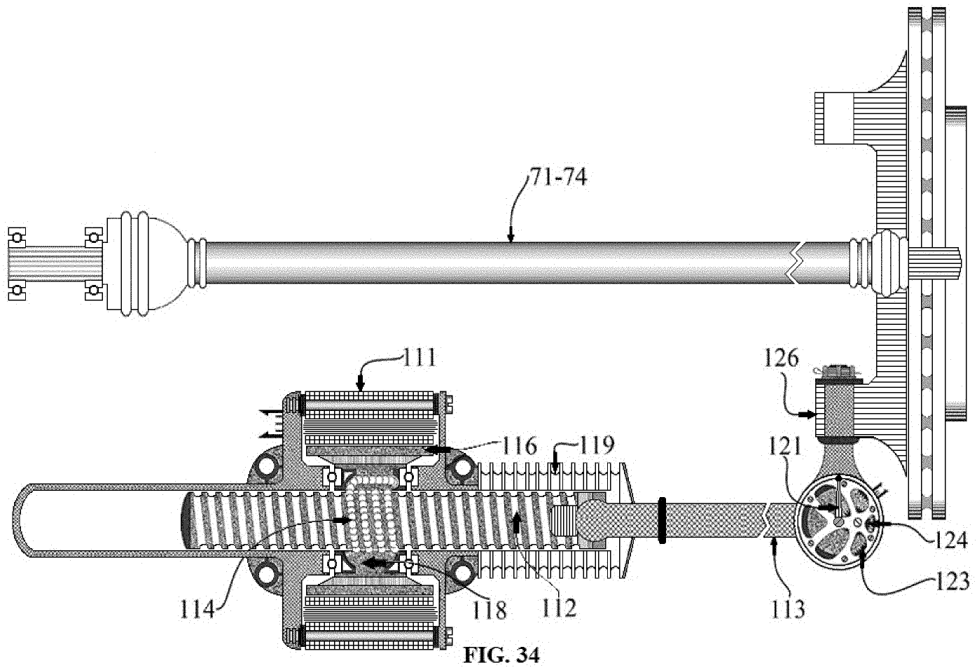

Steering assemblies as depicted in FIGS. 33 and 34, although configured with different electric steering-motors, they are maintaining similar MO. Steering assemblies 110a, 110b in the front of the vehicle, and steering assemblies 110c, 110d in the rear of the vehicle may differ in their electric steering-motor configurations. The front steering configuration 110a, 110b in FIG. 5, may be equipped with more powerful fast acting electric steering-motor than the rear assembly 110c, 110d to act instantly in response to any steering commands from controller 100. The choice of electric steering-motors 111 for the front wheels can be any device, from DC motors, three phase AC motors, DC brush-less motor or any other design of electric motor.

To push or pull the wheels to the proper angle, system 10 embodiment utilizes a large ball-bearing screw 112 as a device for converting the rotation of the electric steering-motor 111 into linear motion of the outer tie rods 113. To minimize friction in ball-bearing screw 112, bearing balls 114 are captured between the nut 118 and the ball-bearing screw-threads. Since controller 100 determines how far the outer tie rod 113 needs to travel to bring the wheel to the elected angle, electric-steering-motor 111 turns large ball-bearing screw 112 and applies axial force through outer tie rod 113 directly to the modified into wheel-position sensor-outer tie rod end 115. Rotor 116 in the electric traction-motors rotates a shaft that is configured with direct gear 117, or with toothed belt drive wheel [not shown], or with chain drive [not shown] or with any other form of power transmission to nut 118, which rotates and moves large ball-bearing screw 112 forward and backwards.

System 10 is configured with four wheel-position sensors 115 attached to each wheel's steering knuckle-arm to accomplish the same function as a mechanical tie-rod end, yet, at the same time, the wheel-position sensors monitor, and transmit by electronic means the continuous wheel-position angles to controller 100. FIG. 33 depicts a wheel-position sensor in four different views for better perceive the sensor's usefulness. A depicts a central cross-section with the outer tie rod; B is a view from the top of the sensor; C is also a center cross-section but is 90° to A cross-section; and D is a view from the bottom. If the tie rod end is not a practical location for a wheel-position sensor, an alternative design of linear wheel-position sensor may be installed on the outer tie rod. The change in length of the outer tie rod may be utilized as scale for the wheel position.

A wheel-position sensor may in fact be configured as a miniature version of steering sensor 90 and may also be constructed that way. Pointer 121 is fixed to the axle of center-gear 120, which is meshed with the teeth of side-gear 124 and said side-gear is meshed with teeth molded inside wheel-position sensor housing 115. When nut 118 rotates; outer tie rod 113 is following the axial movement of screw 112 to the left or the right, triggering a change in the angle between outer tie rod 113 and knuckle steering arm 126, which is proportional to the change in the wheel's angle, e.g., in relation to 0°. The proximate result is the rotation of cylinder 125 inside wheel-position sensor's housing 115 that triggers the movement of the toothed area 123, molded inside the wheel-position sensor housing, which initiates the following chain reaction: movement of toothed area 123 rotates toothed side-gear 124, which rotates center-gear 120, which causes the movement of pointer 121, that sends by electronic means the instantaneous ‘change of position’ information to controller 100.

In situations where any of the wheel-position sensors is totally ‘out-of-order,’ controller 100 may be programmed to apply the reading of the opposite side wheel-position sensor, interpolate the readings to fit the defective side and apply the interpolation to keep the vehicle in safe driving conditions and notify the driver by electronic means about the location and the cause of the malfunction. In AVs, a flushing-light and a buzzer will make the passengers aware of the malfunctioning device. This fail-assist maneuver complies with NHTSA's “fail operational systems” for steering (FIG. 30). FIG. 32 depicts the wheels revolution differences between the left and the right side of the vehicle, at the right wheel's angle. The difference is small above 50 mph.

The myth that mechanical steering is safer than electronic steering is no longer factual. It was vastly demonstrated supra that digital controls can monitor, compute, and actuate EV's gears in milliseconds, giving rise to precision in electronic steering, which translates also into safety; including but not limited to, electronic malfunction warning systems—as described in steering section [0110] supra—with which it can correct defects by electronic means, and notify the driver/owner of AV that the vehicle has malfunction, and what needs to be repaired (FIG. 30). Mechanical components brake because of defective materials installed during manufacturing, due to material wear and tear and/or deficient or lack of maintenance results in malfunctions that could not be monitored because mechanical steering system lack the electronic monitoring devises to inform the driver that the tie rod end is going to brake at the next 90° turn or that speeding at 40 mph in a 90° turn will cause a roll-over.

### Integrated Traction & Steering in Heavy-Duty Vehicles

Heavy-duty trucks, buses and semi-trailers are widely used for transportation of goods and people due to their low operation cost per weight; and, since the world population is moving into cities, public transportation is expected to increase dramatically leading to increased number of buses for inside the city and inter-cities transportation. So far, inherent to these class of vehicles, only electrification—in particular with this disclosure—will solve the vehicles' two paramount nuisances and complications they trigger off:

(iii) a massive pollution of CO₂ and NOₓ that triggers health detriments to living organisms, and diminishes the green-house gases in the atmosphere; and

(iv) extremely poor maneuverability. Drivers are shortcoming when they have to steer their heavy-duty trucks, buses, and semi-trailers inside an urban areas to deliver goods or transport passengers.

The future semi-trailer's business is projected to be autonomous; well, the only way to bring about autonomous mobility for semi-trailers is when traction and steering systems with digitized electronic means while the energy source could be batteries, ultra-capacitors, flywheel, photovoltaic-cells, and fuel-cells, all of which provide electric power from various sources. Traditional diesel engines in buses, heavy-duty and semi-trucks should be abandoned. FIG. 7 demonstrates the overall limitations of diesel engines. The limited operational level of torque in at only 25-32 RPM, and the highest level of power is at 33-40 RPM, which justified the engineering of 10 to 18 gears transmissions to move very heavy load from zero to 60 mph within a 10-15 RPM window of effective diesel engine torque and power. The result, semi-trailers need more than 60 seconds, and the driver's “double-clutch hard labor” to get from zero to 60 mph, while electric semi-trailer manage to do the same in less than 20 seconds, fully loaded.

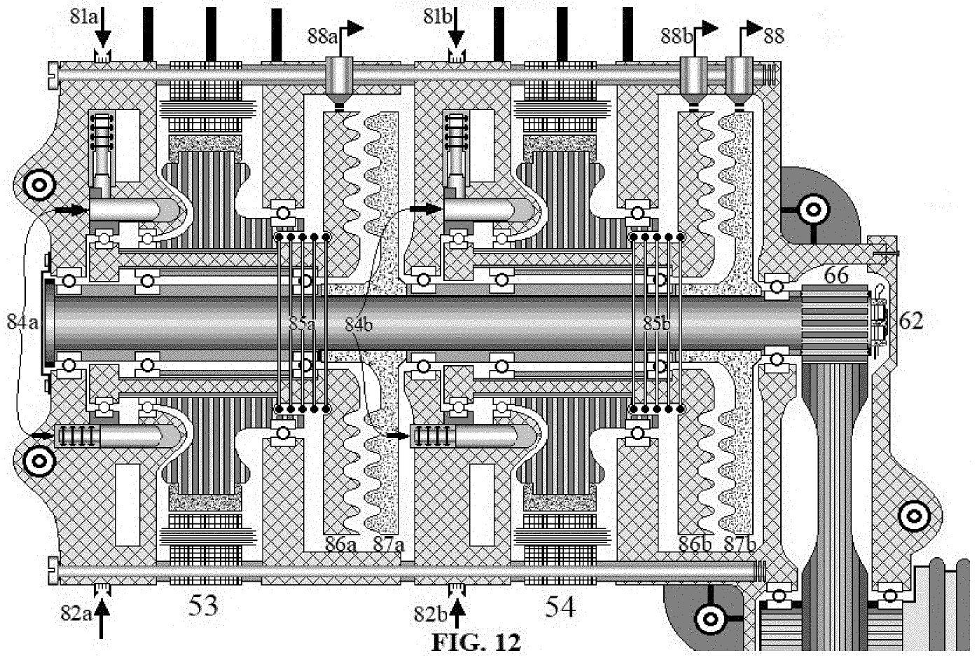

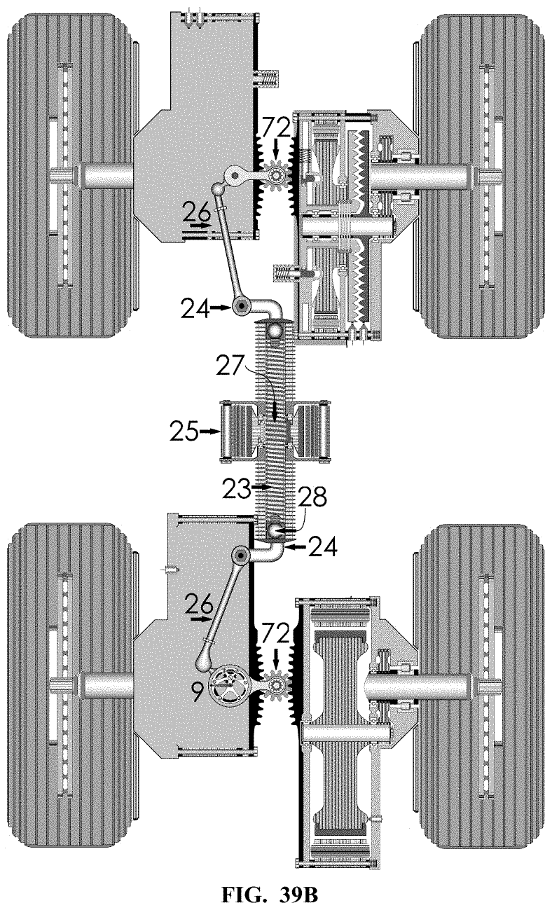

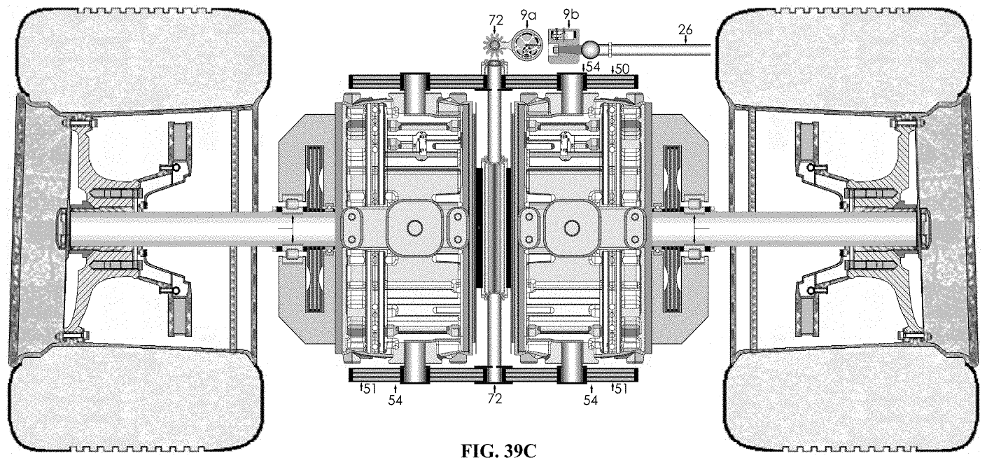

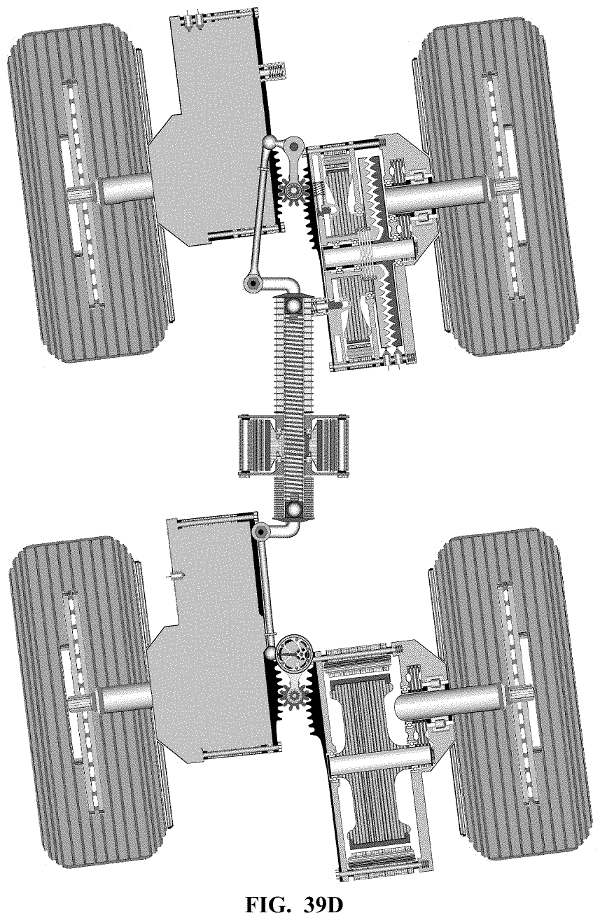

Current electric semi-trucks need improvements to be economic viable, and profitable. It is not sufficient to just replace the diesel engine with four electric traction-motors and propel the same traditional rear-wheels of the tractor; or lower the tractor nose for better coefficient of drag, and continue to steer with the same traditional, mechanical system where only the two very front-wheels of the tractor are steering a 58′-feet long vehicle. Interpreting system 10 as depict in all FIG. 5; then FIG. 39A could be a basic configuration of electric traction-motors and steering set-up in the front wheels of the semi-tractor, with a combination of two pairs of electric traction-motors, without steering gears since the four or eight wheels of the semi-tractor in the rear are practically facing the center of the turning-circle in about 90°, and therefore most of the time these wheels need not to be steered. This design concept may be applied to buses, heavy-duty trucks and semi-trailers by propelling and steering all, or less than all wheels with multiple and diverse electric traction-motors, as depict in FIGS. 12-13 and 36-38 and to integrate the electric traction-motors in the steering process. FIG. 39A is a configuration of three pairs of different electric traction-motors; some electric traction-motors has electronic-clutches, and some does not; some has electric traction-motors that are steerable; and some does not. All the following listed benefits—which are not available in diesel buses or diesel semi-trailers—may be realized:

(i) superior efficiency; (ii) longer range; (iii) uniform distribution of traction power and weight along a 58′-feet long vehicle; (iv) remarkable maneuverability; (v) zero NOx pollution, and minuscule CO2 pollution [electricity production in power plants emits much lower CO2]; (vi) reduction in battery-pack seize, weight, and cost; (vii) lower manufacturing cost and (viii) 40% reduction in operating expenses compared to diesel heavy-duty trucks and semi-trailers.

### All-Wheel Steering and ‘Crab-Walk’ for Trucks and Semi-Trailers

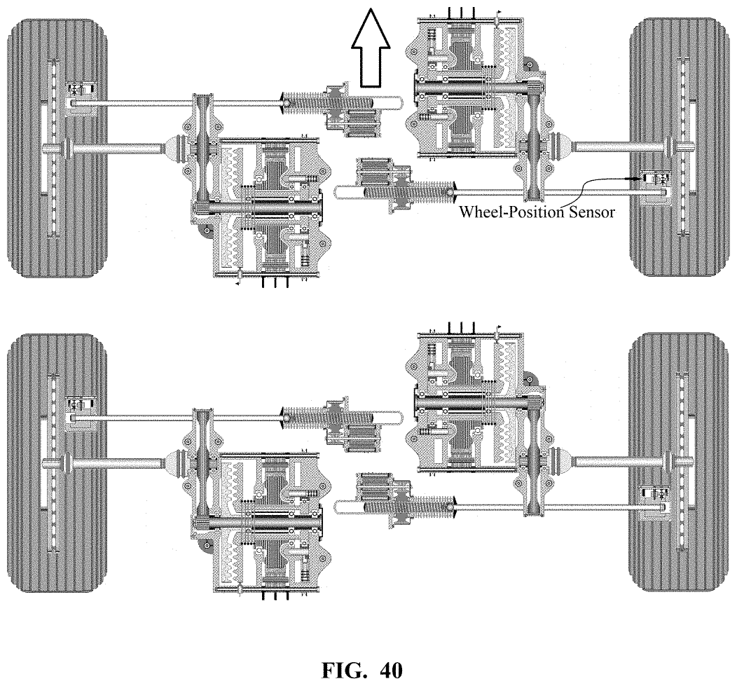

The philosophy of the disclosure is to spread the tractive-power and steering to all, or all wheels along any heavy-duty vehicle for a balanced distribution of the tractive-power, and the steering. Two or three rear axles in the articulated trailer may be propelled and steered to assist the semi-tractor at forward-motion-start and in any acceleration or uphill drive. FIG. 40 depict the four electric traction-motors configuration, installed at the two rear-axles of a semi, articulated trailer that may be equipped with electronic-clutches to be de-coupled when their tractive power is no longer needed, to promote efficiency, while all 4 or 8-wheels are steered for perfect maneuverability.

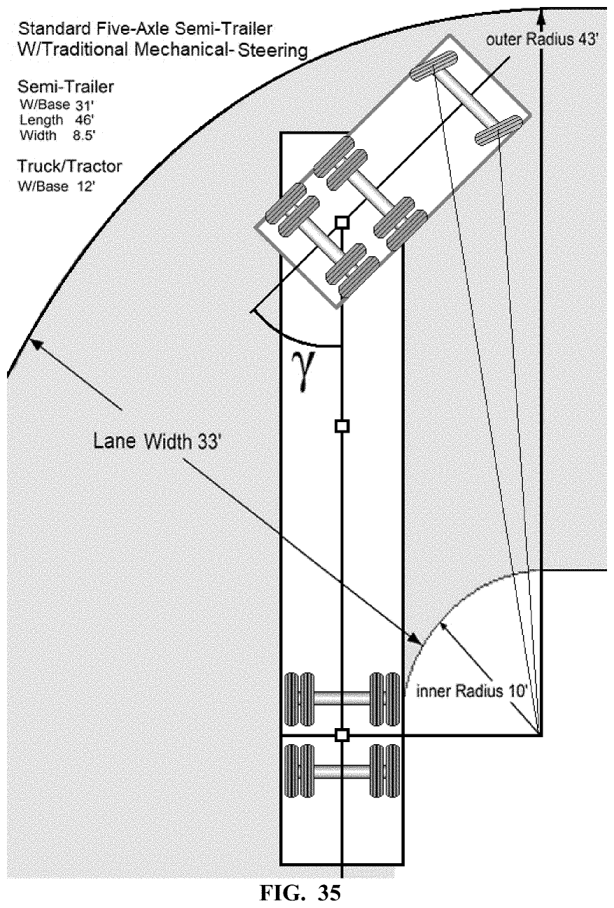

Steering an articulated vehicle, with only the front two-wheels is a massive obstacle not only to the semi-trailer driver, but also to all other drivers on the road as presented in FIG. 35. The driver needs a 33′-feet lane-width—which is almost three driving-lanes—to make a 90° turn. To program an autonomous semi-truck to steer a 58′ long articulated vehicle with only two steerable wheels in the very front, is a mission impossible. Evolution-though it may seem inconsequential to automotive engineers-provided the very primitive caterpillar-worm a controlled mobility in every segment of the body, for a reason; because, with two front-legs, the worm would not be able to move the rest of his body. The eventual deduction is that power distribution in articulated, long vehicles, will rehabilitate the traditional, ill engineered semi-trailer trucks maneuverability, fortiori, if multiple electric traction-motors along the vehicle are integrated in the traction and the steering process.

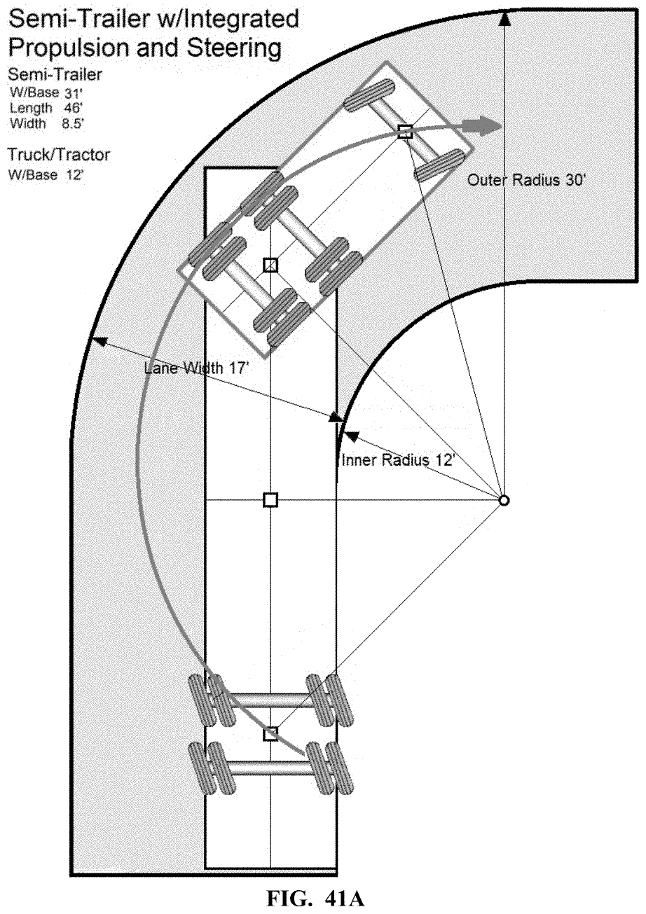

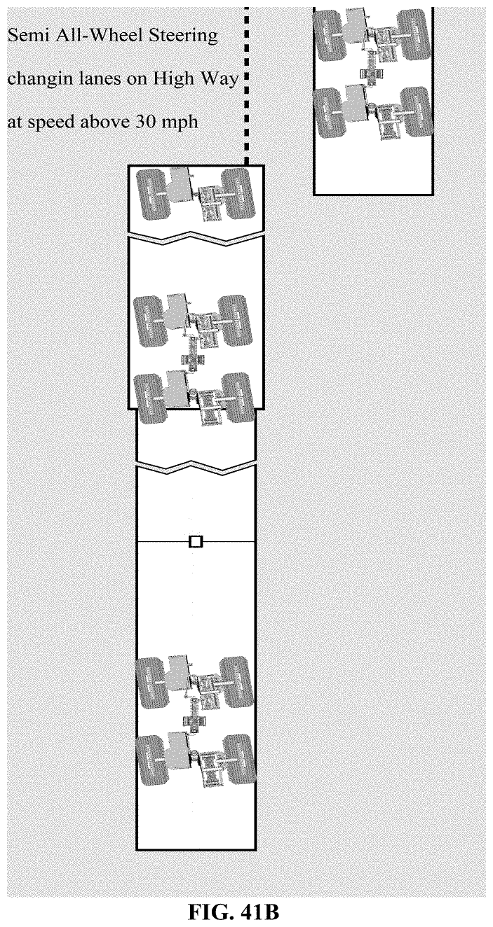

Low-speed multi-wheel vehicle maneuverability was always a problem in resolving the amount of space required by the vehicle to make a turn as depicted in FIG. 35. One of the principal issues in fitting this disclosure in articulated vehicles, such as the one displayed in FIG. 35, is to reduce the maneuvering space, e.g., to minimize the width of the lane a semi-trailer will occupy while steering a 90° turn. Because different articulation angles γ follow different curve radii; and the ratio between the minimum inner radius and the maximum outer radius [swept path] the vehicle uses during maneuvering can be significantly larger than the width of the vehicle. Therefore, the two rear-axles in the trailer must be steerable. FIG. 41A demonstrate the remarkable reduction in the outer radii, and the reduction in the articulation angle γ when steering the trailer wheels in the rear axles. The optimal setting is when the tandems center in the trailer is following exactly the same curve as the center front tractor axle (see heavy line in FIG. 41A). It is obvious that the best way to achieve this goal is to steer the trailer's rear wheels to provide the trailer center-of-tandems the capacity to match the curve radii of the tractor's front axle.

Steering and propelling the trailer rear-axles; this disclosure design for heavy-duty and articulated vehicles will eventually provide better result than just improve steering when the traction is integrated in the steering process:

(vii) it will result in dramatic improvement in the vehicle maneuverability, at low and high speeds, minimize off-tracking and a total swept path width, and overall, much better stability at any speed range because individual traction of each wheel causes equal power distribution along a 58′ feet long tractor and trailer.

(viii) in low-speed steering modes, aligning the rear wheels of the trailer—at 60° to 90° to the turning center (see FIG. 41A) will dramatically reduce the Cᵣᵣ [Coefficient of rolling resistance]. Tires dragging in lateral and longitudinal directions in traditional semi-trailer are being exposed to shear forces that leads to repeatedly tires blow-up, and to rise in maintenance cost, while severely reducing the vehicle efficiency. Steering all wheels will reduce tire wear and maintenance expenditures.

(ix) 58′ Semi-trucks are much longer than cars, then the radii to the turning-center would be much longer too, developing smaller speed differences between the left and the right wheels as is noticeable in passenger cars. Rear-wheel propulsion and steering will dramatically increase tire-grip on the road; and put a stop to the trailer when the tractor stops, which will prevent a quite common accident in semi-trailers roll-overs.

(x) propelling the left and the right side of the tractor and the trailers wheels with different speed will perfect stability, ease maneuverability, and would eliminate the need of power-steering system altogether; and

(xi) as in system 10, the controller, or the autonomous semi-trailer ECU may de-couple specific electric traction-motors when reaching sufficient kinetic energy—especially in highway driving, which is more than 90% of semi-trucks driving—to save electric energy, which results in extended driving range.

(xii) after evaluating the driver's desired steering angle, and the topographic GPS data, the holistic controller computes the specific tractive-power for each wheel, while computing the angle-position of each steerable-wheel. Then, the holistic controller may compute and evaluate, which of the ten or twelve electric-traction-motors along the semi-trailer has to couple to wheels; and in what angle each wheel has to be steered in every point and time of mobility, which is much more sophisticated task than in a 4WD passenger car, yet it is much closer to perfect mobility.

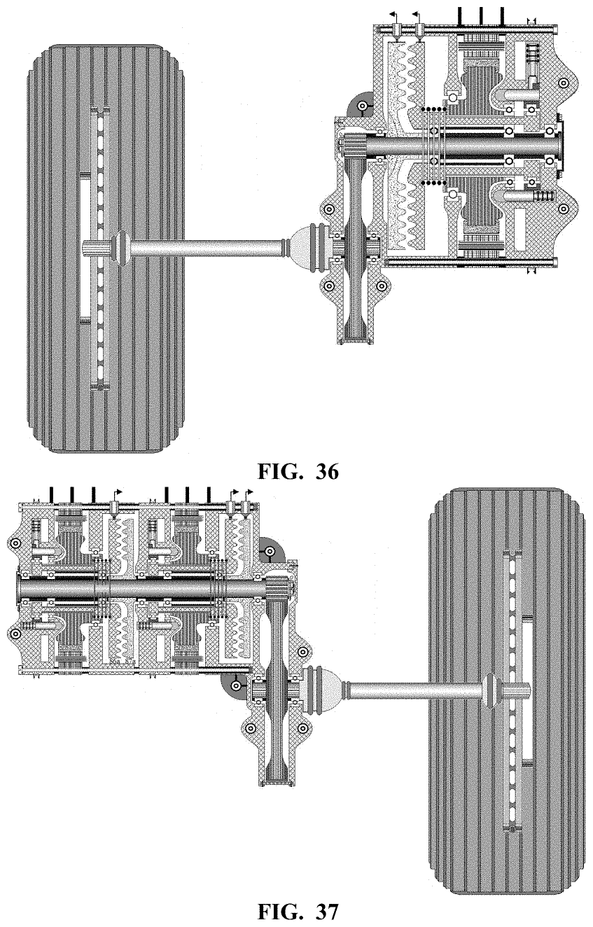

FIG. 36 is a single electric traction-motor with electronic-clutch, manufactured with any specifications, installed in any heavy-duty trucks, buses, or semi-trailers, with more than two axles, with electric traction-motors having various power ratings. FIG. 37 is the same design as FIG. 36, manufactured with two electric traction-motors sharing the same shaft that could be installed in any heavy-duty trucks, usually with only two axles.

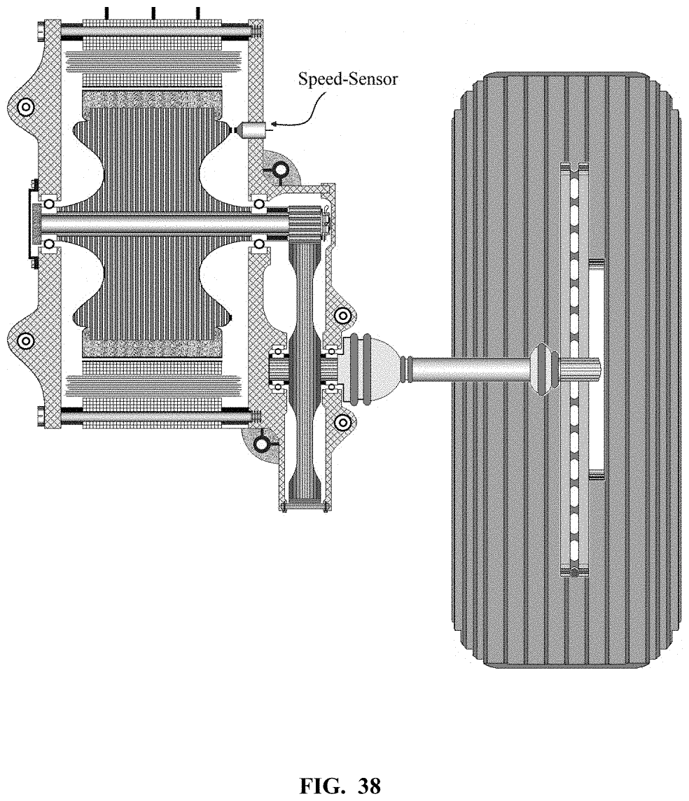

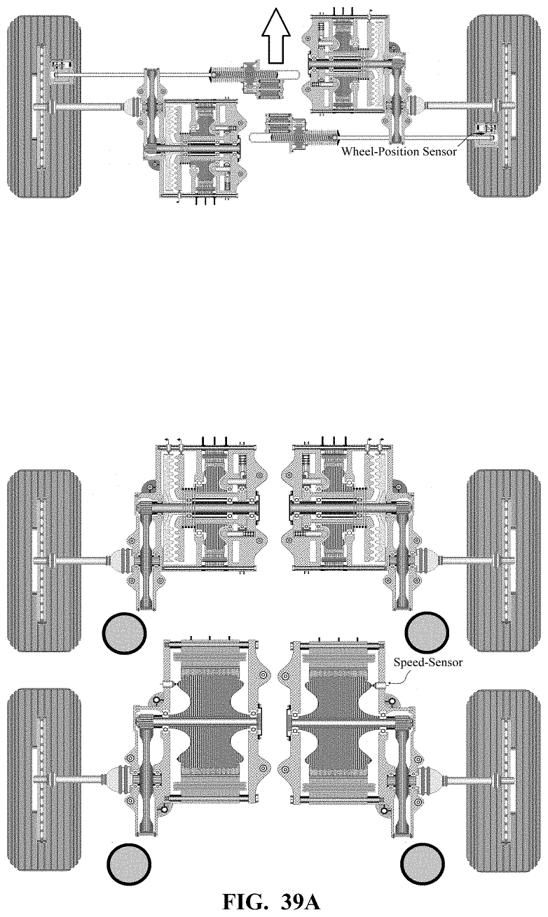

FIG. 38 presents a large, configured as a pair of electric traction-motors with no electronic-clutches, manufactured with any specifications and installed in any light- or heavy-duty vehicles, buses, or semi-trailers, or installed with steering gears [not shown]. The electric traction-motor design may be the core tractive-power that runs whenever the vehicle is in motion. The tractive-power of all electric traction-motor with no electronic clutches may be about one-quarter plus 10% [these electric traction-motors usually installed in pairs] the HP and torque required to propel an empty commercial vehicle in 0° elevation.

The design of various electric traction-motors may secure that the vehicle never stops because power distribution among plurality of various electric traction-motors will eventually eliminate mechanical break-downs because, even though one or a couple of electric traction-motors may malfunction, the rest will suffice to keep the vehicle running, which is a top priority, especially in the trucking industry to deliver goods on time. Utilizing induction motors will eliminate the necessity of water-cooling system and overheating because of the smaller size and substantial number of the electric traction-motors in this disclosure, compared with the giant electric traction-motors in today's electric tracks. The energy losses through to heat is much smaller, which support better efficiency.

FIG. 39A displays a basic design of six electric traction-motors, configured for a semi-tractor. The front axle configured with a pair of electric traction-motors, equipped with electronic-clutches. The left and right front wheels are individually steered. In the middle axle, the electric traction-motors pair are identical in design to the front, yet they may be with greater tractive power. In the rear axle, the electric traction-motors configured as depict in FIG. 38. The design of the two, large electric traction-motors in the rear of the semi-tractor are for a reason. Semi-trailers run most of their driving at constant speed of 45-60 mph on the highways. The large electric traction-motors in the rear axle configured to move a semi-trailer with no cargo, while all other electric traction-motors are de-coupled from wheels, which will dramatically reduce the energy use-up. In this configuration, both axles in the rear are not steerable.

To steer heavy-duty vehicles, and especially semi-trailers with maneuverability of 4-wheel vehicles as described in FIG. 27B, and in velocities above 40 Km/h, all wheels along the semi-tractor and the articulated trailer, or all wheels in the heavy-duty trucks and buses are steered at about the same directions as the front wheels, not necessarily at the exact same angle (see FIG. 41B). The exact angle of the semi-tractor rear axles may be determined with empirical testing since it depends on the vehicle's wheelbase, the distance between the left-side and the right-side wheels, the vehicle weight, the center of gravity, and the purpose of the vehicle.

To steer all wheels in the same direction as the front wheels, the four or eight wheels at the rear axles of the semi-tractor—that are not steered in the basic configuration (see FIG. 39A)—must be steered to a certain degree to join the front wheels of the semi-tractor and the rear wheels of the articulated trailer to perfectly accomplish the ‘crab walk’ configuration, as presented in FIG. 41B.

The method of steering these wheels differs from the previous, traditional approach where each individual wheel steered by pushing or pulling the steering-knuckle of the wheel. FIG. 39B depicts the steering mechanism of the rear two axles in a semi-tractor, and in heavy-duty trucks and buses with one or two rear axles. The method of steering is realized with two large spur- or helical-gears between two opposing electric traction-motors that are connected to the wheels with driveshafts (see FIG. 39D); where 9 is a yaw-sensor; 23 a large steering-screw; 24 a steering-rod; 25 a steering-motor; 26 two tie-rods; 27 a steering-screw ball-bearing; 28 a steering-screw head; and 72 are two long column configured as spur- or helical-gears.

It is obvious from the FIG. 39D that one, large electric steering-motor (#25) is steering all four or eight wheels at the two rear axles, and a single yaw-sensor (#9) is providing the angle and position of all 4 or 8 wheels to the holistic controller.

Each and every time when a traditional class 8 semi-trailer is changing lanes, steering the two front wheels of the semi-tractor is dragging the 16-wheels behind; when the driver steers to the left lane, and after passing the slow-driving vehicle, when the driver steers back to the right lane. Adding the 36.5 metric tons on top of the dragged wheels and the wasted energy becomes a significant factor in the reduction of the driving range.

FIG. 40 displays a different configuration for the four electric traction-motors in the two rear-axles of the semi articulated trailer. The design of the four electric traction-motors may be the same, or with different specifications. However, all four-electric traction-motors are steerable and equipped with or without electronic-clutches. The reason that the four electric traction-motors in the trailer are steerable and equipped with electronic-clutches is because the two ends of the vehicle have to steer to dramatically reduce the turning radius. Couple a seconds after forward-motion start, the holistic controller may de-couple 2 or 4 electric traction-motors to reduce the energy use-up.

Manufacturing and maintenance cost computations is a particularly critical issues when operating trucking business. Purchase price of a new, standard diesel eighteen-wheeler semi-tractor and trailer is about $170,000 where, standard semi-tractor with diesel engine cost about $130,000; and standard trailer for 18-wheeler, cost about $40,000. Adding steerable rear-wheels system will cost additional $20,000; total $190,000. All estimates are on the low-side.

The same new semi-tractor without diesel engine, transmission, drive-shafts, and differentials; exhaust system; water-cooling system, pollution prevention system; power-steering system; starting system; alternator charging system; hydraulic-brakes system; and air-conditioning system will cost about $40,000. Then, the trailer cost about $40,000, and all together about $80,000.

To manufacture eighteen-wheeler semi-tractor and trailer according to this disclosure, with electric integrated traction, steering, and braking may include in general: (i) stripped tractor and trailer $80,000; (ii) 10 electric traction-motors; eight 50 kW induction-motors $960 [@ $200] and two 100 kW induction motors $1,400 [@ $700]; (iii) adding; 6 electronic-clutch mechanisms [4 induction motors, two in the tractor and two in the trailer may be connected to the wheels at all times] $1,800; (iv) six steering electric traction-motors $3,000 [@ $500]; (v) 10 DC to DC converters $1,000 [@ $100]; 10 DC to AC inverters $1,000 [@ $100]; (vi) digital system-controller with all wiring at $4,000; (vii) 10 electric-brake systems $2,000 [@ $200] brakes won't be as powerful as in semi-trailers with diesel-engine since regenerative braking by 10 induction motors will do most of the job and evenly distributed along the tractor and trailer; and (viii) air-conditioning system $1,800; total without the battery-pack is about $97,000˜$100,000.

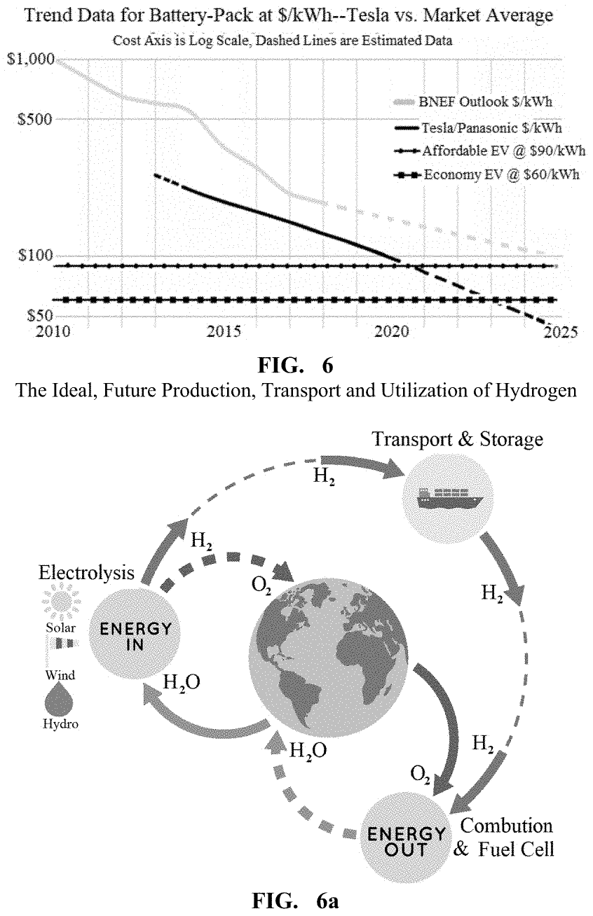

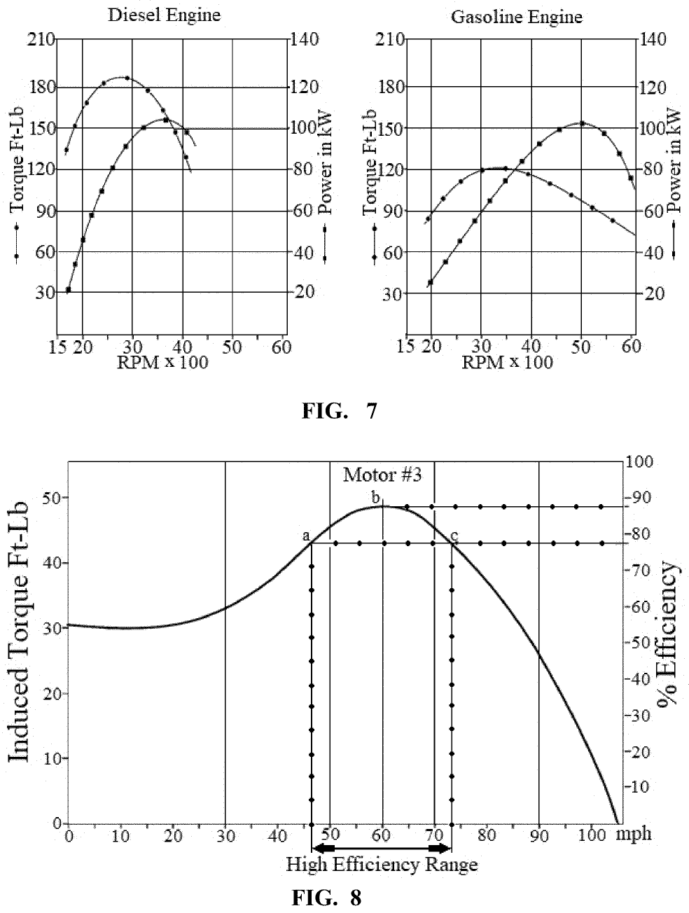

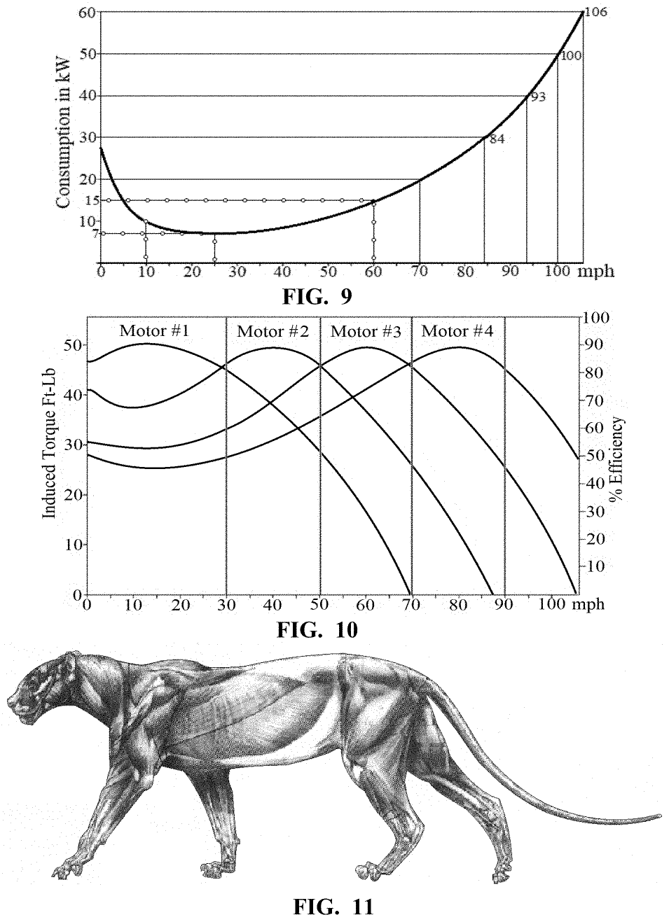

Under previous considerations in [0037], the battery-pack weight and cost in [0040] have a decisive role in designing electric buses, heavy-duty trucks, and semi-trailers. Using Tesla semi's specifications as computed supra that for 480 Km range the battery-pack will cost $47,000 in today's $100/kWh price, and $23,500 when kWh price will reach $50/kWh in 2024 (see FIG. 6). For 960 Km range a battery-pack will cost $94,000 in today's price of $100/kWh, and $47,000 when kWh price reaches $50/kWh in 2024. However, the subject integrated traction, steering and braking disclosure is claiming to have about 25% better efficiency than Tesla's. Interpolating the subject disclosure's energy-pack as E_{P}=1.25 Km/kWh [Tesla's is about 1.02 Km/kWh] energy results to 480- and 960-Km range; then, equipped with the subject integrated propulsion and steering disclosure, loaded with maximum payload the semi-truck with 36,364 Kg, will consume 384 kWh, and 768 kWh respectively; and the battery-pack cost will be reduced to $38,400 and $76,800 with today's battery price of $100 kWh; and $19,200 to $38,400 when kWh price have reached $50 as depict in FIG. 6, respectively. The current price for a semi-trailer equipped with this disclosure is $138,400 and $176,800 in today's battery prices respectively; and further reduced to $119,200 and $138,400 respectively, which is much lower than semi-trailer with diesel engine.

Maintenance cost of a semi-trailer with this disclosure will be significantly lower than diesel semi-trailer. Average annual distance traveled by Class 8 diesel semi-trucks is about 75,000 miles; and the average efficiency is 6.5 miles per gallon, with yearly consumption of 75,000/6.5=11,540 gallons within a price of $3.90/gal, annual cost of fuel is about $45,000.

Semi-trailer with this disclosure and with the efficiency of 0.75 miles/kWh will consume 100,000 kWh to drive 75,000 miles; with $0.07/kWh commercial price of electricity=$7,000 and with 90% efficiency, annual ‘fuel’ cost=$7,700, which is $37,300 less than semi-truck with diesel engine. 3-years just fuel savings will buy a new electric semi-trailer. The additional expenses with diesel semi-trucks, such as tires replacement, engine lubrication and maintenance, are not available in e-semi-trailers because induction-motors are maintenance-free. The battery-pack replacement is due after 1,000,000 K/m, depending on the charging methods.

### The Modular E-Drive Concept in this Disclosure

The modularity in assembling components of this disclosure is another advantageous aspect that could ease fitting this disclosure in any vehicle type.

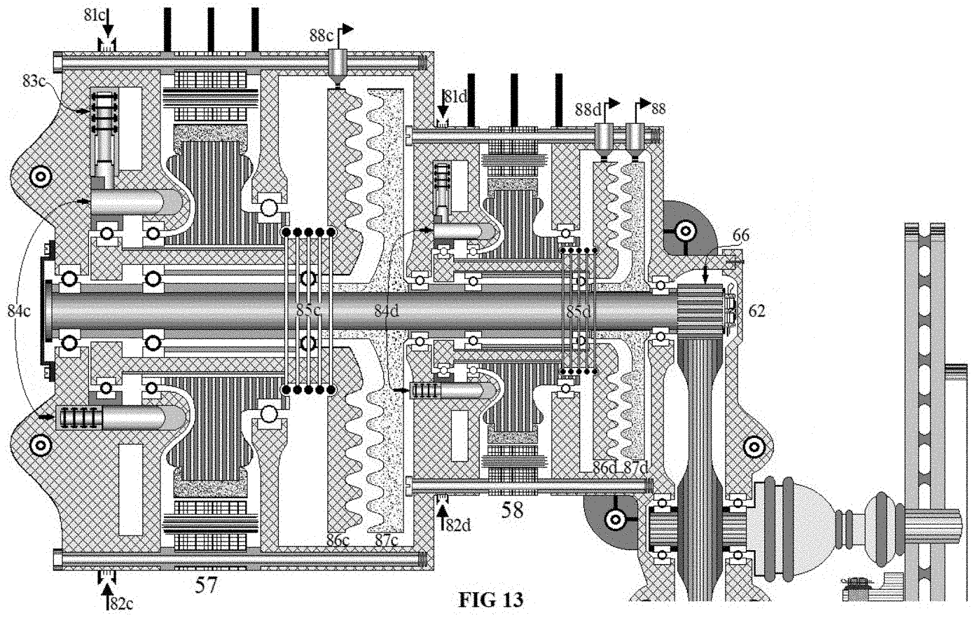

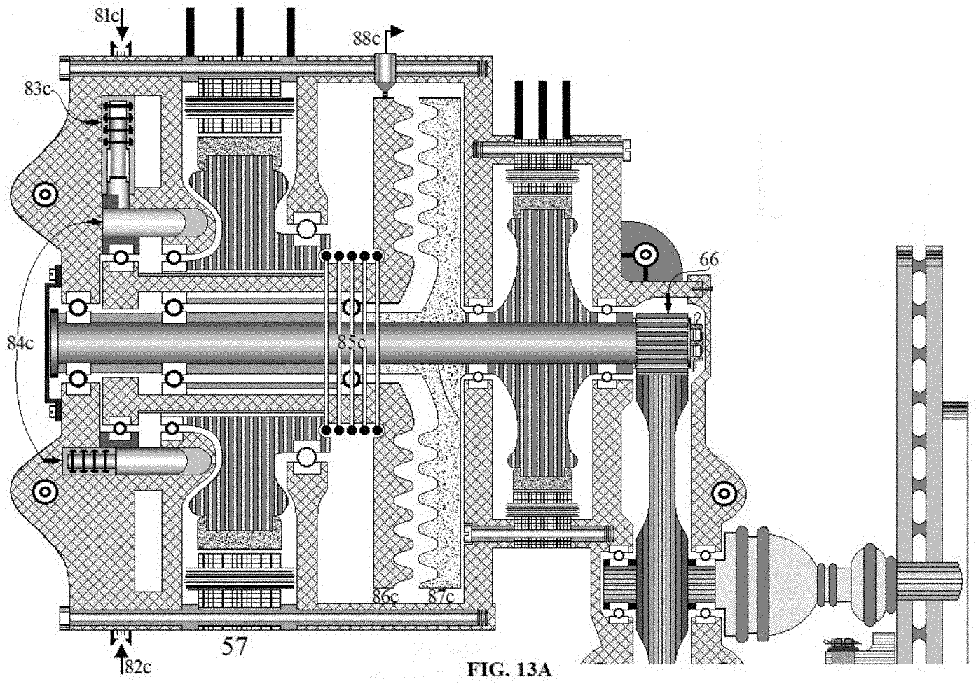

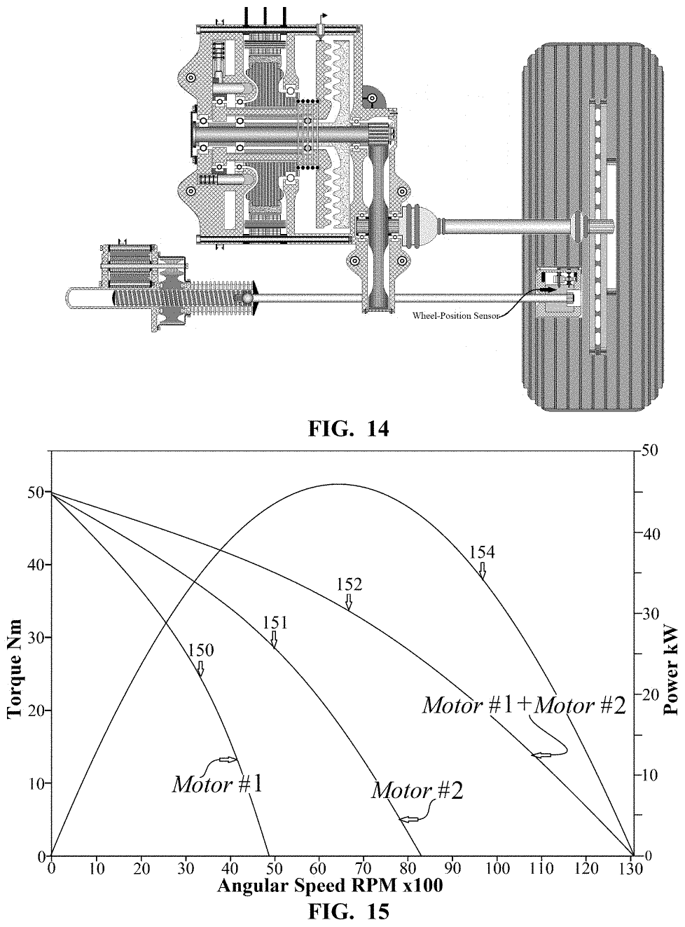

Attributable to Modularity of the Design, this disclosure further simplifies, and lowers manufacturing cost. FIGS. 12, 13, 14, 16, 28, 32, 33, 35 and 37 illustrates a design approach that subdivides systems into modules of various but similar electric traction-motors should be manufactured in standardized size, yet designed with different ratings of power, torque, angular speed, and specific high efficiency range. Picking up the electric traction-motor in FIGS. 12 and 13 as standard manufacturing size of electric traction-motors for personal EVs; and electric traction-motors in FIGS. 13, 36 and 38 as standard manufacturing size of light- and heavy-duty trucks, buses, and semi-trucks; then, infinite electric traction-motors' combinations of this disclosure's master system 10 as depict in FIG. 5A can be assembled in the same production line. Manufactured components with different specifications but with the same exact size—could share a standardized shaft 62 [as depict in FIGS. 12 and 13] and accommodate infinite embodiment. FIGS. 12 and 13 represent two different systems, assembled with the same procedure, having the same function, yet carrying different specifications.

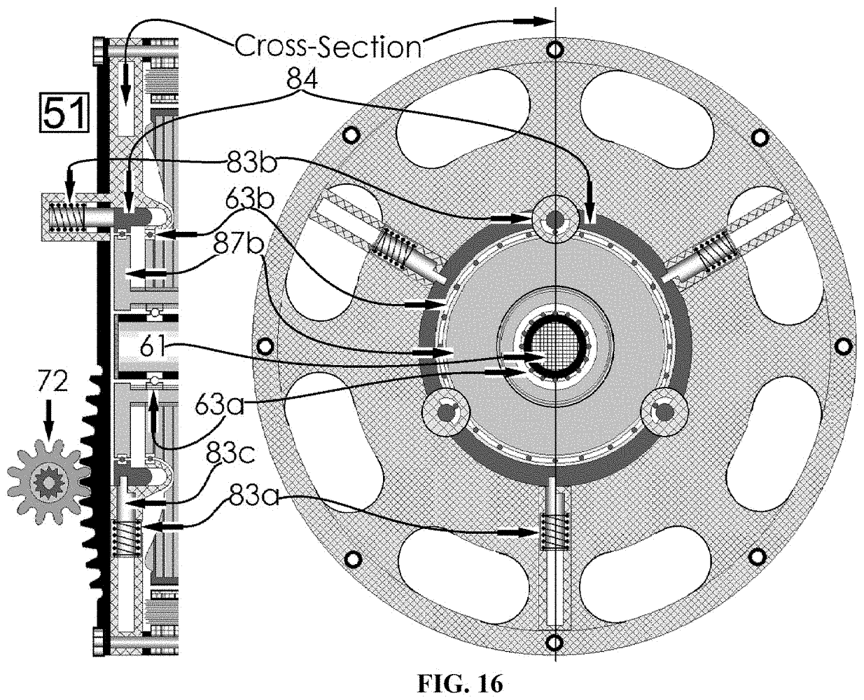

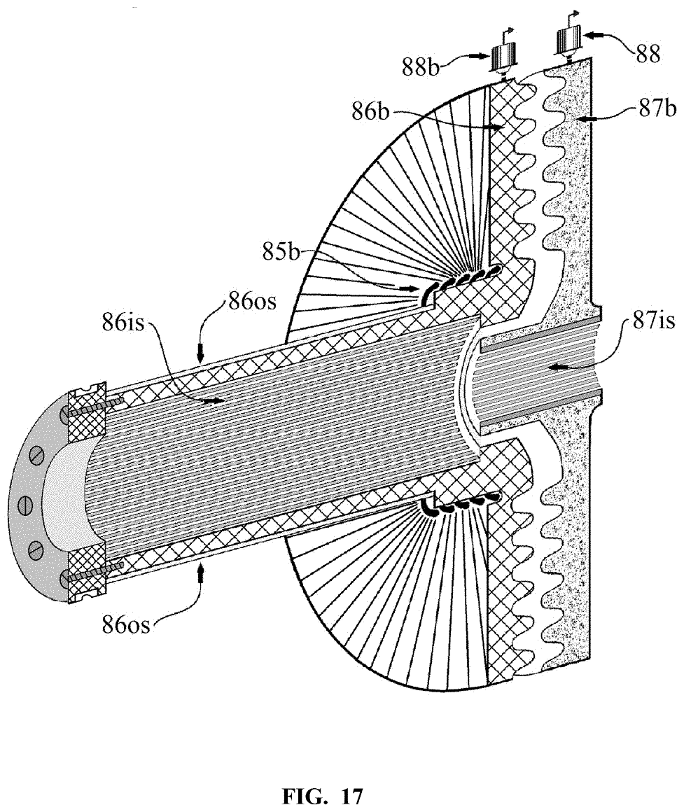

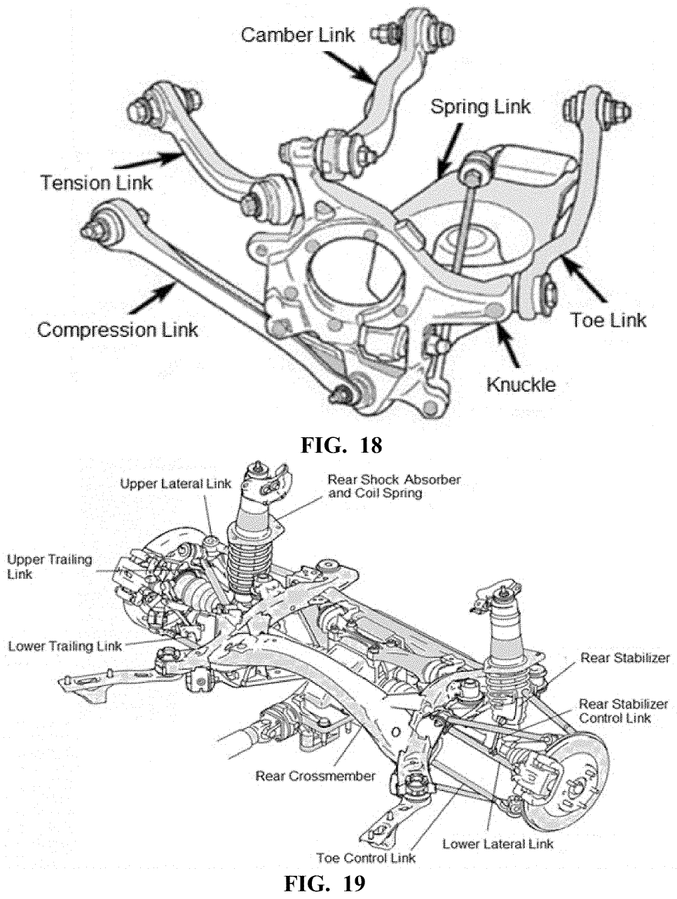

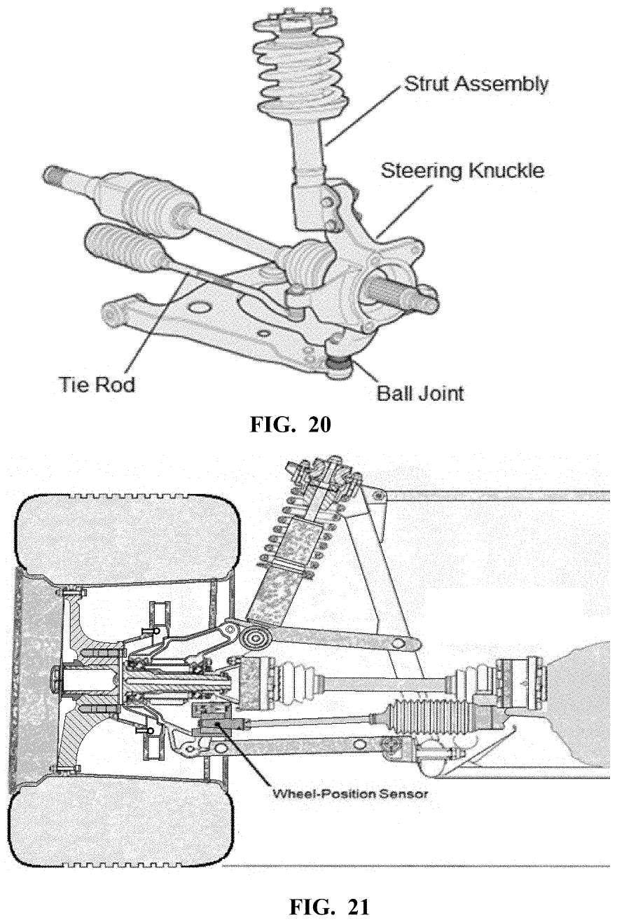

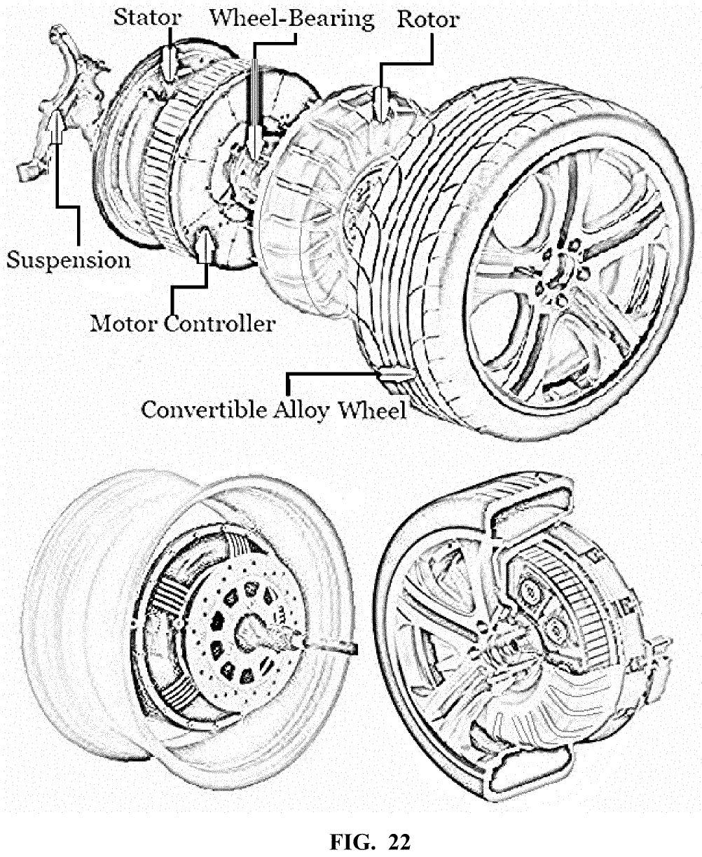

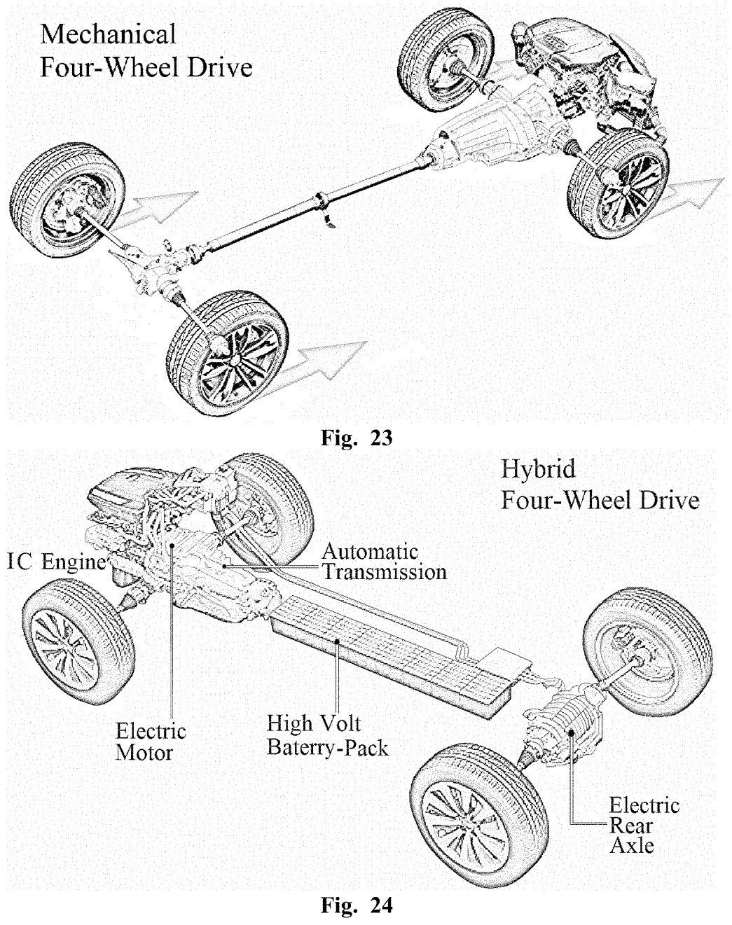

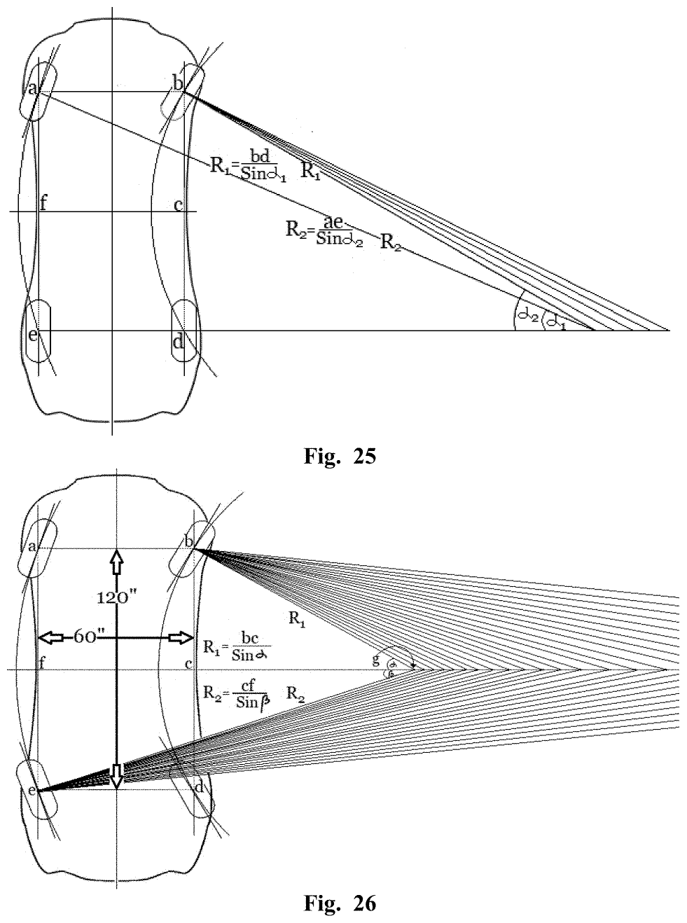

FIG. 16, 17 represent a cross-section of the electronic-clutch that is responsible for coupling and de-coupling electric traction-motors within configuration of FIGS. 12 and 13. The six holes in the periphery of the circle in said electronic-clutch may represent the location where six long bolts may be inserted to hold tight all the components as seen in FIGS. 12 and 13; e.g., the coupling and decoupling clutches; the electric traction-motors with their electronic-clutch discs; and the opposing, permanently fixed—to the shared shaft—discs. All components inserted by sliding them on the splines of the joint-shaft 62. Customization of power and torque in light duty and heavy-duty vehicles accomplished by first choosing the right length of joint-shaft 62, and then sliding-in additional electric traction-motors; or reducing the number of electric traction-motors; or replacing unwanted electric traction-motors; or replacing a defective electric traction-motors; the possibilities are endless.

It should be understood that in certain embodiment electronic controller may include conventional processing apparatus known in the art, and capable of executing pre-programmed instructions stored in associated memory, all performed in accordance with the functionality described herein. To the extent that the methods described herein are embodied in software, the resulting software may be stored in an associated memory where so described, may also constitute the means for performing such methods. Implementation of certain embodiment of the invention, where done so in software, would require no more than routine application of programming skills by one of ordinary skill in the art, in view of the foregoing enabling description. Such a controller be of the type having both ROM, RAM, a combination of non-volatile memory so that the software can be stored and yet allow storage and processing of dynamically produced data and/or signal.

What is claimed:

1. An electric scalable tractive power system for a vehicle, comprising:
a plurality of electric traction-motors,
wherein the plurality of electric traction-motors is:
configured in groups of electric traction-motors,
coupled to wheels of the vehicle, and
designed with different power ratings and different high-efficiency ranges of operation;
further wherein each group of the groups is designed to overlap each other's high efficiency range of operation while the vehicle is changing speeds in order to create a continuous high efficiency range of tractive-power from a forward-motion start of the vehicle to a top-rated speed of the vehicle,
further wherein each group of the groups comprises:
an electronic controlled clutch configured to couple and de-couple each of the plurality of the electric traction-motors, within the each group of the plurality of groups, to and from the wheels as part of a scalable tractive power-control strategy;
a fully automated electronic clutch-system attached to selected electric traction-motors within the each group of the plurality of groups;
a clutch-system configured to carry out coupling and de-coupling of at least one of the plurality of electric traction-motors within the group of groups to and from the wheels by utilizing electronic, electromagnetic, or electro-mechanical procedures;
a battery-pack with at least one energy storage-unit coupled to a DC bus;
a secondary energy storage unit with numerous ultra-capacitor cells;
a flywheel;
a controller comprising multi-objective optimization design (MOOD) procedures is programmed to:
determine power requirements to maintain vehicle instant tractive effort;
elect a group of electric traction-motors from the groups that may produce a required tractive effort with best efficiency;
actuate at least one group of electric traction-motors from the groups;
identify, from the groups, a first group of electric traction-motors having specifications to produce instant speed and load requirements with lowest energy use up;
actuate, and couple the identified first group of electric traction-motors to the wheels;
identify, from the groups, a second group of electric traction-motors configured to overlap the last portion of an efficiency range of the identified first group of electric traction-motors in order to produce a most efficient tractive effort requirement in acceleration or deceleration after the identified first group of electric traction-motors has reached its efficiency limits;
actuate and couple to the wheels the second group of electric traction-motors to carry out tractive effort requirements and simultaneously decouple from the wheels the identified first group of electric traction-motors;
compare tractive power of the second group of electric traction-motors to an instant tractive effort requirement;
identify from the comparison a remaining tractive effort requirement;
actuate a third group of electric traction-motors from the groups to produce the remaining tractive effort.

2. The electric scalable tractive power system of claim 1 further comprising:
a battery-pack with at least one energy storage-unit, coupled to a DC bus;
a secondary energy storage unit, with plurality of ultra-capacitors, coupled to a DC bus;
a third energy storage unit, with a fly wheel, comprising power levels exceeding 3 MW and electricity storage capacities exceeding 5 MWh, wherein the third energy storage uses radial gap magnetic bearings to store kinetic energy, further wherein the third energy storage is coupled to a DC bus;
a fuel cell unit as first energy-producing unit coupled to a DC bus;
a plurality of photovoltaic panels as secondary energy-producing unit installed on different surfaces of a car, a bus, a truck and on articulated cars and trailers, coupled to a DC bus;
a holistic controller includes voltage and current sensing capabilities in all energy storage units and energy-producing units;
wherein the holistic controller comprising a power management logic to:
monitor and manage the state-of-charge and discharge in all energy storage units and energy-producing units.

3. The electric scalable tractive power system of claim 1 further comprising:
a holistic controller programmed to utilize multi-objective optimization design (MOOD) procedures, wherein the holistic controller is configured to:
identify from the groups a specific group of electric traction-motors that meets an instant tractive-effort requirement while using up the smallest amount of energy; and
split the instant tractive-effort between the groups.

4. The electric scalable tractive power system of claim 1 further comprising:
a holistic controller programmed to actuate all the electric traction-motors groups at forward-motion, wherein the vehicle is configured to manage travel from forward-motion start to about 100 Km/h in a short time frame to secure a safe vehicle maneuverability acceleration, deceleration, braking, and any continuous and peak tractive-effort thereafter.

5. The electric scalable tractive power system of claim 1, wherein a shaft connects in series at least two electric traction-motors of the plurality of electric traction-motors to combine the power output thereof,
wherein the holistic controller, while maintaining scalable power control may de-couple one or more electric traction-motors of the plurality of traction-motors sharing the shaft to provide a low energy use-up while meeting the vehicle's tractive effort requirements.
an electronic controlled clutch is:
configured to couple to wheels and de-couple from wheels selected electric traction-motor groups;
wherein an electronic clutch is fully automated within the vehicle scalable tractive power system;
wherein electronic, and electromagnetic system is utilized to carry out coupling of electric traction-motors to wheels and de-coupling electric traction-motors from wheels

6. As part of an electric scalable tractive power system, a plurality of electronic clutches system is coupling, and de-coupling selected electric traction-motors to and from wheels;
a plurality of fully automated clutches attached to selected electric traction-motors;
an electronic clutch is:
configured to couple to wheels and de-couple from wheels selected electric traction-motor;
wherein the electronic clutch is fully automated within the vehicle scalable tractive power system;
wherein electronic, and electromagnetic solenoids is utilized to converts electrical energy into mechanical work, to carry out coupling of electric traction-motors to wheels and de-coupling electric traction-motors from wheels.

7. The electronic clutches of claim 6 comprising:
a wheel-side disc clutch and an electric traction-motor-side disc-clutch are:
configured with plurality of concave indentation and convex projections that fits perfectly tight one inside the other when the wheel-side disc-clutch and the electric traction-motor-side disc-clutch are coupled;
the wheel-side disc-clutch is permanently fixed to the electric traction-motor shaft, and is rotating whenever the vehicle is in motion;
a single or a dual electric traction-motor shaft is:
configured with a spur or a helical gear at the outer-end of the shaft and is meshed with a spur or a helical gear of a large wheel-gear;
the large wheel-gear is:
coupled in the center to the inner-end of the wheel driveshaft;
wherein the number of teeth on the traction-motor shaft-gear divided by the number of teeth on the large wheel-gear represents the gear ratio between the electric traction-motor and the related wheel;
a wheel driveshaft is:
configured with one, two or more flexible joints;
configured with splines with grooves at the inner end meshed with the center of the large wheel-gear and with splines meshed with grooves at the center of the related wheel, wherein a driveshaft transfers torque from the electric traction-motor to the related wheel;
an electric traction-motor side disc clutch is:
configured with a cylinder attached to the back of the electric traction-motor disc-clutch;
an electric traction-motor side disc clutch cylinder is:
configured with splines molded inside and outside to facilitate forward movement of the electric traction-motor disc clutch during coupling with the wheel side disc clutch, and to:
enable a backward movement of the electric traction-motor side disc clutch during de-coupling from the wheel side disc clutch.

8. The electronic clutches of claim 6 comprising:
a plurality of speed-sensors is:
configured to monitor all wheel side disc clutch RPM; and
configured to monitor all electric traction-motor side disc-clutches RPM;
wherein the RPM readings of all wheel side disc clutches is continuously monitored and transmitted by electronic means to a controller;
wherein the RPM readings of all electric traction-motors side disc clutches is continuously monitored and transmitted by electronic means a controller.

9. The electronic clutches of claim 6 comprising:
a controller is:
configured to maintains a feedback loop with each wheel-side disc clutch speed sensor;
wherein the RPM information provided by a wheel side disc clutch sensor enables the holistic controller to compute the precise voltage and the proper modulation that has to be applied to a selected electric traction-motor before coupling the selected electric traction-motor to the corresponding wheel-side disc-clutch;
configured to spin a selected electric traction-motor to precisely match the RPM of the electric traction-motor side disc clutch to the RPM of the wheel side disc clutch just before coupling, to secure a seamless coupling;
whereas the selected electric traction-motor intended to be coupled to a wheel is stationary prior to a coupling task, the electric traction-motor selected to be coupled is actuated and spin to match precisely the angular-speed of the wheel-side disc-clutch in a fraction of a second.

10. The electronic clutches of claim 6, comprising:
a holistic controller is:
configured to couple an electric traction-motor disc-clutch with a wheel-side disc-clutch, utilizing two different sets of electromagnetic solenoids;
a first-set of electromagnetic release-solenoids is:
configured with latches to secure an electric traction-motor disc-clutch cylinder in a decoupled, stationary position;
a compressed coupling-spring is:
configured around an electric traction-motor disc-clutch cylinder, between the electric traction-motor-rotor and the back of the electric traction-motor disc-clutch;
the holistic controller is:
configured to actuate the first-set of electromagnetic release-solenoids, and pull-up with electromagnetic means, the latches holding the electric traction-motor disc-clutch cylinder in a de-coupled, stationary position;
wherein actuating the first set of electromagnetic solenoid triggers the release of the elastic energy stored in a compressed coupling-spring between the electric traction-motor rotor and the electric traction-motor disc-clutch;
wherein the compressed coupling-spring thrusts the electric traction-motor disc-clutch forward on splines molded inside and outside the electric traction-motor disc-clutch cylinder;
whereas a secure coupling of the electric traction-motor disc-clutch with the wheel side disc-clutch is carried out;
wherein the electric traction-motor rotational energy is transferred to the corresponding wheel.

11. The electronic clutches of claim 6, comprising:
a holistic controller is:
configured to decouple an electric traction-motor disc clutch from a wheel side disc clutch;
configured to compute when certain electric traction-motor group is no longer operating in its optimal efficiency limits, or when an electric traction-motor group is no longer needed to maintain the tractive efforts, or when a vehicle tractive-efforts requirements has dropped, or when another electric traction-motor group is coupled while the vehicle is changing speed, or when the tractive efforts requirements has changed;
configured to disconnect the power supply from a de-coupled electric traction-motor simultaneously when an electric traction-motor is de-coupled from a wheel;
configured to actuate a second-set of electromagnetic solenoids to overcome the elastic energy stored in a coupling-spring located between an electric traction-motor rotor and a traction-motor disc-clutch;
configured to activate a first and a second sets of solenoids simultaneously;
whereas both solenoids are actuated:
the first-set of solenoid is:
configured to pull up a set of locking latches, to allow the second set of solenoid enough room to compress the coupling-spring around the electric traction-motor disc-clutch cylinder all the way back to a locking position;
the second-set of solenoids is:
configured to pull-back the traction-motor disc-clutch cylinder;
wherein the traction-motor disc-clutch is de-coupled from the wheel side disc-clutch and pulled-back into a de-coupled position with electromagnetic power;
a first-set of solenoid-springs is:
configured to thrust a set of latches, and lock-down the electric traction-motor disc clutch cylinder in a secured, stationary, decoupled position.

12. As part of a scalable tractive power system, provided are a plurality of energy resources for an electric-vehicle, the plurality of energy resources comprising:
a plurality of energy storage systems:
a battery-pack with at least one energy storage-unit, coupled to a DC bus;
a secondary energy storage with plurality of ultra-capacitors, coupled to a DC bus; and
a third energy storage-units with a flywheel;
a plurality of energy producing units:
a fuel-cell system coupled to selected traction-motors and to a DC bus;
photovoltaic cell modules installed on top and along the side of a vehicle, and on top and along the side of an articulated trailers, coupled to a DC bus;
a controller, comprising power management logic is:
configured to monitor and manage the state-of-charge and discharge in all energy storage and energy producing units, which includes voltage and current sensing capabilities of all battery-cells, all ultra-capacitors, the flywheel, the fuel-cell unit, and all photovoltaic cells modules.

13. The plurality of energy resources of claim 12, comprising:
a secondary energy storage unit with plurality of ultra-capacitor cells coupled to one another and to a DC bus;
wherein every single capacitor-cell may have a capacitance between 500 and 3000 Farads, or greater;
a flywheel is:
configured with power levels greater than 3 MW and electricity storage capacities greater than 5 MWh, which may use radial gap magnetic bearings to store kinetic energy, coupled to a DC bus;
whereas a significant starting and acceleration tractive-effort is required in forward motion starts and during accelerations;
a holistic controller is:
configured to deliver to selected electric traction-motors electric energy during forward motion starts and during accelerations from a secondary energy storage, comprising ultra-capacitors and flywheel energy storage units;
wherein ultra-capacitors and flywheels can burst instantaneous power to complement the battery-packs storage units that suffer fast deterioration when repeatedly providing quick bursts of power in frequent start-stop applications, mainly in commercial, and other heavy-duty vehicles and at lower temperatures.

14. In a scalable tractive power system, provided are electric traction-motors that operate as generators during a deceleration process; the electric traction-motors comprising:
a holistic controller is:
configured to couple all or less than all decoupled electric traction-motors to the wheels, to assist the vehicle to decelerate efficiently with minimum energy losses into heat, while generating maximum electric energy, with the assistance of all or less than all, electric traction-motors;
configured to reconnect the power supply to all electric traction-motors just before coupling the electric traction-motor to the wheels;
wherein the generated electric energy is routed to the corresponding bi-directional DC/AC inverters;
configured to control all be-directional DC/AC voltage inverters to convert AC voltage received from all electric traction-motors that are coupled during deceleration into a DC voltage and supply the DC voltage to the corresponding DC bus;
configured to control all bi-directional DC/DC converters to buck voltage from the respective DC bus and supply the bucked voltage to the respective energy storage units;
configured to utilize multi-objective optimization design (MOOD) programs to distribute unequal decelerating speed among all electric traction-motors, to provide optimal dynamic stability, in wet roads, in curves and in any other driving conditions that require uneven deceleration procedures for optimal stability;
whereas wastage of brake-discs and brake-pads is curtailed;

15. As part of the scalable tractive power system, integration herewith is an all-wheel, electric-steering system, comprising;
an electronic steering-wheel sensor is:
configured to monitor the driver elected steering-angle and transmit the information to the holistic controller with electronic means;
configured as a circular plate with plurality of metal leaflets, placed in a circle on the face of the steering-wheel sensor plate;
a steering-wheel column is:
inserted through an opening in the center of the steering-wheel sensor plate;
fixed to the driver's steering wheel, and is:
following the steering-wheel movements;
a steering-wheel sensor pointer is:
fixed to the steering-wheel column;
configured as the individual moving part of the steering-wheel sensor, and is:
moving whenever the driver turns the steering-wheel,
a steering-wheel sensor pointer outer-end is:
configured to make continuous contact with one leaflets at-the-time while sliding on the face of the steering-wheel sensor plate;
whereas a pointer outer-end is in contact with a specific leaflet, the contact between the pointer outer-end and the leaflet creates a close electrical circuit that provides the holistic controller with the specific information of the driver elected steering angle;
an electric steering-motor is:
fixed to the frame of the vehicle next to each wheel, and in selected wheels in a semi-trailer;
wherein each electric steering-motor converts a rotational energy into a precise linear movement of a large ball-bearing screw:
the large ball-bearing screw is:
connected to the electric steering-motor with teethed gear, with chain, or with belt;
configured to rotate while moving either to the left or to the right in a smooth movement thank to plurality of ball-bearings placed in the threads of the large ball-bearing screw;
a large ball-bearing screw head is:
configured in one end of the large ball-bearing screw, facing the wheel;
wherein the large ball-bearing screw head rotates whenever the large ball-bearing screw is rotating;
a tie-rod is:
configured in one end with a convex design that encapsulates the large ball-bearing screw head to form a ball-and-socket-joint;
whereas the other end of the tie-rod is:
inserted through a wheel-position sensor cylinder;
a controller is:
configured with control logic associated with all-wheel electric steering;
configured to monitor information provided from the driver steering-wheel sensor, and from all individual wheel-position sensors;
configured to evaluate the information provided from all sensors;
configured to utilize multi-objective optimization design (MOOD) procedures;
measure complex variable values and parameters,
find the required trade-off among design objectives, and
improve the pertinence of solutions to:
compute the precise, yet different angle for each wheel with geometric precision, depending on the vehicle speed, to meet the driver elected steering angle;
whereas steering computation varies amid four-wheeler and multi-wheeler vehicles;
the holistic controller is:
further configured to actuate all electric steering-motors to position each wheel at the computed angle;
wherein a loop between the controller, each wheel position sensors, and each electric steering-motors provides a continuous monitoring the precise position of all wheels, while actuating selected steering-motors simultaneously;
configured to integrate the electric traction-motor system with the steering system by;
actuating opposing electric traction-motors on the same electronic-axle with different torque and different speed to assist in the steering process.

16. The all-wheel electric-steering system, of claim 15, comprising:
a steering-wheel sensor is:
configured with plurality of metal leaflets with electrical conductivity,
wherein the number of leaflets may represent the number of different turning angles the driver may select during any steering procedure;
configured that each individual leaflet is connected with an individual electronic means directly to the holistic controller, to transmit the driver elected steering-angle-electronic-information without electrical leakages that might cause transmission errors;
whereas the driver turns the steering-wheel, it moves a pointer on the face of the steering-wheel sensor to reach the leaflet that identifies the driver elected steering-angle;
a steering-wheel sensor pointer is:
configured to contact a specific leaflet that corresponds to the driver elected steering-angle and transmit the information to the controller;
wherein a pointer contact with a specific leaflet creates a close electrical-circuit, with which it provides the holistic controller with the precise steering-angle the driver elected to carry out.

17. The all-wheel electric-steering system, of claim 15, comprising:
an electric steering-motor installed in the front wheel of the vehicle is:
configured with greater electric-power for quicker, prompter response than an efficient steering-motor installed in the rear wheels of the vehicle or the articulated trailer;
whereas more efficient steering-motors may be installed in the rear wheels, and in wheels in articulated trailer; yet any proper electric-motor may be utilized to convert electrical-energy into linear movement of a large ball-bearing screw to secure any wheel movement to the controller computed steering-angle.

18. The all-wheel electric-steering system, of claim 15, comprising:
an electric steering-motors for the rear wheels in a 4-wheeler, a 6-wheeler trucks, or buses, and in a 12 to 18-wheeler semi-trailer is:
configured with efficient electric steering-motors;
a rotor of the efficient electric steering-motor is:
configured as a big nut with a threaded hole, and is:
wrapped around a large ball-bearing screw;
rotating smoothly with ball-bearing captured between the threads of the big nut and the large ball-bearing screw threads, to minimize friction between the large ball-bearing screw and the threaded nut;
whereas the rotor is rotating, it forces the large ball-bearing screw to move either to the left or to the right,
wherein an electric steering rotor rotational energy is converted into a linear motion of the large ball-bearing screw;
any other, proper configuration of electric-motors may be fitted to convert electrical energy into a liner movement of the large ball-bearing screw.

19. The all-wheel electric-steering system, of claim 15, comprising:
a wheel-position sensor is:
functioning as a traditional tie-rod end while monitoring the instantaneous angle of the corresponding wheel;
configures with a round housing and with an extension to one-side, which is connected to the wheel steering-knuckle; and
coupled to a wheel steering-knuckle to establish a flexible joint with the wheel;
a wheel-position sensor housing is:
configured with a teethed-geared facing the inner side of the upper half of the wheel-position sensor housing;
a wheel-position sensor cylinder:
occupies the mid to the lower part inside the wheel-position sensor housing;
a tie-rod is:
configured with one end encapsulated around one end of the large ball-bearing screw head to forms a ball-and-socket-joint, while the other end is entered through a hole in the wheel-position sensor cylinder;
fixed with a lock-nut at the other side of the wheel-position sensor cylinder;
a plurality of gears inside the wheel-position sensor is:
configured as the moving-part of the wheel position sensor, comprising:
a first-gear is:
meshed with the molded teethed-gear in the inner side of the wheel-position sensor housing;
a second-gear is:
meshed with the first-gear;
configured with a center-shaft;
wherein the bottom end of the second-gear shaft rests in a groove at the center top of the wheel-position sensor cylinder, inside the wheel-position sensor housing,
whereas the upper end of the second-gear shaft is:
fixed to a pointer;
a pointer is:
configured to move on the face of the wheel-position sensor;
configured to create an electric contact with a variable resistance on the face of the wheel-position sensor;
two half circle variable resistances are:
fixed to the face of the wheel-position sensor,
configured as half circle to the left, and a half circle to the right,
whereas during steering of the wheel, the pointer is in a continuous electrical contact while sliding on the half circle variable resistance to the left, or sliding on the half circle variable resistance to the right;
whereas driving straight-forward, the pointer is positioned in a specific spot on the face of the wheel-position sensor with no electrical conductivity between the left and the right variable resistances, which informs the controller that the related wheel is in a straight-forward position;
a contact-less IC hall-effect sensor is:
configured to replace the wheel-position sensor pointer function if heavy vibrations of the vehicle may cause interruptions in contact of the pointer with the variable resistance on the face of the wheel-position sensor.

20. The all-wheel electric-steering system, of claim 15, comprising:
a complex steering actuation sequence starts when the holistic controller:
receives the driver elected steering-angle from a steering-wheel sensor;
the holistic controller is:
configured to actuate all electric steering-motors in the vehicle;
wherein the electric steering-motor rotational energy is transfer to the corresponding large ball-bearing screws;
wherein a clockwise or a counter-clockwise rotation of the-large ball-bearing screws push or pulls a tie-rod;
the tie-rod is:
pushed or pulled by the large ball-bearing screw;
configured to push or pull a wheel-position sensor cylinder;
beginning in the ball-bearing screw head, and ends inside a wheel-position sensor cylinder,
whereas a wheel-position sensor housing makes an incremental angular rotation, it changes the previous angle between the tie-rod, the wheel-position sensor, and the wheel,
whereas a molded geared-teeth inside the wheel-position sensor housing initiates the rotation of a first-gear inside the wheel-position sensor housing;
a second-gear is:
actuated by the first gear;
wherein a second-gear shaft makes an incremental angular rotation;
a pointer is:
fixed on top of the second gear shaft, and it makes an incremental move on a variable resistance on the face of the wheel-position sensor plate;
the holistic controller is:
configured to interpret the change in resistance transmitted by the pointer;
compute the instant position of the corresponding wheel in relation to straight forward;
whereas the large ball-bearing screws moves the tie-rod and causes a chain of reactions that ends with the movement of the wheel knuckle-arm, which causes a proportional position change to the corresponding wheel;
wherein the corresponding wheel may be pulled or pushed to the left or to the right, while triggering a change in the angle between the wheel-position sensor and the corresponding wheel.

21. The all-wheel electric-steering system, of claim 15, comprising:
a holistic controller is:
configured to restore a malfunctioning electronic steering system into a ‘fail operational system’ for all-wheel, steer-by-wire systems by:
emulating ‘repair procedure’ in a human double-helix DNA;
whereas a malfunction of a contact-leaflets within a steering-wheel sensor may occur, or
whereas a malfunction in a variable resistance on the face of a wheel-position sensor occur;
may utilize the information of the next leaflet to the defective leaflet on the face of a steering-wheel sensor, or utilize the information of a functioning variable resistance fragment in a wheel-position sensor;
enter into computation the utilized information of the ‘functioning leaflet or the functioning variable resistance fragments, in relation to the location of the defective leaflet or the location of the variable resistance fragment on the face of the sensors;
interpret what should be the reading of the defective leaflet or the reading of the defective variable resistance fragment, and
apply the interpreted results in the computation;
whereas a particular wheel-position sensor is entirely ‘out-of-order;
the holistic controller is:
further configured to utilize the reading of the opposite side wheel-position sensor;
interpret the reading of the wheel-position sensor on the opposite side; and
apply the interpreted results in computation;
keep the affected wheel or wheels within a safe range of less than 1° error;
reduce the velocity of the vehicle to a safe speed;
whereas specific warning signal is turned-on to alert the driver of the malfunctioning location, and provide instructions what has to be done; and
secure the vehicle in a ‘fail operational steering system’ configuration.

22. An electric scalable tractive power system integrated with all-wheel steering system, comprising:
a steering-wheel sensor pointer is:
configured to change position on the face of the driver steering-wheel sensor when the driver moves the steering-wheel;
a holistic controller is:
configured to receive the driver steering information with electronic means;
compute the correct angle for each wheel, including the angle of each wheel in the articulated trailer;
whereas in exceptionally long, articulated vehicles the speed of the vehicle is also entered into calculations to determine the precise time when each axle reaches the beginning of the curve;
configured to compute the different distance the left and the right wheels of the vehicle and the trailer (or trailers) must travel to negotiate the curve with no wheel dragging;
configured to apply different torque, and different speed to opposing electric traction-motors while negotiating the curve,
wherein integration of differential tractive-power in the steering process realizes a function of EPS [electric power-steering];
the controller is:
further configured with vector control system, known as field-oriented control (FOC), comprising two orthogonal components, which is utilized to provide different torque to traction-motors on both sides of a vehicle while negotiating a curve;
wherein one orthogonal component defines the magnetic flux in a stator, providing the controller with a magnetic flux data for the field-oriented control algorithms;
whereas the other orthogonal component corresponds to the torque as determined by the rotor position and speed;
further configured with variable frequency drive (VFD);
a variable frequency drive (VFD) is:
configured as motor controller that drives an AC induction motor (ACIM) or permanent magnet synchronous motor (PMSM) by varying frequency and amplitude of the current supplied to a motor; and
configured to precisely increases the speed of a traction-motor that has to travel a longer distance to make the curve.

23. The electric scalable tractive-system for a vehicle according to claim 1, comprising:
an all-wheel electric traction-system;
a steering system;
a controller configured to control electric traction-motor torque and speed, and electric steering-motors;
whereas a controller cannot prevent a driver from choosing any desired turning angel in combination with unsafe speed;
a controller is:
configured with electronic torque and speed control over all electric traction-motors and over all electric steering-motors operation, entered into the controller date-base;
configured to utilize multi-objective optimization design (MOOD) program,
configured to include a vehicle center of gravity information;
generate an algorithm that delivers a procedure to maintain in any combination of steering wheel angle and vehicle speed, a safe forward motion, below a computed threshold-point that may overturn or endanger a vehicle stability yet afford a driver to make a turn safely in a reasonable speed;
configured to prevent a vehicle from turning-over, even though a driver may have pushed the accelerator to the floor.

24. The all-wheel electric-steering-system of claim 15 further comprising:
an all-wheel electric traction-system;
a steering system;
a controller configured to control electric traction-motor torque and speed, and electric steering-motors;
whereas a controller cannot prevent a driver from choosing any desired turning angel in combination with unsafe speed;
a controller is:
configured with electronic torque and speed control over all electric traction-motors and over all electric steering-motors operation, entered into the controller date-base;
configured to utilize multi-objective optimization design (MOOD) program,
configured to include a vehicle center of gravity information;
generate an algorithm that delivers a procedure to maintain in any combination of steering wheel angle and vehicle speed, a safe forward motion, below a computed threshold-point that may overturn or endanger a vehicle stability yet afford a driver to make a turn safely in a reasonable speed;
configure to prevent a vehicle from turning-over, even though a driver may have pushed the accelerator to the floor.
